(19) United States
(12) Patent Application Publication
(10) Pub. No.: US 2008/0174724 A1
(43) Pub. Date: Jul. 24, 2008

(54) Liquid crystal display device, optical film and polarizing plate

(75) Inventors: Hajime Nakayama, Minami-ashigara-shi (JP); Nobutaka Fukagawa, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/007,553

(22) Filed: Jan. 11, 2008

(30) Foreign Application Priority Data
Jan. 15, 2007 (JP) 2007-005587
Mar. 8, 2007 (JP) 2007-058140

(51) Int. Cl. G02F 1/1335

(52) U.S. Cl. 349/96; 349/117; 349/118

(57) ABSTRACT

A liquid-crystal display device comprising at least a liquid-crystal cell, a first optically anisotropic layer and a second optically anisotropic layer is disclosed. The first optically anisotropic layer satisfies the following formula (a1), the second optically anisotropic layer has at least one optical axis, and at least one of the first and second optically anisotropic layers is formed according to a coating or transferring method.

10<Rth(548)/Re(548) (a1)
[wherein Rth (λ) means the retardation (nm) in the thickness direction at a wavelength λ (nm].

### CROSS-REFERENCE TO RELATED APPLICATIONS

This application claims benefit of priority under 35 U.S.C. 119 to Japanese Patent Application Nos. 2007-005587 filed Jan. 15, 2007 and 2007-058140 filed Mar. 08, 2007, and the entire contents of the applications are incorporated herein by reference.

### BACKGROUND OF THE INVENTION

1. Field of the Invention

The present invention relates to an optical film and a polarizing plate that contribute toward improving the viewing angle characteristics of liquid-crystal display devices, and to a liquid-crystal display device having excellent viewing angle characteristics.

2. Related Art

A liquid crystal display device (LCD) has been more and more widely used instead of a CRT, because it has a thin shape, lightweight and small electric power consumption. Various LCD modes employing a liquid crystal cell in which liquid crystal molecules are aligned in any alignment state have been proposed. Among these, the 90 degree-twisted nematic cell, TN cell, is the most widely used LC cell.

In general, a liquid crystal display device comprises a liquid crystal cell, an optical compensation sheet and a polarizing plate. The optical compensation sheet is used for reducing coloration on the images or widening the viewing angle, and stretched birefringent films or films having a coated liquid crystal layer thereon are utilized. For example, as an optical compensation film capable of widening the viewing angle of a TN mode LCD, an optical compensation sheet prepared by fixing discotic liquid crystal in an alignment on a cellulose acylate film is proposed. However, the viewing angle properties required for large-screen LCD televisions, which may be viewed in various directions, are so tough that they cannot be achieved by employing such the optical compensation sheet. And various modes such as IPS(In-Plane Switching), OCB(Optically Compensatory Bend) and VA (Vertically Aligned) modes other than the TN-mode have been researched and developed.

A VA mode achieves almost complete black state in the normal direction of the panel thereof, but is problematic in that when its panel is observed in an oblique direction, then there occurs light leakage and the viewing angle is narrowed. To solve this problem, proposed is use of an optically-biaxial retardation film of which refractive index differs in three directions, thereby improving the viewing angle characteristics of VA modes (for example, JPA No. 2003-344856).

However, the above-mentioned method is for reducing the light leakage only within a limited wavelength range (for example, green light at around 548 nm), in which nothing is taken into consideration for light leakage in the other wavelength range (for example, blue light at around 446 nm, or red light at around 650 nm). Therefore, when the panel is observed in an oblique direction in the black state, then there occurs a problem of color shift to blue or red coloration. As a means for solving this problem, proposed is a method of using two retardation films having specific wavelength dispersion characteristics of the retardation (Japanese Patent No. 3648240).

### SUMMARY OF THE INVENTION

However, for satisfying the recent requirement for higher display quality in the art, desired is further quality improvement relative to the above-mentioned problems. In actually putting products on the market, not only in terms of display quality but also in terms of producibility is important, and it is an important theme how to readily produce liquid-crystal display devices of high display quality satisfying the market requirements in the technical field of liquid-crystal display devices.

In practical use thereof, products are required not only to have excellent initial performance but also to keep the performance even in long-term use. Some conventional products may have good initial display performance, but when used for a long time, their display performance may often lower, or that is, there may occur slight light leakage at four corners of the display panel (hereinafter this may be referred to as “corners”), therefore giving corner unevenness.

The present invention has been made in consideration of the situation as above, and an object of the invention is to provide a liquid-crystal display device, especially a VA-mode liquid-crystal display device that enables display of high-contrast images in a wide viewing angle range with reduced color shift (color change in oblique directions).

Another object of the invention is to provide a liquid-crystal display device, especially a VA-mode liquid-crystal display device of good durability, capable of solving the above-mentioned problems and producing no or little corner unevenness even in long-term use thereof.

Still another object of the invention is to provide an optical film and a polarizing plate capable of contributing to widening the viewing angle and reducing the viewing angle-dependent color shift of a liquid-crystal display device, especially a VA-mode liquid-crystal display device.

Still another object of the invention is to provide an optical film and a polarizing plate capable of solving the above-mentioned problems and producing no or little corner unevenness even in long-term use thereof.

In one aspect, the present invention provides a liquid-crystal display device comprising at least a liquid-crystal cell, a first optically anisotropic layer and a second optically anisotropic layer,

wherein the first optically anisotropic layer satisfies the following formula (a1), the second optically anisotropic layer has at least one optical axis, and at least one of the first and second optically anisotropic layers is formed according to a coating or transferring method.

10<Rth(548)/Re(548) (a1)

[wherein Rth(λ) means the retardation (nm) in the thickness direction at a wavelength λ (nm].

In another aspect, the preset invention provides an optical film comprising at least a first optically anisotropic layer and a second optically anisotropic layer,

wherein the first optically anisotropic layer satisfies the following formula (a1), the second optically anisotropic layer has at least one optical axis, and at least one of the first and second optically anisotropic layers is formed according to a coating or transferring method.

10<Rth(548)/Re(548) (a1)

[wherein Rth (λ) means the retardation (nm) in the thickness direction at a wavelength λ (nm].

In the invention, the first optically layer may be a polymer film (or a layer formed of a composition according to a coating or transferring method) of which thickness-direction retardation Rth decreases with longer wavelength within a visible light range; the second optically anisotropic layer may be a polymer film (or a layer formed of a composition according to a coating or transferring method) of which in-plane retardation Re and thickness-direction retardation Rth do not change depending on the wavelength within a visible light range, or increase with longer wavelength within a visible light range.

The thickness d (μm) of the first optically anisotropic layer may satisfy the following formula (a4), and Rth(548) thereof satisfies the following formula (a5):

0.1≦d≦20 (a4)

Rth(548)/(d×1000)≧0.03. (a5)

The second optically anisotropic layer may be a layer formed according to a coating or transferring method, and its thickness d (μm) satisfies the following formula (b7) and its Rth(548) satisfies the following formula (b8):

0.1≦d≦20 (b7)

Re(548)/(d×1000)≧0.03. (b8)

The first optically anisotropic layer may satisfy the following formulae (a2) and (a3):

30nm≦Rth(548)≦400nm (a2)

1<Rth(446)/Rth(548). (a3)

The second optically anisotropic layer may satisfy the following formulae (b1) and (b2):

Re(548)>20nm (b1)

0.5<Nz<10 (b2)

[wherein Re(λ) and Rth(λ) each indicate the in-plane retardation (nm) and the thickness-direction retardation (nm), respectively, at a wavelength λ (nm); and Nz=Rth(548)/Re(548)+0.5].

The first optically anisotropic layer may satisfy the following formulae (a1) to (a3), and the second optically anisotropic layer may satisfy the following formulae (b1) to (b6):

10<Rth(548)/Re(548) (a1)

30nm≦Rth(548)≦400nm (a2)

1.0<Rth(446)/Rth(548)<1.5 (a3)

Re(548)>20nm (b1)

0.5<Nz<10 (b2)

0.60≦Re(446)/Re(548)≦1.0 (b3)

1.0≦Re(628)/Re(548)≦1.25 (b4)

0.60≦Rth(446)/Rth(548)≦1.0 (b5)

1.0≦Rth(628)/Rth(548)≦1.25 (b6)

[wherein Re(λ) and Rth(λ) each indicate the in-plane retardation (nm) and the thickness-direction retardation (nm), respectively, at a wavelength λ (nm); and Nz=Rth(548)/Re(548)+0.5].

The first optically anisotropic layer may be a cellulose acylate film. The cellulose acylate film may comprise at least one Rth enhancer. The at least one Rth enhancer may be selected from compounds represented by formula (I) or (II):

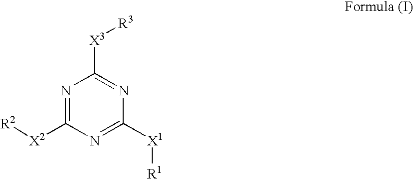

where X¹ represents a single bond, -NR⁴-, —O—or —S—; X² represents a single bond, -NR⁵-, —O—or —S—; X³ represents a single bond, -NR-, —O—or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group;

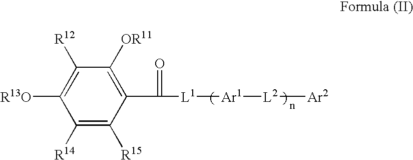

where R¹², R¹⁴ and R¹⁵ independently represent a hydrogen atom or a substituent; R¹¹ and R¹³ independently represent a hydrogen atom or an alkyl group; and L¹ and L² independently represent a single bond or a bivalent linking group. In the formula, Ar¹ represents an arylene group or an aromatic heterocyclic group; Ar² represents an arylene group or an aromatic heterocyclic group; n is an integer equal to or more than 3; “n” types of L² and Ar¹ may be same or different from each other; and R¹¹ and R¹³ are different from each other, provided that the alkyl group represented by R¹³ doesn't include any hetero atoms.

The first optically anisotropic layer may be a layer formed of a discotic liquid-crystal composition or a cholesteric liquid-crystal composition according to a coating or transferring method.

The first optically anisotropic layer may be a birefringent polymer layer formed according to a coating or transferring method, and the polymer layer comprises at least one polymer material selected from a group consisting of polyamide, polyimide, polyester, polyether ketone, polyamidimide, polyester imide, and polyaryl ether ketone.

The second optically anisotropic layer may be a cellulose acylate film. The cellulose acylate film may comprise at least one Re enhancer. The at least one Re enhancer may be selected from compounds represented by formula (I):

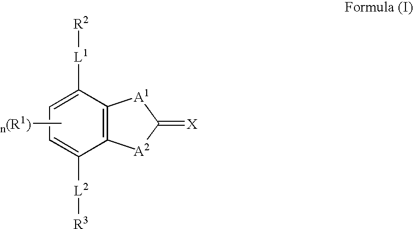

where, L¹ and L² independently represent a single bond or a divalent linking group; A¹ and A² independently represent a group selected from the group consisting of —O—,-NR- where R represents a hydrogen atom or a substituent, —S—and —CO—; R¹, R² and R³ independently represent a substituent; X represents a nonmetal atom selected from the groups 14-16 atoms, provided that X may bind with at least one hydrogen atom or substituent; and n is an integer from 0 to 2.

The second optically anisotropic layer may be a layer formed of a liquid-crystal composition according to a coating or transferring method.

The second optically anisotropic layer may be a birefringent polymer layer formed according to a coating or transferring method, and the polymer layer comprises at least one polymer material selected from a group consisting of polyamide, polyimide, polyester, polyether ketone, polyamidimide, polyester imide, and polyaryl ether ketone.

The liquid-crystal display devise may employ a vertically aligned mode.

In still another aspect, the present invention provides a polarizing plate comprising a polarizing element and the optical film of the invention. The polarizing plate may further comprise a protective film protecting the polarizing element. The protective film may have a moisture permeation degree equal to or smaller than 200 g/m²·day.

The present invention also relates to a liquid-crystal display device comprising at least a liquid-crystal cell, a first optically anisotropic layer satisfying the following formula (a6), and a second optically anisotropic layer,

wherein the first optically anisotropic layer is a layer formed according to a coating or transferring method, of which thickness-direction retardation Rth decreases with longer wavelength within a visible light range; and

the second optically is a layer formed according to a coating or transferring method, of which in-plane retardation Re and thickness-direction retardation Rth do not change depending on the wavelength within a visible light range, or increase with longer wavelength within a visible light range

0.5<Rth(548)/Re(548) (a6)

[wherein Rth (λ) means the retardation (nm) in the thickness direction at a wavelength λ (nm].

The present invention also relates to an optical film comprising at least a liquid-crystal cell, a first optically anisotropic layer satisfying the following formula (a6) and a second optically anisotropic layer,

wherein the first optically anisotropic layer is a layer formed according to a coating or transferring method, of which thickness-direction retardation Rth decreases with longer wavelength within a visible light range; and

the second optically is a layer formed according to a coating or transferring method, of which in-plane retardation Re and thickness-direction retardation Rth do not change depending on the wavelength within a visible light range, or increase with longer wavelength within a visible light range

0.5<Rth(548)/Re(548) (a6)

[wherein Rth (λ) means the retardation (nm) in the thickness direction at a wavelength λ (nm].

### BRIEF DESCRIPTION OF THE DRAWINGS

FIG. 1 is a schematic cross-sectional view of one example of a liquid-crystal display device of the invention.

FIG. 2 is a schematic cross-sectional view of another example of a liquid-crystal display device of the invention.

FIG. 3 is a schematic cross-sectional view of another example of a liquid-crystal display device of the invention.

FIG. 4 is a schematic cross-sectional view of another example of a liquid-crystal display device of the invention.

FIG. 5 is a view used for explaining one example of the optical compensatory mechanism of a liquid-crystal display device the invention, on a Poincare sphere.

FIG. 6 is a view used for explaining one example of the optical compensatory mechanism of a liquid-crystal display device the invention, on a Poincare sphere.

FIG. 7 is a view used for explaining one example of the optical compensatory mechanism of a liquid-crystal display device the invention, on a Poincare sphere.

FIG. 8 is a schematic cross-sectional view of one example of an optical film of the invention.

FIG. 9 is a schematic cross-sectional view of another example of an optical film of the invention.

FIG. 10 is a schematic cross-sectional view of one example of a polarizing plate of the invention.

FIG. 11 is a schematic cross-sectional view of another example of a polarizing plate of the invention.

FIG. 12 is a schematic cross-sectional view of another example of a liquid-crystal display device of the invention.

In the drawings, the reference numerals and signs have the following meanings:
11 Polarizing Element
12 Polarizing Element
13 Liquid-Crystal Cell
14, 14′, 14″ First Optically anisotropic layer
15, 15′, 15″ Second Optically anisotropic layer
16, 16′ 18 Outside Protective Film
17 Cell Side Protective Film
F, F′ Optical Film
P0, P1, P1′, P2, P3, P4, P5, P6, P7 Polarizing plate

### DETAILED DESCRIPTION OF THE INVENTION

In the following, the present invention will be explained with reference to the accompanying drawings. In the description, ranges indicated with “to” mean ranges including the numerical values before and after “to” as the minimum and maximum values. The terms “Substantially perpendicular or parallel” are meant to include a range of strict angle ±10°.

In this description, Re (λ) and Rth (λ) are an in-plane retardation (nm) and a thickness-direction retardation (nm), respectively, at a wavelength of λ. Re (λ) is measured by applying light having a wavelength of λ nm to a film in the normal direction of the film, using KOBRA 21ADH or WR (by Oji Scientific Instruments).

When a film to be analyze by a monoaxial or biaxial index ellipsoid, Rth (λ) of the film is calculated as follows. Rth (λ) is calculated by KOBRA 21ADH or WR based on six Re (λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis inplane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth (λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (21) and (22):

$$\begin{matrix}Re ( θ ) = [ nx - \frac{ny \times nz}{( \sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}} )} ] \times \frac{d}{cos \{ {sin}^{- 1} ( \frac{sin ( - θ )}{nx} ) \}} & ( 21 ) \\ Rth = \{ ( nx + ny ) / 2 - nz \} \times d & ( 22 )\end{matrix}$$

wherein Re (θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth (λ) of the film may be calculated as follows:

Re (λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth (λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some major optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

In this description, Re (λ) and Rth (λ) such as Re(446), Re(548), Re(628), Rth(446), Rth(548) and Rth(628) are measured as follows: Using a measuring instrument, a sample is analyzed at three or more different wavelengths (for example, λ=479.2, 546.3, 632.8, 745.3 nm), and Re and Rth of the sample are calculated at those wavelengths. The data are approximated according to a Cauchy's formula (up to the trinominal expression, Re=A+B/λ²+C/λ⁴), to obtain the values A, B and C. From the above, Re and Rth at a wavelength λ are plotted, and Re and Rth at the wavelength λ are obtained as Re (λ) and Rth (λ).

### [Liquid-Crystal Display Device]

The liquid-crystal display device of the invention comprises a first optically anisotropic layer which satisfies a formula (a1), 10<Rth(548)/Re(548) and a second optically anisotropic layer having at least one optical axis. At least one of the first and second optically anisotropic layers is formed according to a coating or transferring method.

In one preferred embodiment of the liquid-crystal display device of the invention, the above-mentioned first optically anisotropic layer is a polymer film of which thickness-direction retardation Rth decreases with longer wavelength within a visible light range, and the above-mentioned second optically anisotropic layer is a layer formed according to a coating or transferring method.

In another preferred embodiment of the liquid-crystal display device of the invention, the above-mentioned first optically anisotropic layer is a layer formed according to a coating or transferring method, and the above-mentioned second optically anisotropic layer is a polymer film of which in-plane retardation Re and thickness-direction retardation Rth do not change depending on the wavelength within a visible light range, or increase with longer wavelength within a visible light range.

In one more preferred embodiment of the invention, the first optically anisotropic layer satisfies the above formula (a1) and the following formulae (a2) and (a3), and the second optically anisotropic layer satisfies the following formulae (b1) to (b6).

10<Rth(548)/Re(548) (a1)

30≦Rth(548)≦400 (a2)

1<Rth(446)/Rth(548)<1.5 (a3)

Re(548)>20nm (b1)

0.5<Nz<10 (b2)

0.6<Re(446)/Re(548)≦1 (b3)

1≦Re(628)/Re(548)≦1.25 (b4)

0.6≦Rth(446)/Rth(548)≦1 (b5)

1≦Rth(628)/Rth(548)≦1.25 (b6)

[In the formulae, Re (λ) and Rth (λ) each indicate the in-plane retardation (nm) and the thickness-direction retardation (nm), respectively, of the film at a wavelength λ (nm); and Nz=Rth(548)/Re(548)+0.5.]

The above first optically anisotropic layer satisfies the above formula (a1), and its Rth decreases with longer wavelength within a visible light range, or that is, the layer is an optically anisotropic layer having regular wavelength dispersion characteristics of Rth. The above second optically anisotropic layer is an optically anisotropic layer having at least one optical axis. Preferably, the second optically anisotropic layer is a layer having at least one in-plane optical axis; and more preferably the second optically anisotropic layer is monoaxial or biaxial and both its Re and Rth increase with longer wavelength within a visible light range, or that is, the layer is an optically anisotropic layer having reversed wavelength dispersion characteristics of both of Rth and Re. This embodiment, or that is, the combination of the first optically anisotropic layer having the above-mentioned wavelength dispersion characteristics of Rth and the biaxial second optically anisotropic layer having reversed wavelength dispersion characteristics of both Re and Rth, enables optical compensation in the oblique direction not only for the G light at the center in a visible light range but also for the R light in a longer wavelength range and for the B light in a shorter wavelength range, with respect to the optical compensation in VA-mode (vertical alignment) mode liquid-crystal display devices. As a result, the liquid-crystal display device of this embodiment reduces color shift in oblique directions.

In the invention, at least one of the first and second optically anisotropic layers is formed according to a coating or transferring method, and therefore, for example, as compared with a production process comprising laminating polymer films with adhesive, the invention has the advantage of production process simplification as the adhesive coating step may be omitted. Retardation is proportional to the thickness of a film, and therefore, in order that the first and second optically anisotropic layers could satisfy the necessary optical characteristics, they must be thick in some degree; however, for some liquid-crystal compositions and polymer compositions, there are known various materials capable of exhibiting high optical anisotropy even though they form thin layers; and accordingly, the invention may meet the requirement for the thickness reduction in liquid-crystal display devices, using such materials.

In a more preferred embodiment, the second optically anisotropic layer is formed according to a coating or transferring method, as additionally having the following advantage.

As compared with an optically anisotropic layer formed of a polymer film, the optically anisotropic layer formed according to a coating or transferring method may be thinner and may have a lower photoelasticity coefficient. One reason for the unevenness that may occur at the corners of the display panel of a liquid-crystal display device in long-term use may be because of the change in the optical characteristics of the optically anisotropic layer owing to the deformation thereof; but in this embodiment, since the second optically anisotropic layer is formed according to a coating or transferring method, its photoelasticity coefficient is low and the change in the optical characteristics of the second optically anisotropic layer owing to the deformation thereof may be reduced. As a result, the corner unevenness to be caused by the deformation of the second optically anisotropic layer may be therefore reduced.

In the invention, the first and/or second optically anisotropic layers to be formed according to a coating or transferring method may be formed on the other member of a liquid-crystal display device, for example, on the surface of a protective film of a polarizing element or an optically-compensatory film, directly or optionally via any other layer (e.g., alignment film) by coating a composition or transferring a layer of a composition thereto.

In one embodiment of the liquid-crystal display device of the invention, the above first optically anisotropic layer is a polymer film satisfying the above formulae (a1) to (a3), and on its surface, the second optically anisotropic layer satisfying the above formulae (b1) to (b6) is formed directly or optionally via any other layer (e.g., alignment film) by coating a composition or transferring a layer of a composition thereto.

In another embodiment of the invention, the second optically anisotropic layer is a biaxial polymer film satisfying the above formulae (b1) to (b6), and on its surface, the first optically anisotropic layer satisfying the above formulae (a1) to (a3) is formed directly or optionally via any other layer (e.g., alignment film) by coating a composition or transferring a layer of a composition thereto.

The multilayered film that comprises the first or second optically anisotropic layer of a polymer film and, as formed on its surface according to a coating or transferring method, the second or first optically anisotropic layer may be incorporated in various modes of liquid-crystal display devices, especially in VA-mode devices as an optically-compensatory film therein. The multilayered film may be integrated as a member of a polarizing plate with a polarizing element formed of a polyvinyl alcohol film or the like, which may be incorporated in various modes of liquid-crystal display devices, especially in VA-mode devices. Using the multilayered film is favorable as improving the workability in incorporating it in liquid-crystal display devices.

Still another embodiment of the liquid-crystal display device of the invention comprises a polymer film satisfying the above formulae (a1) to (a3) (first optically anisotropic layer) as a protective film of one polarizing element (the protective film disposed on the side of the liquid-crystal cell) and comprises the second optically anisotropic layer satisfying the above formulae (b1) to (b6) formed by coating a composition or transferring a layer of a composition to the surface of the protective film of the other polarizing element (the protective film disposed on the side of the liquid-crystal cell) directly or optionally via any other layer (e.g. alignment film) thereon.

Still another embodiment of the liquid-crystal display device of the invention comprises a biaxial polymer film satisfying the above formulae (b1) to (b6) (second optically anisotropic layer) as a protective film of one polarizing element (the protective film disposed on the side of the liquid-crystal cell) and comprises the first optically anisotropic layer satisfying the above formulae (a1) to (a3) formed by coating a composition or transferring a layer of a composition to the surface of the protective film of the other polarizing element (the protective film disposed on the side of the liquid-crystal cell) directly or optionally via any other layer (e.g., alignment film) thereon.

Various embodiments of the liquid-crystal display device of the invention are described herein under with reference to the drawings attached hereto.

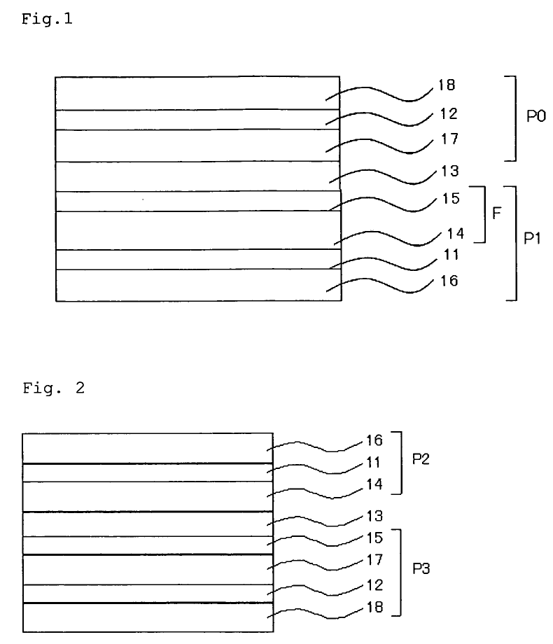

FIG. 1 is a schematic cross-sectional view of one example of a liquid-crystal display device of the invention. FIG. 1 is an example of a constitution of a VA-mode liquid-crystal display device, comprising a VA-mode liquid-crystal cell 13, and a pair of first polarizing element 11 and second polarizing element 12 disposed to sandwich the liquid-crystal cell 13 therebetween. Between the first polarizing element 11 and the liquid-crystal cell 13, the device has a first optically anisotropic layer 14 satisfying the above formulae (a1) to (a3) and, as formed thereon according to a coating or transferring method, a second optically anisotropic layer 15 satisfying the above formulae (b1) to (b6). On the surface of the first optically anisotropic layer 14 of a polymer film, formed is the second optically anisotropic layer 15 of a liquid-crystal composition or a polymer composition, directly or via any other layer thereon, according to a coating method or a transferring method, thereby producing an optically-compensatory film F, and this may be incorporated into a liquid-crystal display device.

In general, the polarizing elements 11 and 12 are formed of a polyvinyl alcohol film or the like, and therefore their water absorption is high. Accordingly, in general, a protective film is laminated on the surface of the two, and the resulting laminate polarizing plate may be incorporated in a liquid-crystal display device. In FIG. 1, the polarizing element 12 is a laminate polarizing plate P0 with the protective films 17 and 18 disposed on its both surfaces; and the polarizing element 11 is a laminate polarizing plate P1 with the protective film 16 on its outer surface and with the optically-compensatory film F as the protective film on the other surface thereof, and these may be incorporated in a liquid-crystal display device. The polarizing plate P1 is so disposed that its optically-compensatory film F is on the side of the liquid-crystal cell 13, and that the surface of the second optically anisotropic layer 15 formed according to a coating or transferring method, is on the side of the liquid-crystal cell 13.

In general, the polarizing elements 11 and 12 are so disposed that their transmission axes cross perpendicularly to each other. The first optically anisotropic layer 14 has an in-plane slow axis, and the slow axis is preferably perpendicular to the absorption axis of the first polarizing element 11.

FIG. 2 is a schematic cross-sectional view of another example of a liquid-crystal display device of the invention. In this, the same members as in FIG. 1 are given the same reference numerals, and their detailed description is omitted herein. The same shall apply to the other drawings. In the liquid-crystal display device of FIG. 2, the VA-mode liquid-crystal cell 13 is disposed between the polarizing plates P2 and P3. The polarizing plate P2 comprises a polarizing element 11, a protective film 16 disposed on the outer surface thereof, and a polymer film satisfying the optical characteristics of the first optically anisotropic layer 14 and serving as a protective film of the polarizing element 11. The polarizing plate P3 comprises a polarizing element 12, protective films 17 and 18 disposed on its outer surface and on the side of the liquid-crystal cell. The protective film 17 disposed on the side of the liquid-crystal cell is a polymer film such as a cellulose acylate film, and has the second optically anisotropic layer 15 formed thereon directly or via any other layer (e.g., alignment film) according to a coating or transferring method thereon, therefore this is in the form of a multilayered film.

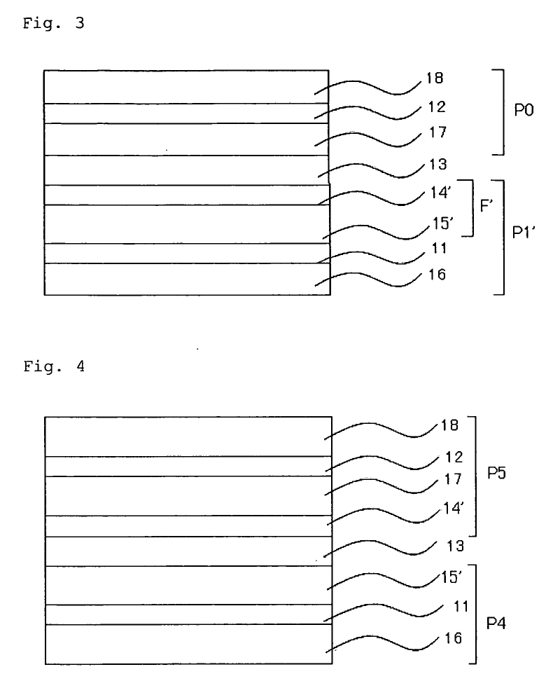

FIG. 3 is a schematic cross-sectional view of another example of a liquid-crystal display device of the invention. The liquid-crystal display device of FIG. 3 comprises a pair of a first polarizing element 11 and a second polarizing element 12 disposed to sandwich a VA-mode liquid-crystal cell 13 therebetween. Between the first polarizing element 11 and the liquid-crystal cell 13, the device has a first optically anisotropic layer 14′ satisfying the above formulae (a1) to (a3) and formed according to a coating or transferring method, and a second optically anisotropic layer 15′ satisfying the above formulae (b1) to (b6). On the surface of the second optically anisotropic layer 15′ of a monoaxial or biaxial polymer film, formed is the first optically anisotropic layer 14′ of a liquid-crystal composition or a polymer composition directly or via any other layer thereon according to a coating method or a transferring method, thereby producing an optically-compensatory film F′, and this may be incorporated into a liquid-crystal display device. The polarizing element 11 may be a laminate polarizing plate P1′ that comprises a protective film 16 on its outer surface and an optically-compensatory film F′ formed on the other surface thereof as a protective film, and the polarizing plate P1′ may be incorporated in a liquid-crystal display device. The polarizing plate P1′ is so disposed that its optically-compensatory film F′ is on the side of the liquid-crystal cell 13, and that the surface of the first optically anisotropic layer 14′ formed according to a coating or transferring method, is on the side of the liquid-crystal cell 13.

FIG. 4 is a schematic cross-sectional view of another example of a liquid-crystal display device of the invention. In the liquid-crystal display device of FIG. 4, the VA-mode liquid-crystal cell 13 is disposed between polarizing plates P4 and P5. The polarizing plate P4 comprises a polarizing element 11, a protective film 16 disposed on the outer surface thereof, and a polymer film satisfying the optical characteristics of the second optically anisotropic layer 15′ and serving as a protective film of the polarizing element 11. The polarizing plate P5 comprises a polarizing element 12, protective films 17 and 18 disposed on its outer surface and on the side of the liquid-crystal cell. The protective film 17 disposed on the side of the liquid-crystal cell is a polymer film such as a cellulose acylate film, and has the first optically anisotropic layer 14′ formed thereon directly or via any other layer (e.g., alignment film) according to a coating or transferring method thereon, therefore this is in the form of a multilayered film.

The VA-mode liquid-crystal display devices of FIG. 1 to FIG. 4 comprise the first optically anisotropic layer which satisfies the above formulae (a1) to (a3) and of which Rth has regular wavelength dispersion characteristics (14 or 14′ in the drawings), and the second optically anisotropic layer which satisfies the above formulae (b1) to (b6) and of which Re and Rth both have reversed wavelength dispersion characteristics (15 or 15′ in the drawings), therefore evading the contrast reduction color shift occurring in oblique direction in the black state.

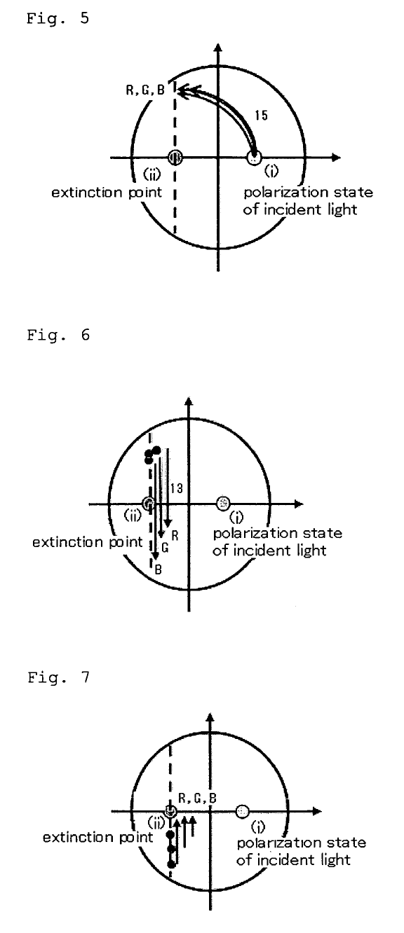

One example of optical compensation in the liquid-crystal display device of the invention is described on a Poincare sphere. FIG. 5 to FIG. 7 are views showing the change in the polarization state of incident light to the liquid-crystal display device of FIG. 2, on a Poincare sphere. The Poincare sphere is a three-dimensional map to describe a polarization state, and the equator of the sphere indicates linear polarization. In this, the light propagation direction in the liquid-crystal display device is at an azimuth direction of 45 degrees and a polar direction of 34 degrees. In FIG. 5 to FIG. 7, the S2 axis is an axis running through the paper vertically from the back to the top; and FIG. 5 to FIG. 7 show a view to see a Poincare sphere from the positive direction of the S2 axis. In this, S1, S2 and S3 coordinates indicate values of stoke parameters in a certain polarization state. FIG. 5 to FIG. 7 show the two-dimensional condition, in which, therefore, the displacement at the point before and after the change of the polarization state is shown by the linear arrow in the drawings. In fact, however, the polarization state change in light having passed through a liquid-crystal layer and an optically-compensatory film is represented by rotation at a specific angle around a specific axis determined in accordance with the individual optical characteristics, on a Poincare sphere. The rotation angle is proportional to the reciprocal number of the wavelength of the incident light, and is proportional to the retardation value in the retardation region through which the incident light runs.

The polarization state of the incident light having passed through the polarizing element 12 of the liquid-crystal display device of FIG. 2 corresponds to the point (i) in FIG. 5 to FIG. 7; and the polarization state of the light as blocked by the absorption axis of the polarizing element 11 in FIG. 2 corresponds to the point (ii) in FIG. 5. Heretofore, in a VA-mode liquid-crystal display device, the off-axis light leakage in an oblique direction is caused due to the shift of the polarization state of the out-going light from the point (ii). The first optically anisotropic layer 14 and the second optically anisotropic layer 15 are used for changing the polarization state of the incident light correctly from the point (i) to the point (ii), including the polarization state change in the liquid-crystal cell 13.

First, the light having passed through the second optically anisotropic layer 15 is converted by the retardation of the second optically anisotropic layer 15. In this case, the conversion level, or that is, the rotation angle on a Poincare sphere decreases with longer wavelength of the light; but on the other hand, the retardation of the second optically anisotropic layer 15 has reversed wavelength dispersion characteristics, and therefore the two factors are offset each other, and as in FIG. 5, the polarization state of R light, G light and B light, after having passed through the second optically anisotropic layer 15, could almost correspond on the S1 coordinates on a Poincare sphere.

Afterwards, as in FIG. 6, the polarization state of the R light, the B light and the G light having passed through the VA-mode liquid-crystal cell 13 changes like the arrow 13 shown in the drawing, with the result that the S3 coordinates differ for light separation; and the separation may be evaded by utilizing the wavelength dispersion characteristics of the retardation of the first optically anisotropic layer 14. More concretely, when the first optically anisotropic layer 14 is formed of a material that satisfies the above formula (a1) and has regular wavelength dispersion characteristics of Rth thereof, then, as in FIG. 7, the polarization state of all the R light, the G light and the B light may be converted into that on the S1 axis, or that is, into the extinction point (ii) with no difference in the S1 coordinates for the light, as indicated by the arrow 14 in the drawing. As a result, in the oblique direction, the color shift may be reduced more and the contrast may be improved more.

One example of optical compensatory mechanism is shown in FIG. 5 to FIG. 7, to which, however, the invention should not be limited.

Preferred embodiments of the optical characteristics, the materials and the production methods for the first optically anisotropic layer and the second optically anisotropic layer usable in the invention are described in detail herein under.

### [First Optically Anisotropic Layer]

Preferably, the liquid-crystal display device of the invention comprises a first optically anisotropic layer which satisfies the following formula (a1), of which Rth increases with a shorter wavelength within a visible light range, or that is, a first optically anisotropic layer having regular wavelength dispersion characteristics of Rth. More preferably, the first optically anisotropic layer satisfies the following formulae (a1) to (a3):

10<Rth(548)/Re(548) (a1)

30nm≦Rth(548)≦400nm (a2)

1<Rth(446)/Rth(548)<1.5 (a3)

The invention includes an embodiment in which Re of the first optically anisotropic layer satisfies Re(548)=0. More preferably, the layer satisfies Rth(548)/Re(548)>15. Rth(548) is preferably from 50 to 400 nm, more preferably from 75 to 300 nm.

Preferably, the first optically anisotropic layer satisfies the above formula (a3), or that is, the layer is characterized in that its Rth has regular wavelength dispersion characteristics of the retardation.

The material for use in producing the first optically anisotropic layer is not specifically defined. When the first optically anisotropic layer is a polymer film, a polarizing element may be stuck to it. As a single member, for example, as an optical compensatory film, it may be incorporated in a liquid-crystal display device. The material for the polymer film is preferably a polymer having good optical properties, transparency, mechanical strength, thermal stability, water shield ability and isotropic properties; however, any material satisfying the above-mentioned condition may be employed herein. For example, it includes polycarbonate-type polymer, polyester-type polymer such as polyethylene terephthalate and polyethylene naphthalate, acrylic polymer such as polymethyl methacrylate, and styrenic polymer such as polystyrene and acrylonitrile/styrene copolymer (AS resin). In addition, also employable are polyolefin-type polymer, for example, polyolefin such as polyethylene and polypropylene, and ethylene/propylene copolymer; vinyl chloride-type polymer; amide-type polymer such as nylon and aromatic polyamide; imide-type polymer, sulfone-type polymer, polyether sulfone-type polymer, polyether-ether ketone-type polymer, polyphenylene sulfide-type polymer, vinylidene chloride-type polymer, vinyl alcohol-type polymer, vinyl butyral-type polymer, arylate-type polymer, polyoxymethylene-type polymer, epoxy-type polymer; and mixed polymer of the above polymers.

As the material to form the polymer film, preferably used is a thermoplastic norbornene-type resin. The thermoplastic norbornene-type resin includes Nippon Zeon's Zeonex and Zeonoa, and JSR's Arton, etc.

As the material to form the polymer film, especially preferred is a cellulose polymer (hereinafter this may be referred to as cellulose acylate) heretofore used as a transparent protective film for polarizing element. One typical example of cellulose acylate is triacetyl cellulose. The cellulose material for cellulose acylate includes cotton liter and wood pulp (hardwood pulp, softwood pulp), and cellulose acylate obtained from any such cellulose material is usable herein. As the case may be, those cellulose materials may be mixed for use herein. The cellulose materials are described in detail, for example, in Marusawa & Uda's “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein. There should not be any specific limitation to the cellulose acylate film for use in the invention.

Regarding the degree of acyl substitution of the cellulose acylate for the cellulose acylate film for the first optically anisotropic layer, the cellulose acylate may have an acetyl group alone, or may be a composition of cellulose acylates having plural acyl substituents. As preferred examples of the cellulose acylate, the degree of total acylation may be from 2.3 to 3.0, preferably from 2.4 to 2.95, more preferably from 2.5 to 2.93.

As the acyl substituent for the cellulose acylate, also preferred is a mixed fatty acid ester. Preferably, the aliphatic acyl group of the fatty acid ester residue have from 2 to 20 carbon atoms. Concretely, the group includes acetyl, propionyl, butyryl, isobutyryl, valeryl, pivaloyl, hexanoyl, octanoyl, lauroyl, stearoyl; and preferred are acetyl, propionyl and butyryl.

The cellulose acylate may be a mixed acid ester having a fatty acid acyl group and a substituted or unsubstituted aromatic acyl group.

The degree of substitution with an aromatic acyl group in a cellulose fatty acid monoester is preferably at most 2.0, more preferably from 0.1 to 2.0 relative to the remaining hydroxyl group. In a cellulose fatty acid diester (cellulose diacetate), it is preferably at most 1.0, more preferably from 0.1 to 1.0 relative to the remaining hydroxyl group.

Preferably, the cellulose acylate has a mass-average degree of polymerization of from 350 to 800, more preferably from 370 to 600. Also preferably, the cellulose acylate for use in the invention has a number-average molecular weight of from 70000 to 230000, more preferably from 75000 to 230000, even more preferably from 78000 to 120000.

The cellulose acylate may be produced, using an acid anhydride or an acid chloride as the acylating agent for it. One most general production method on an industrial scale comprises esterifying cellulose obtained from cotton linter, wood pulp or the like with a mixed organic acid component containing an organic acid corresponding to an acetyl group and other acyl group (acetic acid, propionic acid, butyric acid) or its acid anhydride (acetic anhydride, propionic anhydride, butyric anhydride).

The cellulose acylate film is preferably produced according to a solvent-casting method. Examples of production of cellulose acylate film according to a solvent-casting method are given in U.S. Pat. Nos. 2,336,310, 2,367,603, 2,492,078, 2,492,977, 2,492,978, 2,607,704, 2,739,069 and 2,739,070, British Patent Nos. 640731 and 736892, JPB Nos. syo 45-4554 and syo 49-5614, and JPA Nos. syo 60-176834, syo 60-203430 and syo 62-115035, and their descriptions are referred to herein. The cellulose acylate film may be stretched. Regarding the method and condition for stretching treatment, for example, referred to are JPA Nos. syo 62-115035, hei 4-152125, hei 4-284211, hei 4-298310 and hei 11-48271.

### [Rth Enhancer]

For preparing a cellulose acylate film satisfying the condition required for the first optically anisotropic layer, an Rth enhancer may be added to the cellulose acylate film. It is noted that the term “Rth enhancer” is used for any compounds capable of developing or enhancing birefringence in the thickness direction.

Preferably the compounds having an absorption peak at a wavelength from 250 nm to 380 nm and exhibiting high polarizability anisotropy are employed as the Rth enhancer. The compounds represented by the formula (I) are especially preferred as the Rth enhancer.

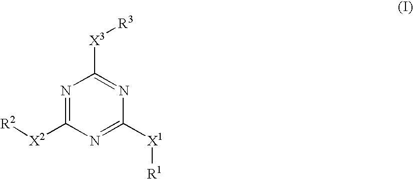

In the formula (I), X¹ represents a single bond, —NR⁴—, —O—or —S—;X² represents a single bond, —NR⁵—, —O—or —S—;X³ represents a single bond, —NR⁶—, —O—or —S—. And, R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group.

Preferred examples, I-(1) to IV-(10), of the compound represented by the formula (I) include, but are not limited to, those shown below.

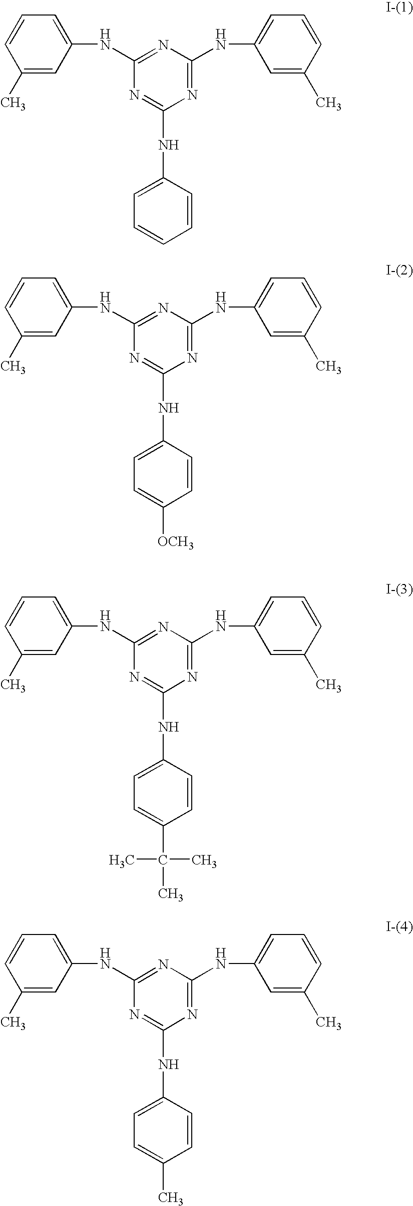

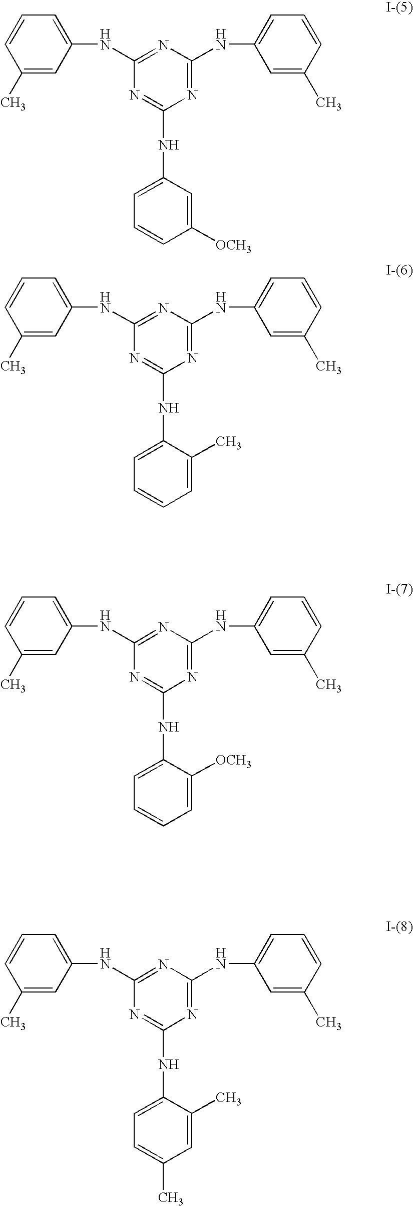

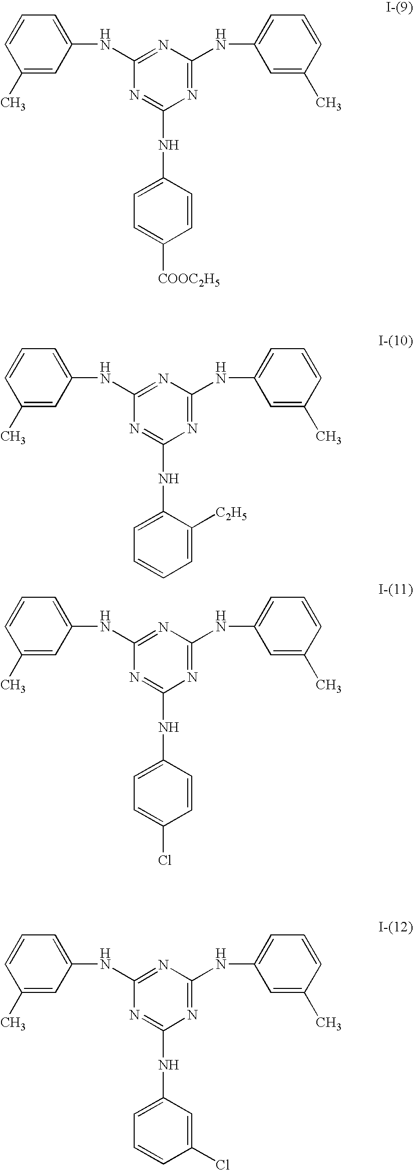

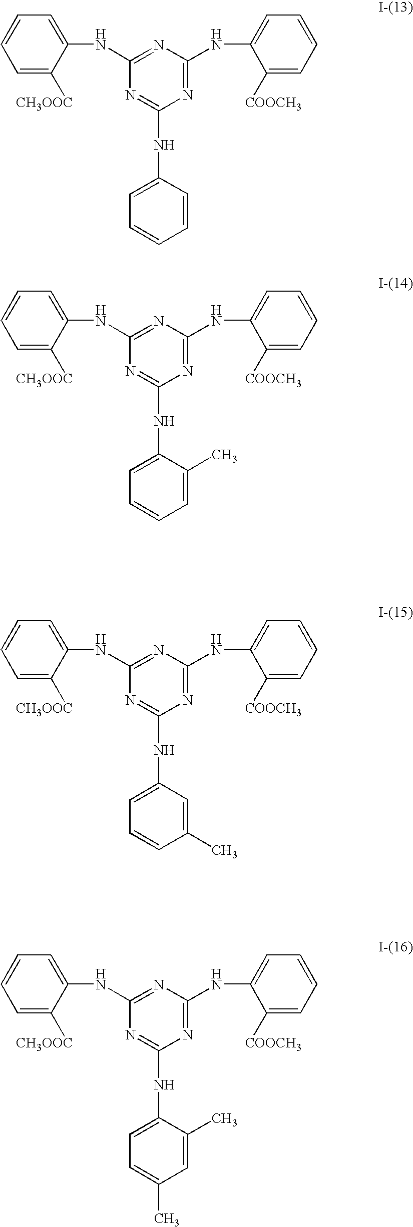

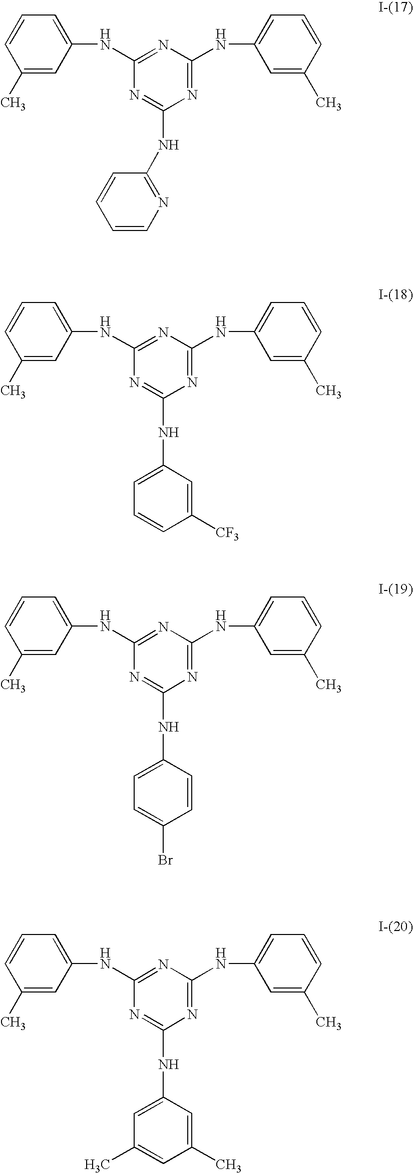

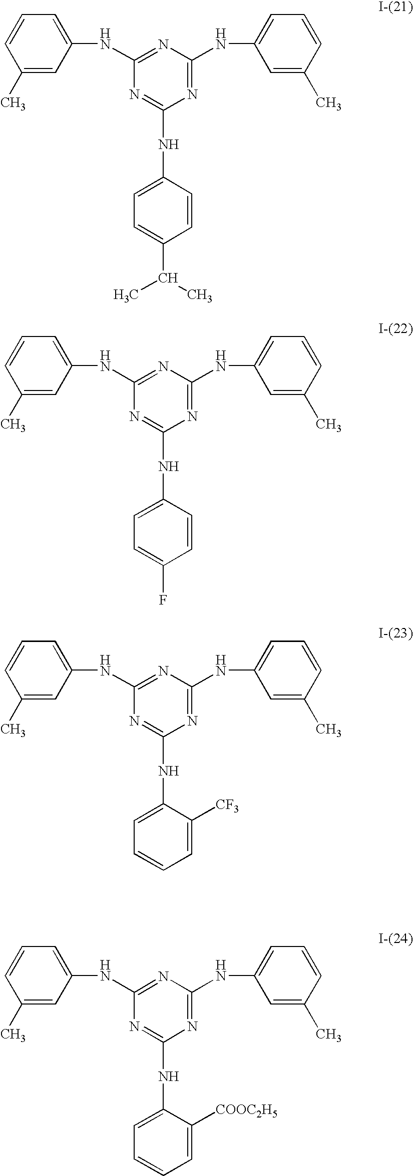

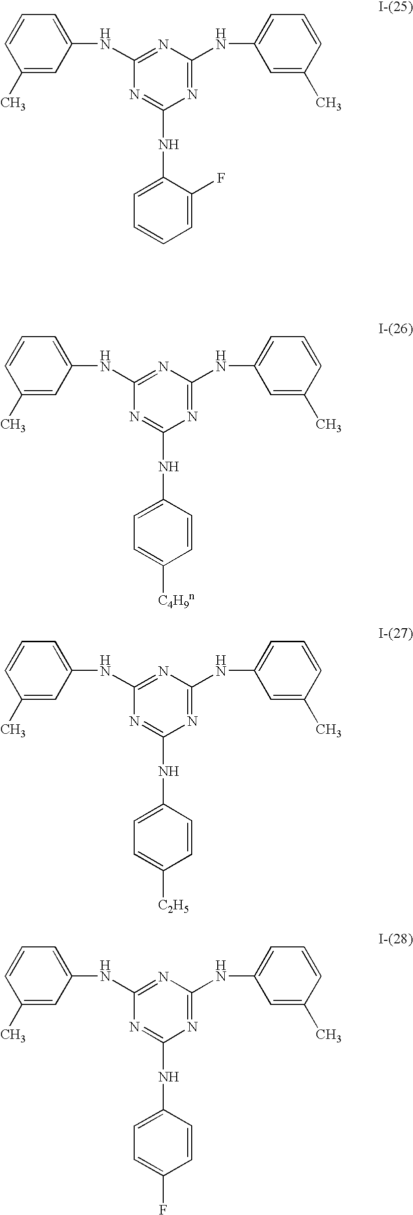

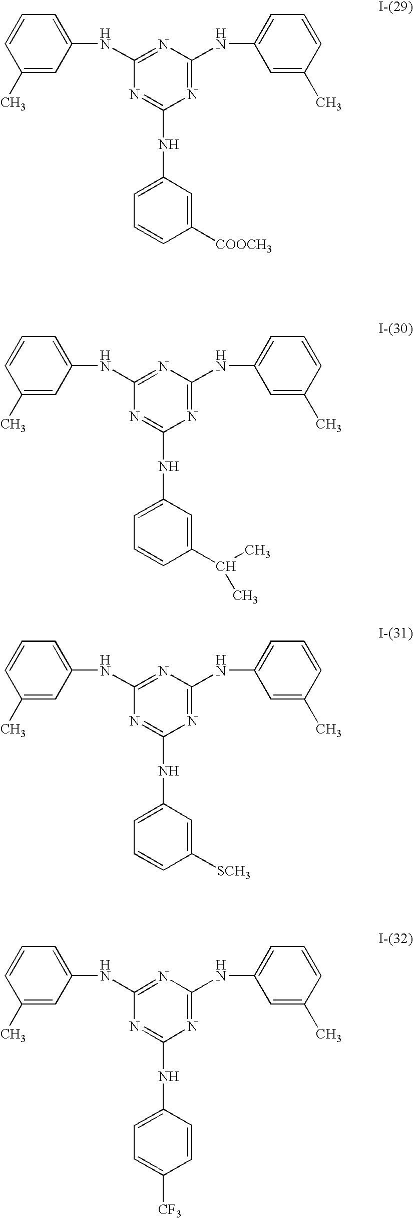

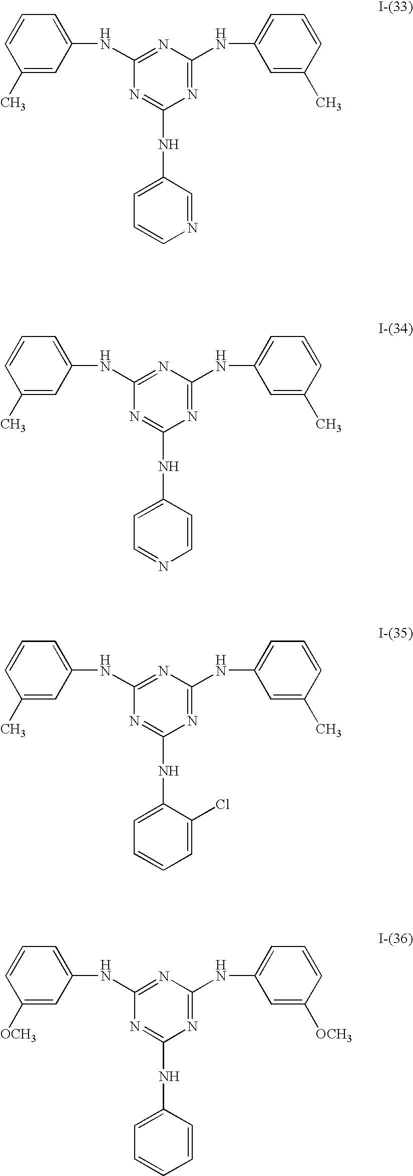

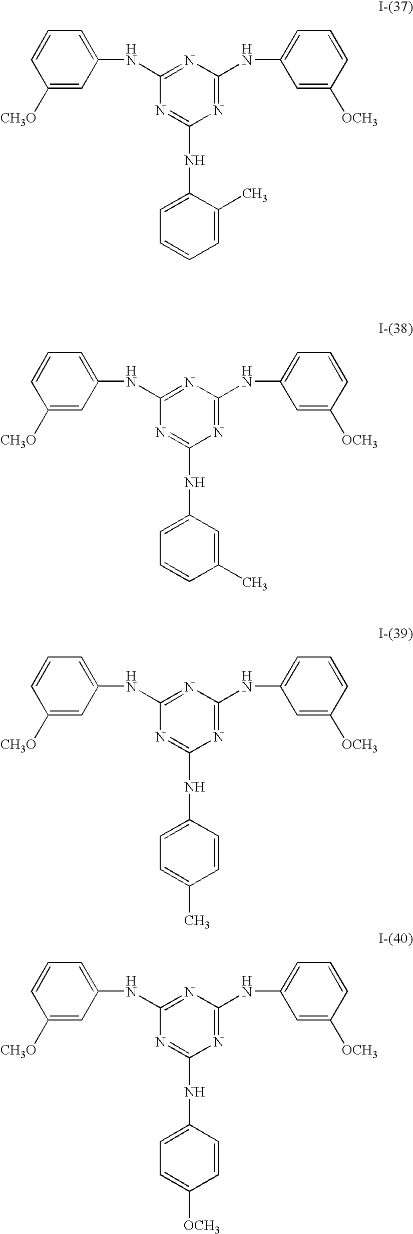

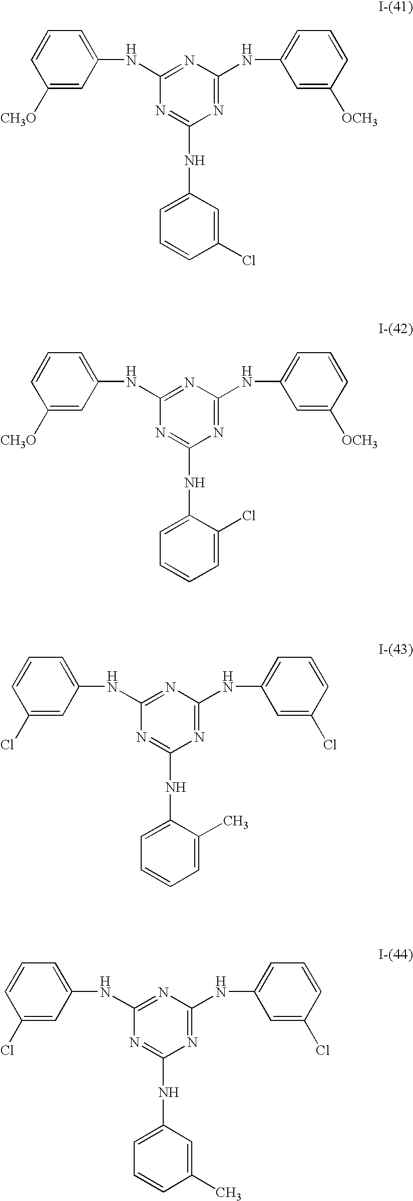

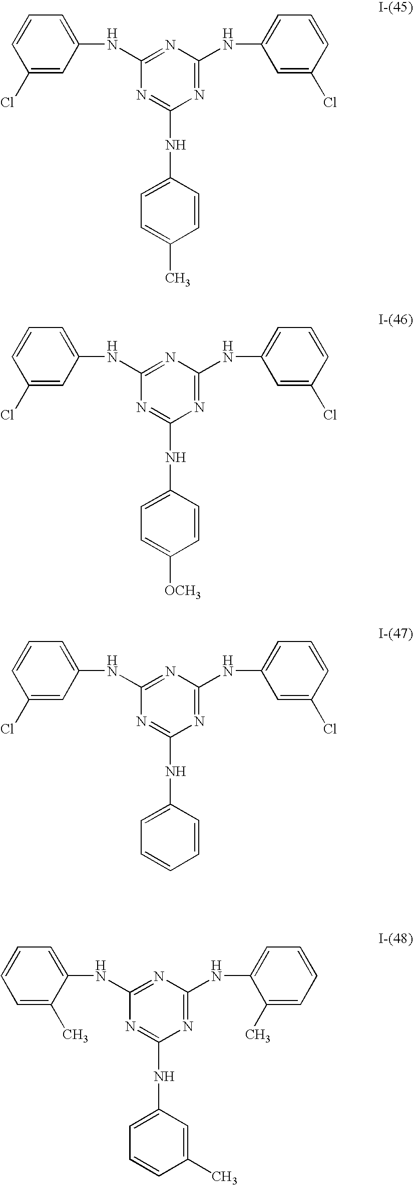

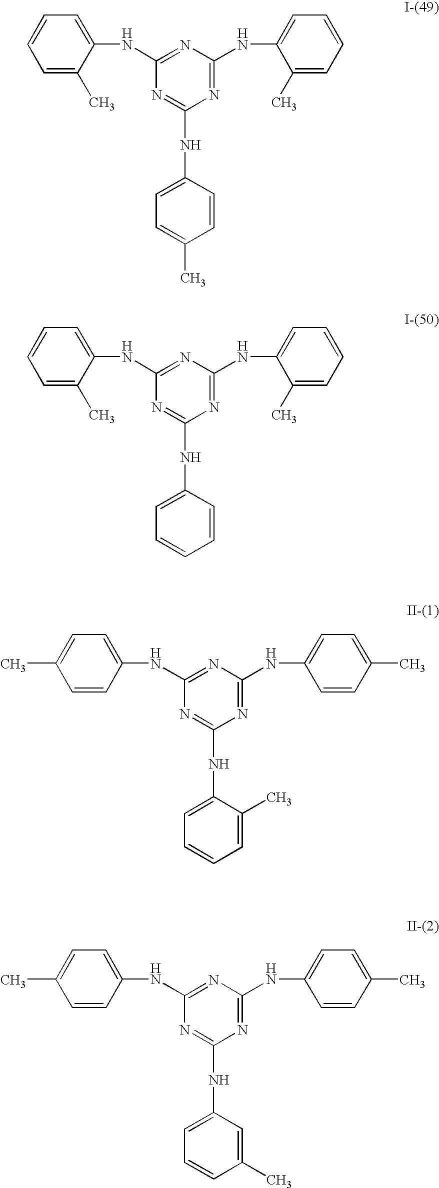

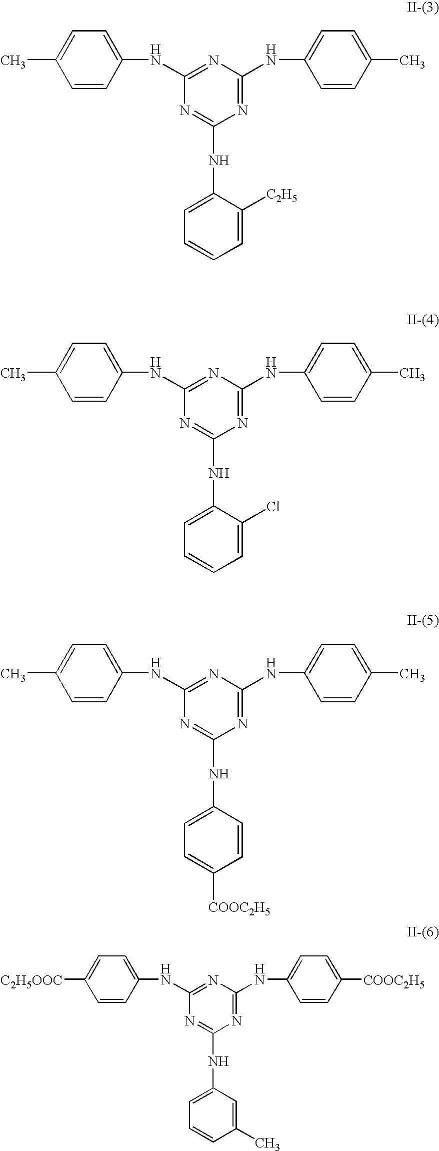

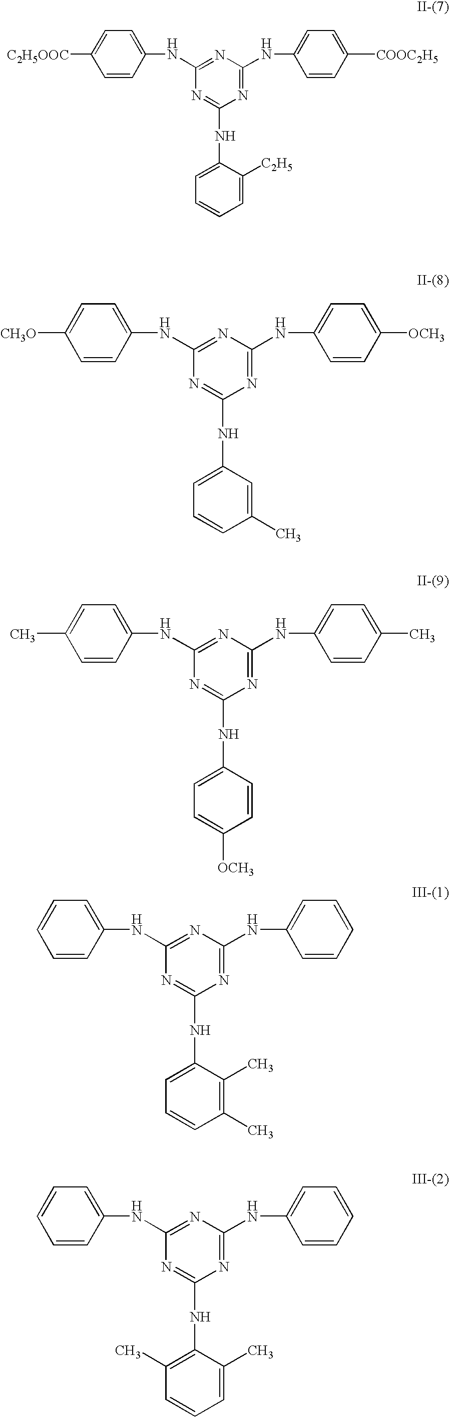

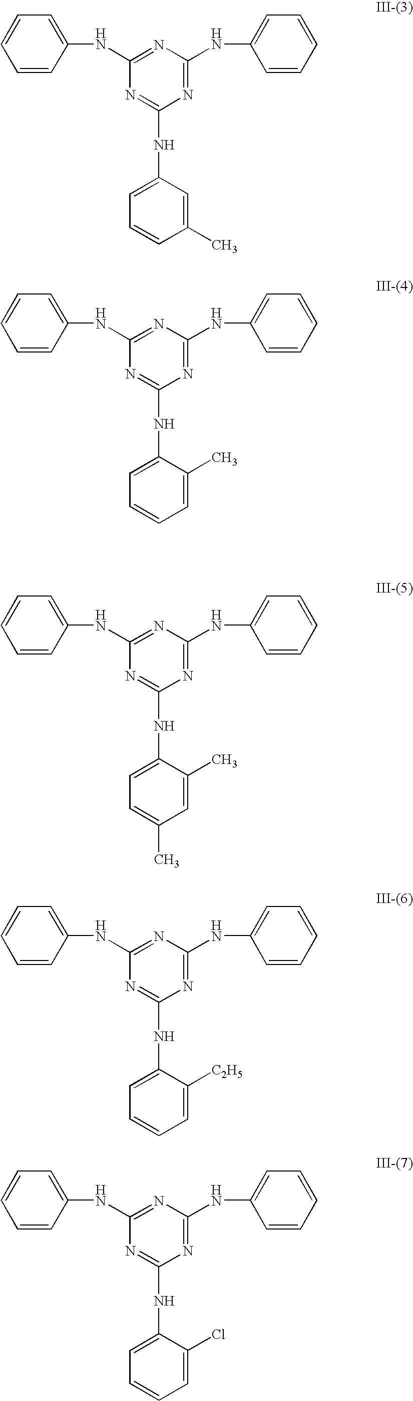

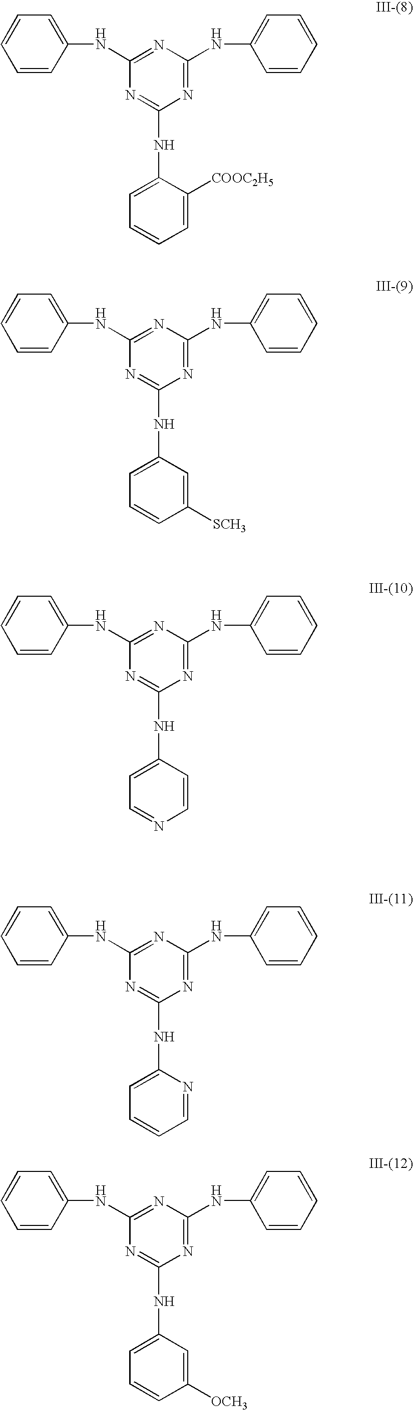

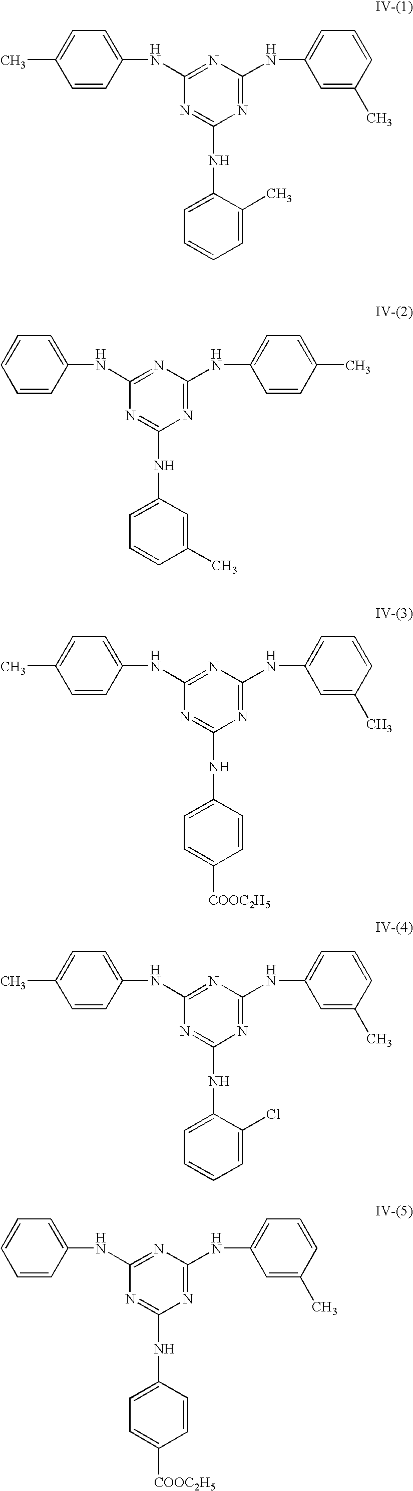

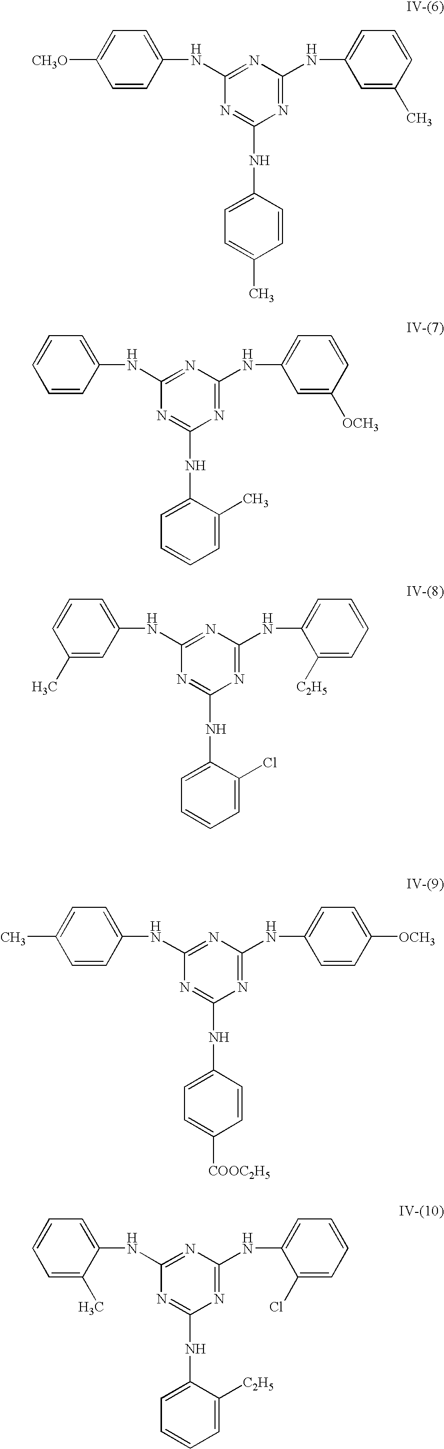

The compounds represented by the formula (II) are also preferred as the Rth enhancer. The formula (II) will be described in detail.

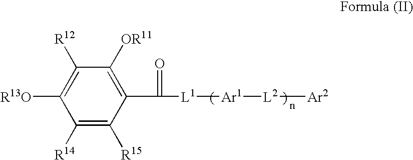

In the formula (II), R¹², R¹⁴ and R¹⁵ independently represent a hydrogen atom or a substituent; R¹¹ and R¹³ independently represent a hydrogen atom or an alkyl group; and L¹ and L² independently represent a single bond or a bivalent linking group. In the formula, Ar¹ represents an arylene group or an aromatic heterocyclic group; Ar² represents an arylene group or an aromatic heterocyclic group; n is an integer equal to or more than 3; “n” types of L² and Ar¹ may be same or different from each other. R¹¹ and R¹³ are different from each other, and the alkyl group represented by R¹³ doesn't include any hetero atoms.

In the formula (II), R¹², R¹¹ and R¹⁵ respectively represent a hydrogen atom or a substituent. The substituent may be selected from Substituent Group T described later.

In the formula (II), R¹² preferably represents a hydrogen atom, an alkyl group, an alkoxy group, an amino group or hydroxy; more preferably a hydrogen atom, an alkyl group or an alkoxy group; much more preferably a hydrogen atom, a C₁₋₄ alkyl group such as methyl or a C₁₋₁₂ (the preferred is C₁₋₈, the more preferred is C₁₋₆ and the specially preferred is C₁₋₄) alkoxy group; further much more preferably a hydrogen atom, a C₁₋₄ alkyl group or a C₁₋₄ alkoxy group; especially preferably a hydrogen atom, methyl or methoxy; and most preferably a hydrogen atom.

In the formula (II), R¹⁴ preferably represents a hydrogen atom or an electron donating substituent; more preferably a hydrogen atom, an alkyl group, an alkoxy group, an amino group or hydroxy; much more preferably a hydrogen atom, a C₁₋₄ alkyl group or a C₁₋₁₂ (the preferred is C₁₋₈, the more preferred is C₁₋₆ and the especially preferred is C₁₋₄) alkoxy group; and especially preferably a hydrogen atom, a C₁₋₄ alkyl group or a C₁₋₄ alkoxy group; and most preferably a hydrogen atom or methoxy.

In the formula (II), R¹⁵ preferably represents a hydrogen atom, a halogen atom, an alkyl group, an alkoxy group, an amino group or hydroxy; more preferably a hydrogen atom, an alkyl group or an alkoxy group; much more preferably a hydrogen atom, a C₁₋₄ alkyl group such as methyl or a C₁₋₁₂ (the preferred is C₁₋₈, the more preferred is C₁₋₆ and the especially preferred is C₁₋₄) alkoxy group; especially preferably a hydrogen atom, methyl or methoxy; and most preferably a hydrogen atom.

In the formula (II), R¹¹ and R¹³ respectively represent a hydrogen atom or an alkyl group, provided that R¹¹and R¹³ are different from each other and the alkyl group represented by R¹³ doesn't include any hetero atoms. The term “hetero atom” is used for any atoms other than hydrogen and carbon atoms and examples of the hetero atom include oxygen, nitrogen, sulfur, phosphorus, halogen (F, Cl, Br, I) and boron atoms.

The alkyl group represented R¹¹ or R¹³ may have a linear or branched chain structure or a cyclic structure, and be selected from not only non-substituted alkyl groups but also substituted alkyl groups. The alkyl group is preferably selected from substituted or non-substituted C₁₋₃₀ alkyl groups, substituted or non-substituted C₃₋₃₀ cycloalkyl groups, substituted or non-substituted C₅₋₃₀ bicycloalkyl groups, namely monovalent groups made of C₅₋₃₀ bicycloalkanes by removing a hydrogen atom therefrom, and tricycloalkyl groups.

Preferable examples of the alkyl group represented by R¹¹ or R¹³ include methyl, ethyl, n-propyl, isopropyl, n-butyl, sec-butyl, n-pentyl, iso-pentyl, n-hexyl, n-heptyl, n-octyl, tert-octyl, 2-ethylhexyl, n-nonyl, 1,1,3-trimethyl hexyl, n-decyl, 2-hexyldecyl, cyclohexyl, cycloheptyl, 2-hexenyl, oleyl, linoleyl, and linolenil. Examples of the cycloalkyl group include cyclohexyl, cyclopentyl, 4-n-dodecylcyclohexy; and examples of the bicycloalkyl group include bicyclo [1,2,2] heptane-2-yl and bicyclo [2,2,2] octane-3-yl.

R¹¹ preferably represents a hydrogen atom, methyl, ethyl, n-propyl or iso-propyl; and more preferably a hydrogen atom or methyl; and most preferably methyl.

R¹³ preferably represents a C₂ or longer alkyl group, and more preferably a C₃ or longer alkyl group. Among them, branched or cyclic alkyl groups are preferred.

Specific examples (O-1 to O-20) of the alkyl group represented by R¹³ include, but are not limited to, those shown below. It is noted that “#” means the position of the oxygen atom side.

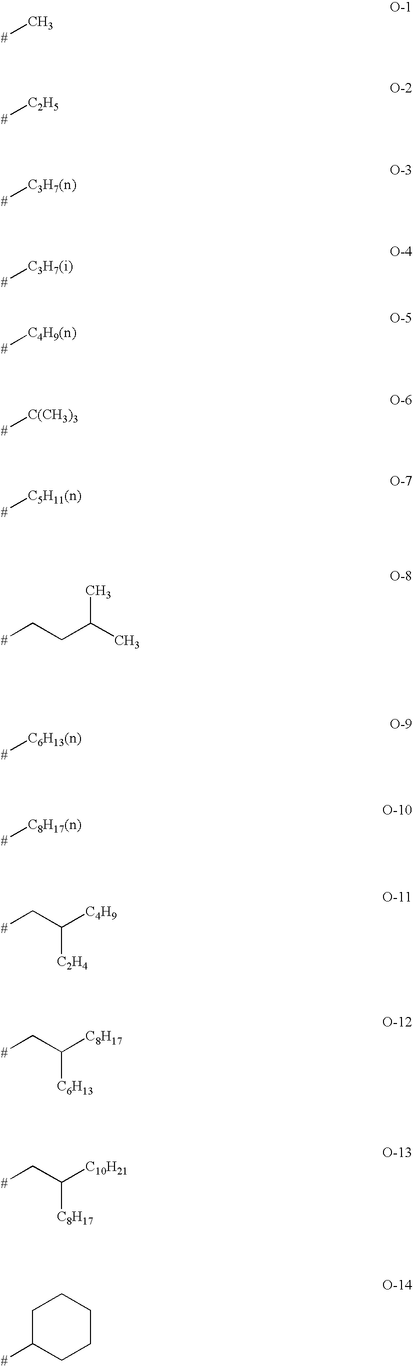

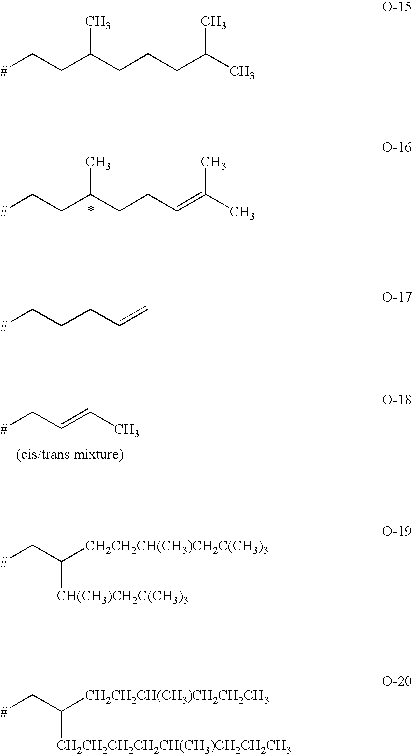

In the formula (II), Ar¹ represents an arylene group or an aromatic heterocyclic group and Ar¹ in each repeating unit may be same or different.

In the formula (II), Ar²represents an aryl group or an aromatic heterocyclic group.

The arylene group presented by Ar¹ in the formula (II) may be selected from C₆₋₃₀ arylene groups, and have a single ring structure or a condensed ring structure with another ring. And the arylene group may have at least one substituent, and the substituent may be selected from Substituent Group T described later. The arylene group represented by Ar¹ is preferably selected from C₆₋₂₀, more preferably C₆₋₁₂ arylene groups, such as phenylene, p-methylphenylen and naphtylene.

The arylene group presented by Ar² in the formula (II) may be selected from C₆₋₃₀ arylene groups, and have a single ring structure or a condensed ring structure with another ring. And the arylene group may have at least one substituent, and the substituent may be selected from Substituent Group T described later. The arylene group represented by Ar² is preferably selected from C₆₋₂₀, more preferably C₆₋₁₂ arylene groups, such as phenylene, p-methylphenylen and naphtylene.

The aromatic heterocyclic group represented by Ar¹ or Ar² in the formula (II) may be selected from the groups of aromatic rings in which at least one hetero atom selected from oxygen, nitrogen and sulfur atoms is embedded, and is preferably selected from the groups of 5- or 6-membered aromatic rings in which at least one of a nitrogen and sulfur atoms is embedded. The aromatic heterocyclic group may have at least one substituent. The substituent may be selected from Substituent Group T.

Examples of the aromatic heterocyclic group represented by Ar¹ or Ar² in the formula (II) include furan, pyrrole, thiophene, imidazole, pyrazole, pyridine, pyrazine, pyridazine, triazole, triazine, indole, indazole, purine, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenadine, tetrazole, benzimidazole, benzoxazole, benzthiazole, benztriazole, tetraza indeline, pyrrolotriazole and pyrazotriazole. Preferred examples of the aromatic heterocyclic group include benzimidazole, benzoxazole, benzthiazole and benztriazole.

In the formula (II), L¹ and L² independently represent a single bond or a bivalent linking group. L¹ and L² may be same or different from each other. And L² in each repeating unit may be same or different from each other.

The bivalent linking group is preferably selected from the group consisting of —O—, -NR- (R represents a hydrogen atom or a substituted or non-substituted alkyl or aryl group), —CO—, —SO₂—, —S—, an alkylene group, a substituted alkylene group, an alkenylene group, a substituted alkenylene group, an alkynylene group, a substituted alkynylene group and any combinations of tow or more selected therefrom; and more preferably from the group consisting of —O—, -NR-, —CO—, —SO₂NR-, —NRSO₂—, —CONR-, -NRCO—, —COO—, —OCO—and an alkynylene group. Preferably, R represents a hydrogen atom.

In the compound represented by the formula (II), Ar¹ binds to L¹ and L². For the compound having a phenylene as Ar¹, it is preferable that L¹⁻Ar¹-L² and L²⁻Ar¹-L² are in a para-position (1,4-position) relation.

In the formula (II), n is an integer equal to or more than 3, preferably from 3 to 7, more preferably from 3 to 6 and much more preferably from 3 to 5.

Preferable examples of the formula (II) include the compounds represented by the formula (IV) and formula (V) shown below.

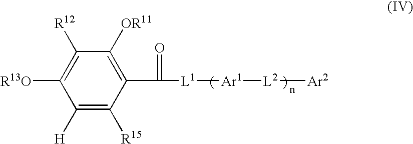

In the formula (IV), R¹² and R¹⁵ independently represent a hydrogen atom or a substituent; R¹¹and R¹³ independently represent a hydrogen atom or an alkyl group; L¹ and L² independently represent a single bond or a bivalent linking group; Ar¹ represents an arylene group or an aromatic heterocyclic group; Ar² represents an arylene group or an aromatic heterocyclic group; n is an integer equal to or more than 3; the “n” types of L² or Ar¹ may be same or different from each other; provided that R¹¹and R¹³ are different from each other and the alkyl group represented by R¹³ doesn't include any hetero atoms.

In the formula (IV), the meanings of R¹², R¹⁵, R¹¹and R¹³ are same as those in the formula (II); and preferred examples of R¹², R¹⁵, R¹¹ and R¹³ are same as those in the formula (II). In the formula (IV), the meanings of L¹, L², Ar¹ and Ar² are same as those in the formula (II); and preferred examples of L¹, L², Ar¹ and Ar² are same as those in the formula (III).

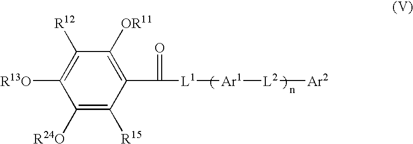

In the formula (V), R¹² and R¹⁵ independently represent a hydrogen atom or a substituent; R¹¹and R¹³ independently represent a hydrogen atom or an alkyl group; L¹ and L² independently represent a single bond or a bivalent linking group; Ar¹ represents an arylene group or an aromatic heterocyclic group; Ar² represents an arylene group or an aromatic heterocyclic group; n is an integer equal to or more than 3; the “n” types of L² or Ar¹ may be same or different from each other; provided that R¹¹and R¹³ are different from each other and the alkyl group represented by R¹³ doesn't include any hetero atoms.

In the formula (V), the meanings of R¹², R¹⁵, R¹¹ and R¹³ are same as those in the formula (II); and preferred examples of R¹², R¹⁵, R¹¹ and R¹³ are same as those in the formula (II). In the formula (V), the meanings of L¹, L², Ar¹ and Ar² are same as those in the formula (II); and preferred examples of L¹, L², Ar¹ and Ar² are same as those in the formula (II).

In the formula (V), R²⁴ represents a hydrogen atom or an alkyl group; and examples of the alkyl group are same as those preferably exemplified as an alkyl group prepresented by R¹¹or R³. In the formula, R²⁴ preferably represents a hydrogen atom or a C₁₋₄ alkyl group, more preferably a hydrogen atom or a C₁₋₃ alkyl group, and much more preferably methyl. In the formula, R¹¹ and R¹⁴ may be same or different from each other, and it is most preferred that both of R¹¹ and R²⁴ are methyl.

Preferable examples of the compound represented by the formula (V) include the compounds represented by the formula (V-A) and (V-B).

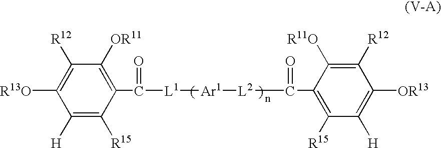

In the formula (V-A), R¹² and R¹⁵ independently represent a hydrogen atom or a substituent; R¹¹ and R¹³ independently represent a hydrogen atom or an alkyl group; L¹ and L² independently represent a single bond or a bivalent linking group; Ar¹ represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V-A), the meanings and preferable examples of R¹², R¹⁵, R¹¹, R¹³, L¹, L², Ar¹ and n may be same as those in the formula (II).

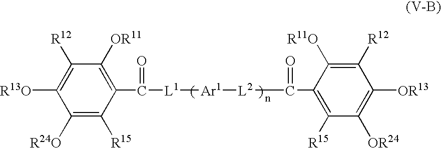

In the formula (V-B), R¹² and R¹⁵ independently represent a hydrogen atom or a substituent; R¹¹, R¹³ and R¹⁴ independently represent a hydrogen atom or an alkyl group; L¹ and L² independently represent a single bond or a bivalent linking group; Ar¹ represents an arylene group or an aromatic heterocyclic group; n is an integer equal to or more than 3; the “n” types of L² or Ar¹ may be same or different from each other; provided that R¹¹ and R¹³ are different from each other and the alkyl group represented by R¹³ doesn't include any hetero atoms.

In the formula (V-B), the meanings and preferable examples of R¹², R¹⁵, R¹¹, R¹³, R²⁴, L¹, L², Ar¹ and n may be same as those in the formula (II).

“Substituent Group T” will be described below.

### Substituent Group T:

Halogen atoms such as fluorine, chlorine, bromine and iodine atoms; alkyls (preferably C₁₋₃₀alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent- residues formed from C₅₋₃₀ bicycloalkanes from which a hydrogen atom is removed) such as bicyclo [1,2,2] heptane-2-yl and bicyclo [2,2,2] octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo [2,2,1] hepto-2-en-1-yl and bicyclo [2,2,2] octo-2-en-4-yl; alkynyls (preferably C₂₋₃₀ substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀ silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n- octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀substituted or non-substituted aryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino andmorpholinocarbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylaminosulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxy phosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Same or different two or more substituents may be selected. If possible, the substituents may bond to each other to form a ring.

Preferable examples of the compound represented by the formula (V-A) include the compounds in which R¹¹ is methyl, both of R¹² and R¹⁵ are hydrogen atoms, R¹³ is a C₃ or longer alkyl group, L¹ is a single bond, —O—, —CO—, -NR-, —SO₂NR-, -NRSO₂—, —CONR-, -NRCO—(R is a hydrogen atom or a substituted or non-substituted alkyl or aryl group, and preferably a hydrogen atom), —COO—, —OCO—or an alkylene; L² is —O—or -NR- (R is a hydrogen atom or a substituted or non-substituted alkyl or aryl group, and preferably a hydrogen atom); Ar¹ is an arylene group, and n is an integer from 3 to 6.

Examples of the compound represented by the formulae (V-A) and (V-B) include, but are not limited to, those shown below.

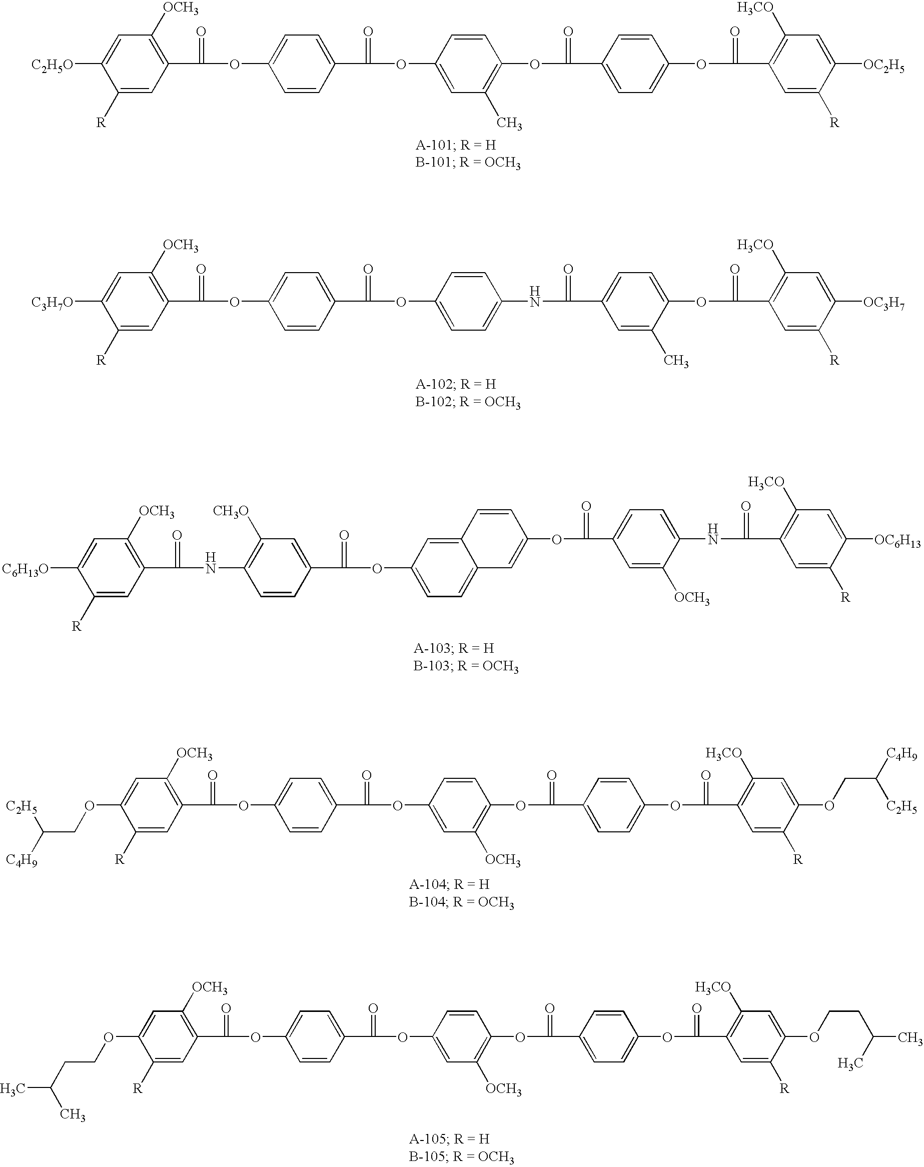

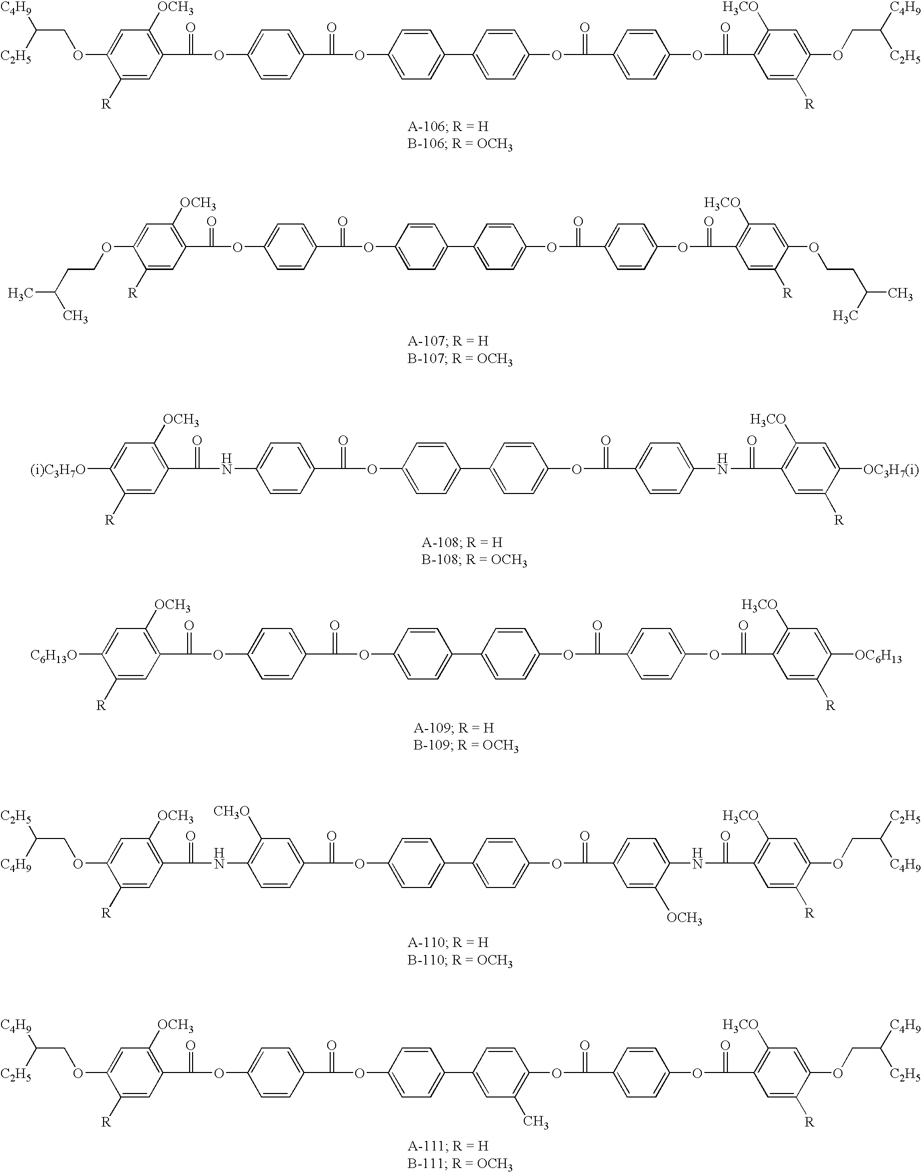

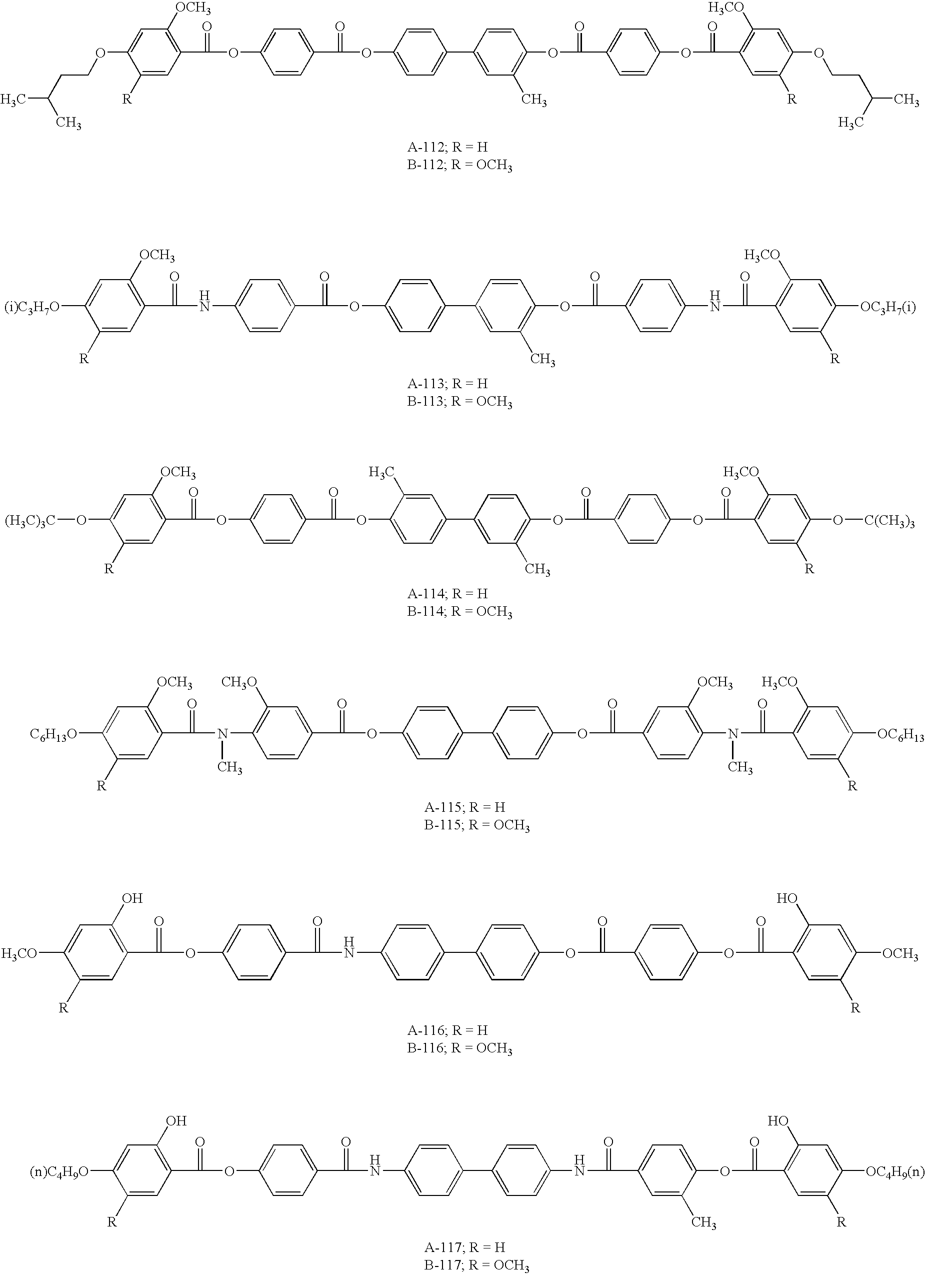

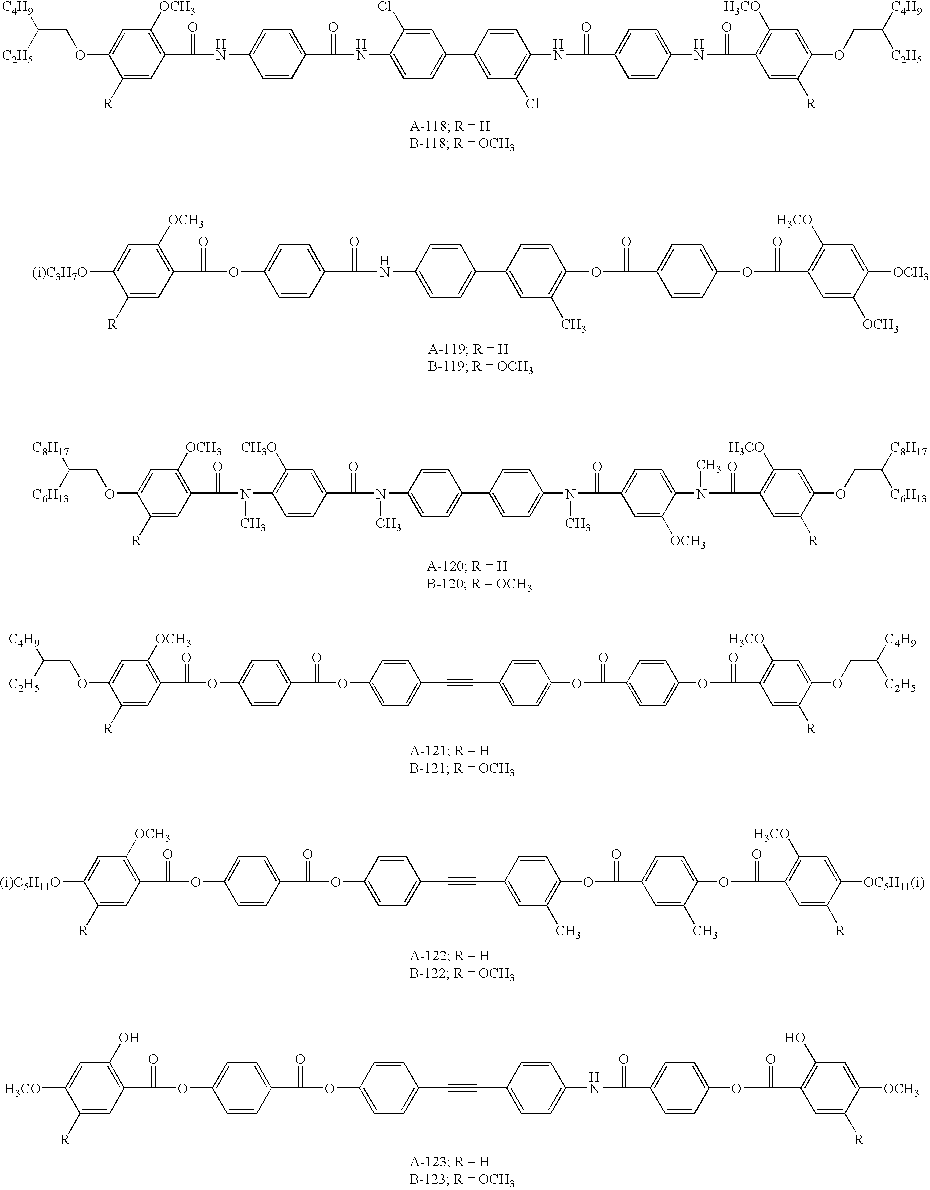

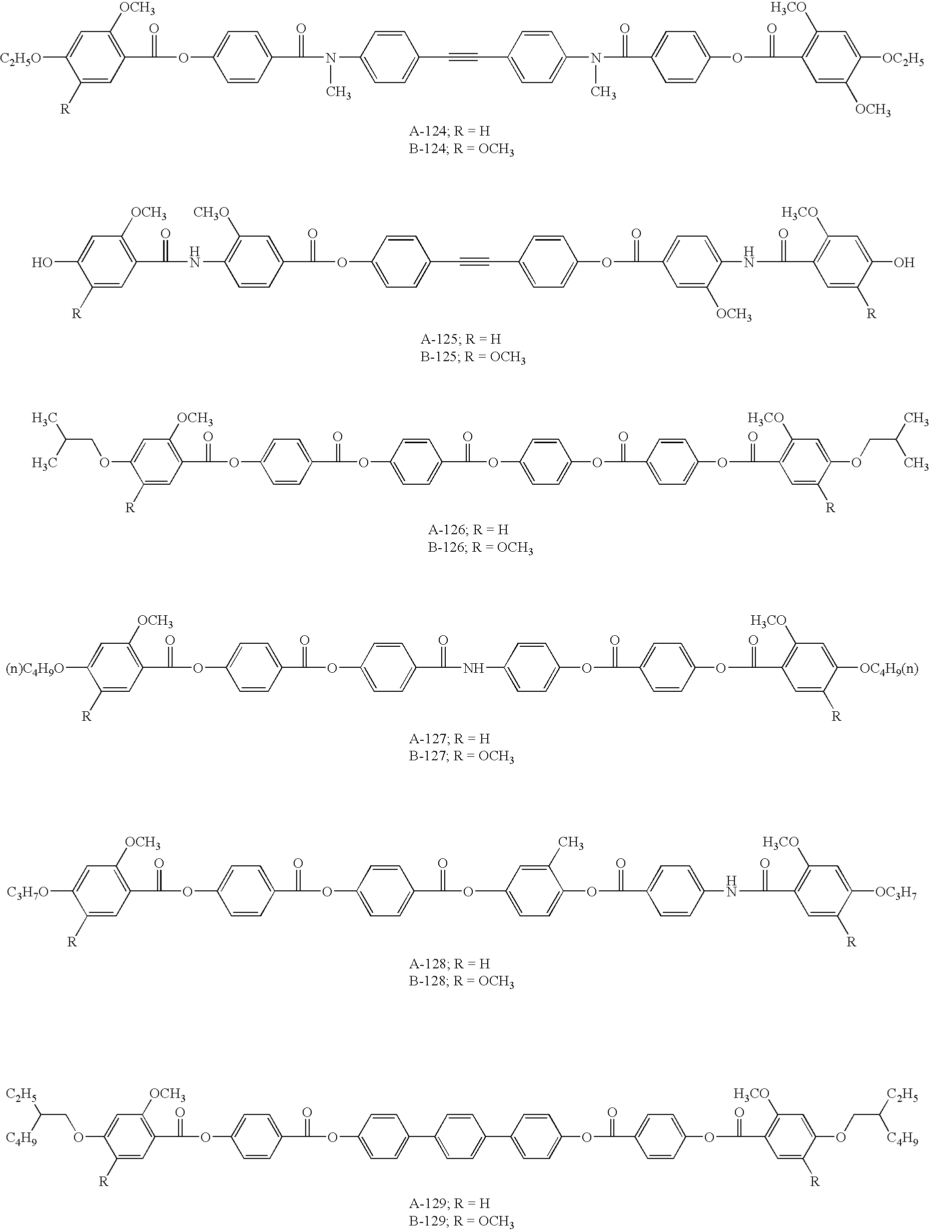

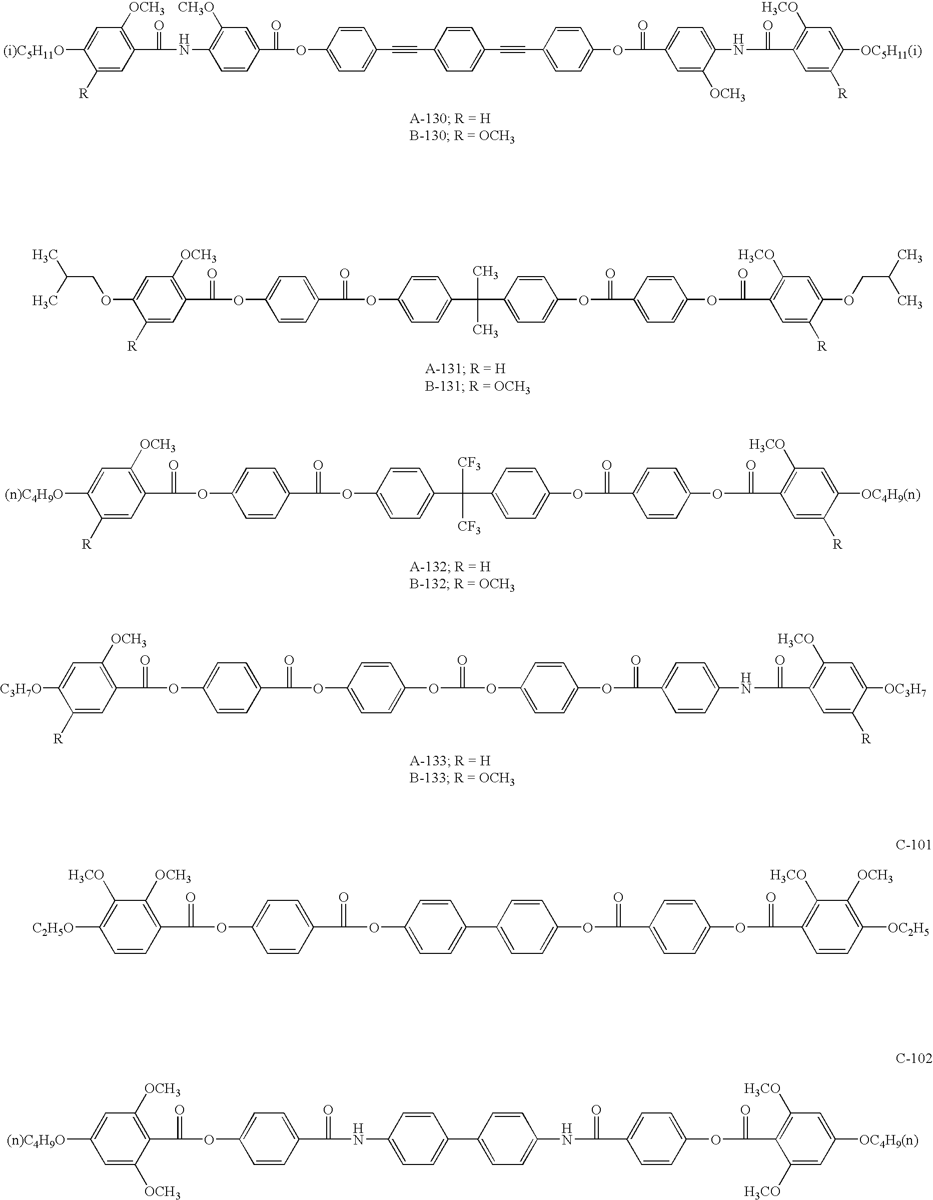

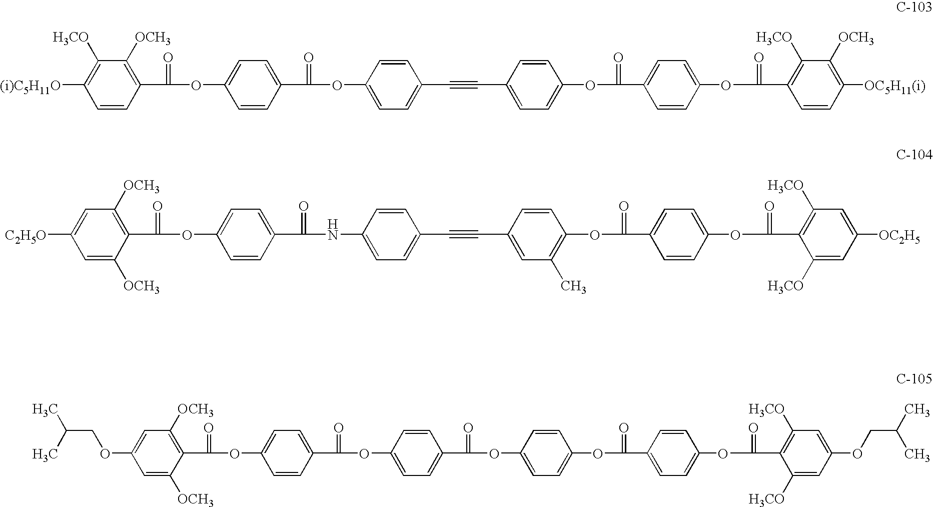

The compound represented by the formula (II) may be produced by a general esterification or a general amidation of a substituted benzoic acid, which may be synthesized previously, and a phenol derivative or a aniline derivative. The esterification or amidation may be carried out according to any method which can make an ester or amide bonding. For example, the compound may be produced as follows:

a substituted benzoic acid is converted into an acid halide, and, then, a condensation reaction of the acid halide and a phenol derivative or an aniline derivative is carried out; or

a dehydration condensation of a substituted benzoic acid and a phenol derivative or an aniline derivative is carried out in the presence of a condensation agent or catalyst.

The former method is preferred in terms of the production process.

Reaction solvent, which can be employed in the process of producing the compound represented by the formula (II), is preferably selected from the group consisting of hydrocarbon base solvents such as toluene and xylene; ether base solvents such as dimethylether, tetrahydrofuran and dioxane; ketone base solvents; ester base solvents; acetonitrile, dimethyl formamide and dimethylacetamide. One solvent or tow or more solvents may be employed. Among these, toluene, acetonitrile, dimethylformamide and dimethylacetamide are preferred.

The reaction temperature is preferably set within the range from 0 to 150° C., more preferably from 0 to 100° C., much more preferably from 0 to 90° C., and especially preferably from 20 to 90° C.

The reaction may be carried out with base or without base, the latter is preferred. Examples of the base include organic bases and inorganic bases, and organic bases such as pyridine and tertiary alkyl amine (e.g. triethyl amine and ethyl diisopropyl amine) are preferred.

The compound represented by the formula (V-A) or (V-B) can be produced according to any usual method. The compounds in which “n” is 4 may be produced as follows:

a reaction of a starting material having a following structure “A” with a derivative having a reactive site such as hydroxyl and amino is carried out to generate an intermediate B-2 shown below; a reaction of the intermediate B-2 with a compound “C” shown below to connect two molecules of the intermediate B-2 with a molecule of the compound “C” shown below; and then a compound represented by the formula (V-A) or (V-B) can be obtained.

The method to be employed for producing the compound is not limited to the above mentioned method.

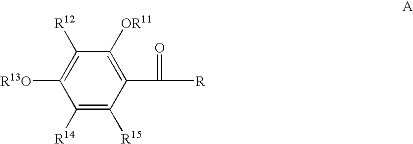

In the structure “A”, R represents a reactive group such as hydroxyl and a halogen atom; R¹¹, R¹², R¹³ and R¹⁵ are same as described above; and R¹⁴ represents a hydrogen atom or the above mentioned OR²⁴.

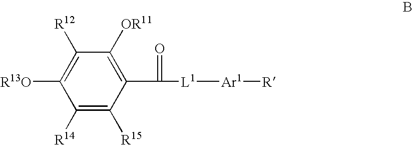

In the formula, R′ represents a reactive group such as carboxyl; R¹¹, R¹², R¹³, R¹⁴, R¹⁵, Ar¹ and L¹ are same as described above.

R—Ar²—L²—Ar²—R′ C

In the formula, R and R′ represent a reactive group such as hydroxyl and amino; and Ar²and L² are defined as Ar¹ and L¹ are defined above.

The amount of the Rth enhancer is preferably from 0.1 to 30 mass %, more preferably from 1 to 25 mass % and much more preferably from 3 to 15 mass % with respect to the total mass of cellulose acylate.

When the cellulose acylate film is produced according to a solvent cast method, the Rth enhancer may be added to the dope. The addition of the Rth enhancer to the dope may be conducted any stage, and for example, a solution of the Rth enhancer may be prepared by dissolving it in an organic solvent such as alcohol, methylene chloride or dioxolane and then added to the dope; or the Rth enhancer may be added to the dope directly.

One or more types of compounds selected from the formulae (I), (II)-(V) may be used as the Rth enhancer.

For producing a cellulose acylate film satisfying properties required for the first optically anisotropic layer, at least one UV absorbent may be employed in combination with or in place of the Rth enhancer. The UV absorbent can also function as an Rth enhancer. Examples of the UV absorbent include oxybenzophenone compounds, benzotriazole compounds, salicylate compounds, benzophenone compounds, cyanoacrylate compounds, and nickel complex compounds; and preferred are benzotriazole compounds causing little coloration. In addition, UV absorbents described in Japanese Laid-Open Patent Publication Nos. 10-182621 and 8-337574, and UV absorbent polymers described in Japanese Laid-Open Patent Publication No. 6-148430 are also preferably used herein. For the UV absorbent for the cellulose acylate film, preferred are those having an excellent ability to absorb UV rays having a wavelength of at most 370 nm, in terms of preventing degradation of polarizing elements and liquid crystals, and those not almost absorbing visible light having a wavelength of at least 400 nm in terms of the image display capability.

Examples of the benzotriazole-type UV absorbent usable in the invention are 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthal imidomethyl)-5′-methylphenyl)benzotriazole, 2,2-methylenebis(4-(-1,1,3,3-tetramethylbutyl)-6-(2H-benzotriazol-2-yl)phenol, 2-(2′-hydroxy-3′-tert-butyl-5′-methylphenyl)-5-chlorobenzotriaz ole, 2-(2H-benzotriazol-2-yl)-6-(linear or branched dodecyl)-4-methylphenol, a mixture of octyl-3-[3-tert-butyl-4-hydroxy-5-(chloro-2H-benzotriazol-2-yl) phenyl] propionate and 2-ethylhexyl-3-[3-tert-butyl-4-hydroxy-5-(5-chloro-2H-benzotriazol-2-yl)phenyl] propionate, to which, however, the invention should not be limited. In addition, commercial products of TINUVIN 109, TINUVIN 171, TINUVIN 326 (all by Ciba Speciality Chemicals) are also preferably usable herein.

### [Agent for Controlling Wavelength Dispersion of Retardation]

For producing a cellulose acylate film satisfying properties required for the first optically anisotropic layer, at least one UV absorbent may be employed. The UV absorbent can also function as an agent for controlling wavelength dispersion of retardation. Examples of the UV absorbent include oxybenzophenone compounds, benzotriazole compounds, salicylate compounds, benzophenone compounds, cyanoacrylate compounds, and nickel complex compounds; and preferred are benzotriazole compounds causing little coloration. In addition, UV absorbents described in Japanese Laid-Open Patent Publication Nos. 10-182621 and 8-337574, and UV absorbent polymers described in Japanese Laid-Open Patent Publication No. 6-148430 are also preferably used herein. For the UV absorbent for the cellulose acylate film, preferred are those having an excellent ability to absorb UV rays having a wavelength of at most 370 nm, in terms of preventing degradation of polarizing elements and liquid crystals, and those not almost absorbing visible light having a wavelength of at least 400 nm in terms of the image display capability.

### [Plasticizer]

A plasticizer such as triphenyl phosphate or biphenyl phosphate may be added to the polymer film (preferably cellulose acylate film) to be used as the first optically anisotropic layer.

In one preferred embodiment of the invention, the first optically anisotropic layer is formed according to a coating or transferring method. In the embodiment in which the first optically anisotropic layer is formed according to a coating method, the first optically anisotropic layer may be formed on the other member of a liquid-crystal display device, for example, on the surface of a polymer film to be used as the second optically anisotropic layer or on the surface a protective film for a polarizing element (optionally on the surface of the alignment film formed on those surfaces) by applying a composition for optically anisotropic layer thereon. On the other hand, in the embodiment where the first optically anisotropic layer is formed according to a transferring method, the first optically anisotropic layer may be formed as follows: A composition of an optically anisotropic layer is applied to the surface of a temporary support, polymer film (optionally on the surface of the alignment film formed on that surface), and the resulting layer is transferred onto the other member of a liquid-crystal display device, for example, on the surface of a polymer film to be used as the second optically anisotropic layer or on the surface a protective film for a polarizing element. Accordingly, in any of these embodiments, the first optically anisotropic layer is formed according to a method that includes a coating step.

The material to be used in forming the first optically anisotropic layer is not specifically defined. So far as it may be prepared as a liquid composition for coating application and so far as the layer formed according to a coating process can exhibit optical properties necessary for the first optically anisotropic layer, the material is not specifically defined at all. Layers of the same or different materials may be laminated, and the laminate may form the first optically anisotropic layer, satisfying the optical characteristics necessary for the layer.

### [Liquid-Crystal Composition]

The first optically anisotropic layer may be formed of a liquid-crystal composition. Liquid crystal may have various alignment morphologies, and the optically anisotropic layer in which the alignment of the liquid crystal is controlled and the liquid crystal is fixed in the controlled alignment state may exhibit the desired optical properties, as it is a single layer or a laminate of plural layers. In the invention, the liquid-crystal composition to be used in forming the first optically anisotropic layer is preferably a discotic liquid-crystal composition containing at least a discotic liquid-crystal compound of which molecular form is discotic, or a cholesteric liquid-crystal composition. The liquid crystal to be in the composition may be a low-molecular liquid crystal or a polymer liquid crystal.

In case where a low-molecular liquid-crystal compound is used for the liquid-crystal material for use in forming the first optically anisotropic layer, preferred is a polymerizing discotic liquid-crystal compound, and more preferably, the discotic liquid-crystal compound is formed in homeotropic alignment. In homeotropic alignment, the molecules of a discotic liquid-crystal compound are aligned substantially horizontally to the layer face. “Substantially horizontal” as referred to herein means that the mean angle (mean tilt angle) between the disc face of the molecules of the discotic liquid-crystal compound and the layer face is within a range of from 0° to 10°. Discotic liquid-crystal compounds are described in a variety of literature (e.g., C. Destrade et al., Mol. Crysr. Liq. Cryst., Vol. 71, page 111 (1981); Quarterly General Chemistry edited by the Chemical Society of Japan, No. 22, Chemistry of Liquid Crystal, Chap. 5, Chap. 10, Sec. 2 (1994); B. Kohne et al., Angew. Chem. Soc. Chem. Comm., page 1794 (1985); J. Zhang et al., J. Am. Chem. Soc., Vol. 116, page 2655 (1994)), and these may be widely employed. Regarding the polymerization of discotic liquid-crystal compound, for example, referred to is the method described in JPA No. hei 8-27284.

As the cholesteric liquid-crystal composition for use in forming the first optically anisotropic layer, a composition containing a cholesteric liquid crystal may be used; but not limited to it, any other liquid-crystal composition capable of exhibiting a cholesteric liquid-crystal state as a whole may also be used, and the liquid crystal itself to be in the composition should not be limited to a cholesteric liquid crystal alone. For example, a liquid-crystal composition containing an optically-active compound along with a nematic liquid crystal, anda liquid-crystal composition containing a nematic liquid crystal with an asymmetric carbon atom introduced thereinto may also be used in forming the first optically anisotropic layer so far as it may exhibit a cholesteric liquid-crystal state. One preferred example of the cholesteric liquid-crystal composition usable in the invention is a three dimensionally-crosslinkable, chiral nematic (cholesteric) liquid-crystal composition containing a polymerizing liquid-crystal monomer; and more preferred is a liquid-crystal composition capable of forming a twisted alignment chiral nematic (cholesteric) liquid-crystal layer for which the wavelength for reflection falls within a UV range. For example, a mixture of a liquid-crystal monomer and a chiral compound as in JPA No. hei 7-258638 and JPT No. hei 10-508882 may be used.

Preferably, the liquid-crystal composition is a curable composition, and it preferably contains a polymerizing component as it forms a cured layer through polymerization. The liquid-crystal compound itself may be polymerizable, or an additional polymerizing monomer may be added; but preferably, the liquid-crystal compound itself is polymerizable. The curable liquid-crystal composition may optionally contain various additives such as polymerization initiator, alignment controlling agent, surfactant. The first optically anisotropic layer may be formed by preparing a coating liquid of a curable liquid-crystal composition, applying it onto the surface of a support of a polymer film or the like or onto the surface of an alignment film, then aligning the molecules, preferably the discotic molecules of the liquid-crystal compound in a desired alignment state, and thereafter polymerizing it through light irradiation and/or heating thereby fixing the molecules in the alignment state.

### [Polymer Composition]

As described in the above, the first optically anisotropic layer may be a layer formed according to a coating method or a transferring method using a polymer composition. The polymer composition contains one or more polymers capable of exhibiting optical anisotropy according to a coating method. In case where the expression of the optically anisotropic layer is insufficient, then the polymer layer formed according to a coating method may be stretched. For example, a polymer composition is applied onto a support or a polymer film to be a temporary support, thereby forming a polymer layer thereon, and then the obtained laminate film may be stretched so that the stretched layer has the necessary optical characteristics for the first optically anisotropic layer. The polymer for use in forming the first optically anisotropic layer is not specifically defined. In terms of that the polymer capable of forming an optically-anisotropic polymer layer according to a coating method, preferred is at least one polymer material selected from a group of polyolefin (e.g., polyethylene, polypropylene, norbornene-typepolymer), polycarbonate, polyarylate, polysulfone, polyvinyl alcohol, polymethacrylate, polyacrylate, cellulose ester (e.g., cellulose triacetate, cellulose diacetate), polyamide, polyimide, polyester, polyether ketone, polyamidimide, polyester imide, and polyaryl ether ketone. Above all, more preferred is at least one polymer material selected from a group of polyamide, polyimide, polyester, polyether ketone, polyamidimide, polyesterimide, and polyaryl ether ketone; and even more preferred is polyimide.

### [Formation Method for First Optically Anisotropic Layer According to Coating or Transferring Method]

The liquid-crystal composition or the polymer composition to be used for forming the first optically anisotropic layer may be prepared as a coating liquid. The coating liquid may be prepared by dissolving and/or dispersing a liquid-crystal material or a polymer material in a solvent. The solvent for use in preparing the coating liquid is preferably an organic solvent. Examples of the organic solvent are amides (e.g., N,N-dimethylformamide), sulfoxides (e.g.,dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g.,acetone,methylethylketone),ethers (e.g., tetrahydrofuran, 1,2-dimethoxyethane). Preferred are alkyl halides and ketones. Two ormore different types of organic solvents may be combined for use herein.

The coating method to be used in forming the first optically anisotropic layer is not specifically defined, for which any known method is employable (e.g., wire bar coating method, extrusion coating method, direct gravure coating method, reverse gravure coating method, die coating method). Above all, the layer is formed according to a wire bar coating method. For forming the first optically anisotropic layer, also preferably used is a die coating method. In particular, preferably is a coating method using a slide coater or a slot die coater.

The transferring method is effective when direct formation of the first optically anisotropic layer on the surface of the other member of a liquid-crystal display device according to a coating method is difficult. A liquid-crystal composition or a polymer composition is applied onto the surface of a temporary support (optionally on the surface of an alignment film) to form an optically anisotropic layer thereon, and the thus-formed optically anisotropic layer is transferred onto the surface of the other member of a liquid-crystal display device, thereby forming the intended first optically anisotropic layer. According to the method, even when the material such as the liquid-crystal composition or the polymer composition for use in forming the first optically anisotropic layer is difficult to apply to a substrate except a glass substrate, it may be once applied to a glass substrate to form an optically anisotropic layer, and the thus-formed optically anisotropic layer may be then transferred onto the surface of the protective film of a polarizing element or onto the surface of the polymer film for the second optically anisotropic layer to be in a liquid-crystal display device, thereby forming the intended first optically anisotropic layer thereon. In the transferring step, if desired, an adhesive may be used for improving the adhesiveness between the layer and the member to which it is transferred. For example, an adhesive may be applied on the surface of the member of a polymer film to which the layer is to be transferred, thereby forming an adhesive layer thereon, and then the optically anisotropic layer may be transferred onto it.

Preferably, the first optically anisotropic layer is a thin layer, as contributing toward the reduction in the thickness of the body of a liquid-crystal display device. In the invention, the first optically anisotropic layer is formed of a liquid-crystal composition or a polymer composition, and therefore, the layer may be made thin by suitably selecting the material for it. Even though thin, the thus-formed first optically anisotropic layer may have the necessary optical characteristics. In the invention, the thickness of the first optically anisotropic layer is preferably from 0.1 to 20 μm, more preferably from 0.1 to 10 μm, even more preferably from 0.1 to 3 μm. In the invention, Rth(548)/(d×1000) of the first optically anisotropic layer is preferably at least 0.03, more preferably at least 0.05, even more preferably at least 0.07.

The first optically anisotropic layer to be formed according to a coating or transferring method is generally formed on a support of a polymer film or the like. Positively taking advantage of the birefringence of the polymer film to form the support, the laminate may satisfy the necessary optical characteristics for the first optically anisotropic layer in one embodiment; or a film having a retardation of nearly 0 (zero) maybe used for the support (for example, the cellulose acylate film as in JPA No. 2005-138375), and the layer of a liquid-crystal composition or a polymer composition alone may satisfy the necessary optical characteristics for the first optically anisotropic layer in the other embodiment. As described in the above, the support of the first optically anisotropic layer may be a polymer film to be used as the second optically anisotropic layer, or may be a polymer film for the protective film for polarizing element; and in these embodiments, the polymer film satisfying the necessary requirements for the individual applications may be selected.

### [Second Optically Anisotropic Layer]

The liquid-crystal display device of the invention has a second optically anisotropic layer having at least one optical axis. The second optically anisotropic layer preferably satisfies the following formulae (b1) and (b2):

Re(548)>20nm (b1)

0.5<Nz<10. (b2)

More preferably, the second optically anisotropic layer satisfies the following formulae (b1)′ and (b2)′:

Re(548)>30nm (b1)′

1.5≦Nz<10. (b2)′

Both Re and Rth of the second optically anisotropic layer preferably satisfy the following formulae (b3) to (b6):

0.60≦Re(446)/Re(548)≦1.0 (b3)

1.0≦Re(628)/Re(548)≦1.25 (b4)

0.60≦Rth(446)/Rth(548)≦1.0 (b5)

1.0≦Rth(628)/Rth(548)≦1.25. (b6)

More preferably, they satisfy the following formulae (b3)′ to (b6)′:

0.65≦Re(446)/Re(548)≦1.0 (b3)′

1.0≦Re(628)/Re(548)≦1.20 (b4)′

0.65≦Rth(446)/Rth(548)≦1.0 (b5)′

1.0≦Rth(628)/Rth(548)≦1.20. (b6)′

Even more preferably, they satisfy the following formulae (b3)″ to (b6)″:

0.70≦Re(446)/Re(548)≦1.0 (b3)″

1.0≦Re(628)/Re(548)≦1.15 (b4)″

0.70≦Rth(446)/Rth(548)≦1.0 (b5)″

1.0≦Rth(628)/Rth(548)≦1.15. (b6)″

The material for use in forming the second optically anisotropic layer is not specifically defined. When the second optically anisotropic layer is a polymer film, a polarizing element may be stuck to it. As a single member, for example, as an optical compensatory film, it may be incorporated in a liquid-crystal display device. The material for the polymer film is preferably a polymer having good optical properties, transparency, mechanical strength, thermal stability, water shield ability and isotropic properties; however, any material satisfying the above-mentioned condition may be employed herein. Its examples may be the same as those of the polymer film material for use for the first optically anisotropic layer mentioned in the above.

As the material to form the polymer film, especially preferred is a cellulose polymer (hereinafter this may be referred to as cellulose acylate) heretofore used as a transparent protective film for polarizing element. Examples of the cellulose acylate for use in forming the cellulose acylate film usable as the second optically anisotropic layer may be the same as those of the cellulose acylate material usable in forming the first optically anisotropic layer.

[Re enhancer]

For preparing a cellulose acylate film satisfying the condition required for the second optically anisotropic layer, an Re enhancer may be added to the cellulose acylate film. It is noted that the term “Re enhancer” is used for any compounds capable of developing or enhancing birefringence in the film plane. The cellulose acylate film to be used as the second optically anisotropic layer may comprise at least one compound represented by the formula (I) as an Re enhancer.

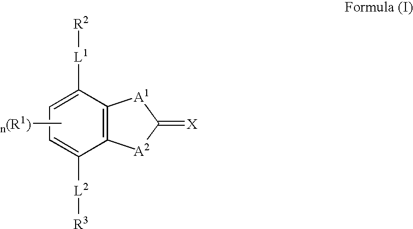

In the formula, L¹ and L² independently represent a single bond or a divalent linking group; A¹ and A² independently represent a group selected from the group consisting of —O—,-NR- where R represents a hydrogen atom or a substituent, —S—and —CO—;R¹, R² and R³independently represent a substituent; X represents a nonmetal atom selected from the groups 14-16 atoms, provided that X may bind with at least one hydrogen atom or substituent; and n is an integer from 0 to 2.

Among the compounds represented by the formula (I), the compounds represented by the formula (II) are preferred as a retardation enhancer.

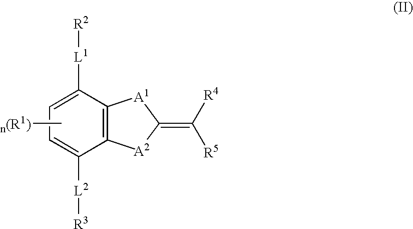

In the formula (II), L¹ and L²independently represent a single bond or a divalent group. A¹ and A²independently represent a group selected from the group consisting of —O—,-NR- where R represents a hydrogen atom or a substituent, —S—and —CO—. R¹, R² and R³ independently represent a substituent. And n is an integer from 0 to 2.

Preferred examples of the divalent linking group represented by L¹ or L² in the formula (I) or (II) include those shown below.

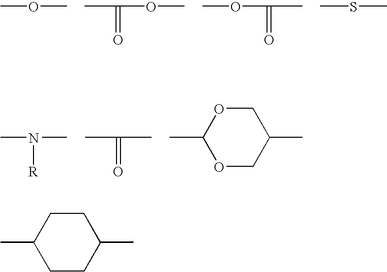

And further preferred are —O—, —COO—and —OCO—.

In the formulae (I) and (II), R¹ represents a substituent, if there are two or more R, they may be same or different from each other, or form a ring. Examples of the substituent include those shown below.

Halogen atoms such as fluorine, chlorine, bromine and iodine atoms; alkyls (preferably C₁₋₃₀alkyls) such as methyl, ethyl, n-propyl, iso-propyl, tert-butyl, n-octyl, and 2-ethylhexyl; cylcoalkyls (preferably C₃₋₃₀ substituted or non-substituted cycloalkyls) such as cyclohexyl, cyclopentyl and 4-n-dodecylcyclohexyl; bicycloalkyls (preferably C₅₋₃₀ substitute or non-substituted bicycloalkyls, namely monovalent residues formed from C₅₋₃₀ bicycloalkanes from which a hydrogen atom is removed) such as bicyclo [1,2,2] heptane-2-yl and bicyclo [2,2,2] octane-3-yl; alkenyls (preferably C₂₋₃₀ alkenyls) such as vinyl and allyl; cycloalkenyls (preferably C₃₋₃₀ substituted or non-substituted cycloalkenyls, namely monovalent residues formed from C₃₋₃₀ cycloalkenes from which a hydrogen atom is removed) such as 2-cyclopentene-1-yl and 2-cyclohexene-1-yl; bicycloalkenyls (preferably C₅₋₃₀ substituted or non-substituted bicycloalkenyls, namely monovalent residues formed from C₅₋₃₀ bicycloalkenes from which a hydrogen atom is removed) such as bicyclo [2,2,1] hepto-2-en-1-yl and bicyclo [2,2,2] octo-2-en-4-yl; alkynyls (preferably C₂₋₃₀substitute or non-substituted alkynyls) such as etynyl and propargyl; aryls (preferably C₆₋₃₀ substitute or non-substituted aryls) such as phenyl, p-tolyl and naphthyl; heterocyclic groups (preferably (more preferably C₃₋₃₀) substituted or non-substituted, 5-membered or 6-membered, aromatic or non-aromatic heterocyclic monovalent residues) such as 2-furyl, 2-thienyl, 2-pyrimidinyl and 2-benzothiazolyl; cyano, hydroxyl, nitro, carboxyl, alkoxys (preferably C₁₋₃₀ substituted or non-substituted alkoxys) such as methoxy, ethoxy, iso-propoxy, t-butoxy, n-octyloxy and 2-methoxyethoxy; aryloxys (preferably C₆₋₃₀ substituted or non-substituted aryloxys) such as phenoxy, 2-methylphenoxy, 4-t-butylphenoxy, 3-nitrophenoxy and 2-tetradecanoyl aminophenoxy; silyloxys (preferably C₃₋₂₀silyloxys) such as trimethylsilyloxy and t-butyldimethylsilyloxy; hetero-cyclic-oxys (preferably C₂₋₃₀ substituted or non-substituted hetero-cyclic-oxys) such as 1-phenyltetrazole-5-oxy and 2-tetrahydropyrenyloxy; acyloxys (preferably C₂₋₃₀ substitute or non-substituted alkylcarbonyloxys and C₆₋₃₀ substituted or non-substituted arylcarbonyloxys) such as formyloxy, acetyloxy, pivaloyloxy, stearoyoxy, benzoyloxy and p-methoxyphenylcarbonyloxy; carbamoyloxys (preferably C₁₋₃₀ substituted or non-substituted carbamoyloxys) such as N,N-dimethyl carbamoyloxy, N,N-diethyl carbamoyloxy, morpholinocarbonyloxy, N,N-di-n-octylaminocarbonyloxy and N-n-octylcarbamyloxy; alkoxy carbonyloxys (preferably C₂₋₃₀ substituted or non-substituted alkoxy carbonyloxys) such as methoxy carbonyloxy, ethoxy carbonyloxy, t-butoxy carbonyloxy and n-octyloxy carbonyloxy; aryloxy carbonyloxys (preferably C₇₋₃₀substituted or non-substitutedaryloxy carbonyloxys) such as phenoxy carbonyloxy, p-methoxyphenoxy carbonyloxy and p-n-hexadecyloxyphenoxy carbonyloxy; aminos (preferably C₀₋₃₀ substituted or non-substituted alkylaminos and C₆₋₃₀ substituted or non-substituted arylaminos) such as amino, methylamino, dimethylamino, anilino, N-methyl-anilino and diphenylamino; acylaminos (preferably C₁₋₃₀ substituted or non-substituted alkylcarbonylaminos and C₆₋₃₀ substituted or non-substituted arylcarbonylaminos) such as formylamino, acetylamino, pivaloylamino, lauroylamino and benzoylamino; aminocarbonylaminos (preferably C₁₋₃₀ substituted or non-substituted aminocarbonylaminos) such as carbamoylamino, N,N-dimethylaminocarbonylamino, N,N-diethylamino carbonylamino and morpholino carbonylamino; alkoxycarbonylaminos (preferably C₂₋₃₀ substituted or non-substituted alkoxycarbonylaminos) such as methoxycarbonylamino, ethoxycarbonylamino, t-butoxycarbonylamino, n-octadecyloxycarbonylamino and N-methyl-methoxy carbonylamino; aryloxycarbonylaminos (preferably C₇₋₃₀ substituted or non-substituted aryloxycarbonylaminos) such as phenoxycarbonylamino, p-chloro phenoxycarbonylamino and m-n-octyloxy phenoxy carbonylamino; sulfamoylaminos (preferably C₀₋₃₀ substituted or non-substituted sulfamoylaminos) such as sulfamoylamino, N,N-dimethylamino sulfonylamino and N-n-octylamino sulfonylamino; alkyl- and aryl-sulfonylaminos (preferably C₁₋₃₀ substituted or non-substituted alkyl-sulfonylaminos and C₆₋₃₀ substituted or non-substituted aryl-sulfonylaminos) such as methyl-sulfonylamino, butyl-sulfonylamino, phenyl-sulfonylamino, 2,3,5-trichlorophenyl-sulfonylamino and p-methylphenyl-sulfonylamino; mercapto; alkylthios (preferably substituted or non-substituted C₁₋₃₀ alkylthios such as methylthio, ethylthio and n-hexadecylthio; arylthios (preferably C₆₋₃₀ substituted or non-substituted arylthios) such as phenylthio, p-chlorophenylthio and m-methoxyphenylthio; heterocyclic-thios (preferably C₂₋₃₀ substituted or non-substituted heterocyclic-thios such as 2-benzothiazolyl thio and 1-phenyltetrazol-5-yl-thio; sulfamoyls (preferably C₀₋₃₀ substituted or non-substituted sulfamoyls) such as N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl; sulfo; alkyl- and aryl-sulfinyls (preferably C₁₋₃₀ substituted or non-substituted alkyl- or C₆₋₃₀ substituted or non-substituted aryl-sulfinyls) such as methylsulfinyl, ethylsulfinyl, phenylsulfinyl and p-methylphenylsulfinyl; alkyl- and aryl-sulfonyls (preferably C₁₋₃₀ substituted or non-substituted alkyl-sulfonyls and C₆₋₃₀ substituted or non-substituted arylsulfonyls) such as methylsulfonyl, ethylsulfonyl, phenylsulfonyl and p-methylphenylsulfonyl; acyls (preferably C₂₋₃₀ substituted non-substituted alkylcarbonyls, and C₇₋₃₀ substituted or non-substituted arylcarbonyls) such as formyl, acetyl and pivaloyl benzyl; aryloxycarbonyls (preferably C₇₋₃₀ substituted or non-substituted aryloxycarbonyls) such as phenoxycarbonyl, o-chlorophenoxycarbonyl, m-nitrophenoxycarbonyl and p-t-butylphenoxycarbonyl; alkoxycarbonyls (preferably C₂₋₃₀ substituted or non-substituted alkoxycarbonyls) methoxycarbonyl, ethoxycarbonyl, t-butoxycarbonyl and n-octadecyloxycarbonyl; carbamoyls (preferably C₁₋₃₀ substituted or non-substituted carbamoyls) such as carbamoyl, N-methylcarbamoyl, N,N-dimethylcarbamoyl, N,N-di-n-octylcarbamoyl and N-(methylsulfonyl)carbamoyl; aryl- and heterocyclic-azos (preferably C₆₋₃₀ substituted or non-substituted arylazos and C₃₋₃₀ substituted or non-substituted heterocyclicazos) such as phenylazo and p-chlorophenylazo, 5-ethylthio-1,3,4-thiadiazol-2-yl-azo, imides such as N-succinimide and N-phthalimide; phosphinos (preferably C₂₋₃₀ substituted or non-substituted phosphinos) such as dimethyl phosphino, diphenyl phosphino and methylphenoxy phosphino; phosphinyls (preferably C₂₋₃₀ substituted or non-substituted phosphinyls) such as phosphinyl, dioctyloxy phosphinyl and diethoxyphosphinyl; phosphinyloxys (preferably C₂₋₃₀ substituted or non-substituted phosphinyloxys) such as diphenoxyphosphinyloxy and dioctyloxyphosphinyloxy; phosphinylaminos (preferably C₂₋₃₀ substituted or non-substituted phosphinylaminos) such as dimethoxy phosphinylamino and dimethylamino phosphinylamino; and silyls (preferably C₃₋₃₀ substituted or non-substituted silyls) such as trimethylsilyl, t-butylmethylsilyl and phenyldimethylsilyl.

The substituents, which have at least one hydrogen atom, may be substituted by at least one substituent selected from these. Examples such substituent include alkylcarbonylaminosulfo, arylcarbonylaminosulfo, alkylsulfonylaminocarbonyl and arylsulfonylaminocarbonyl. More specifically, methylsulfonylaminocarbonyl, p-methylphenylsulfonylaminocarbonyl, acetylaminosulfonyl and benzoylaminosulfonyl are exemplified.

Preferably, R¹ represents a hydrogen atom, an alkyl group, an alkenyl group, an aryl group, a heterocyclic group, hydroxyl, carboxyl, analkoxygroup, anacyloxygroup, cyanooranaminogroup; and more preferably, a halogen atom, an alkyl group, cyano or an alkoxy group.

R² and R³ independently represent a substituent. Examples of the substituent include those exemplified above as examples of R¹. Preferably, R² and R³ independently represent a substituted or non-substituted phenyl or a substituted or non-substituted cyclohexyl; more preferably, a substituted phenyl or a substituted cyclohexyl; and much more preferably, a phenyl having a substituent at a 4-position or a cyclohexyl having a substituent at a 4-position.

R⁴ and R⁵independently represent a substituent. Examples of the substituent include those exemplified above as examples of R¹. Preferably, R⁴and R⁵independently represent an electron-attractant group having the Hammett value, σₚ, more than 0; more preferably an electron-attractant group having the Hammett value, σₚ, from 0 to 1.5. Examples of such an electron-attractant group include trifluoromethyl, cyano, carbonyl and nitro. R⁴ and R⁵ may bind to each other to form a ring.

It is to be noted that, regarding Hammett constant of the substituent, σₚ and σₘ, there are detailed commentaries on the Hammett constant of the substituent, σₚ and σₘ in “Hammett Rule-Structure and Reactivity—(Hammeto soku-Kozo to Hanohsei)” published by Maruzen and written by Naoki Inamoto; “New Experimental Chemistry 14 Synthesis and Reaction of Organic Compound V (Shin Jikken Kagaku Koza 14 Yuuki Kagoubutsu no Gousei to Hannou)” on p. 2605, edited by Chemical Society of Japan and published by Maruzen; “Theory Organic Chemistry Review (Riron Yuuki Kagaku Gaisetsu)” on p. 217, published by TOKYO KAGAKU DOZIN CO. LTD., and written by Tadao Nakatani; and Chemical Reviews, Vol. 91, No. 2, pp. 165-195(1991).

In the formula, A¹ and A² independently represent a group selected from the group consisting of —O—, -NR- where R represents a hydrogen atom or a substituent, —S—and —CO—; and preferably, —O—, -NR- where R represents a substituent selected from those exemplified above as examples of R¹, or —S—.

In the formula, X represents a nonmetal atom selected from the groups 14-16 atoms, provided that X may bind with at least one hydrogen atom or substituent. Preferably, X represents ═O, ═S, ═NR or ═C(R)R where R represents a substituent selected from those exemplified as examples of R¹.

In the formula, n is an integer from 0 to 2, and preferably 0 or 1.

Examples of the compound represented by the formula (I) or (II) include, but examples of the Re enhancer are not limited to, those shown below. Regarding the compounds shown below, each compound to which is appended (X) is referred to as “Example Compound (X)” unless it is specified.

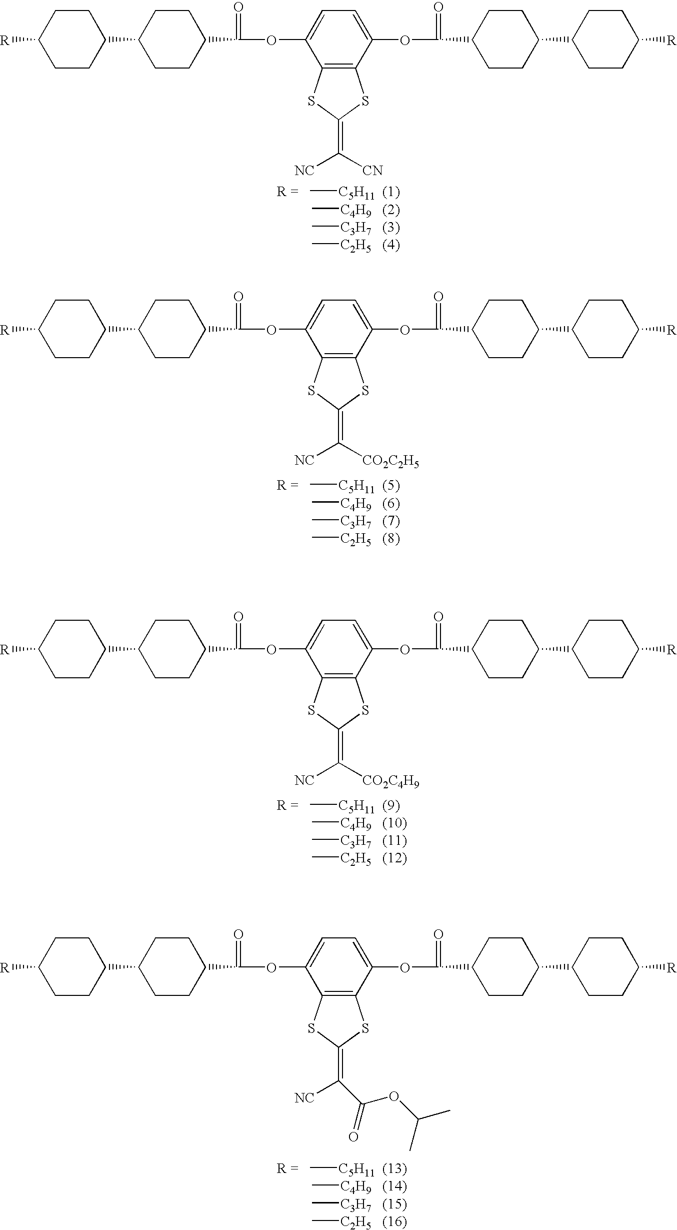

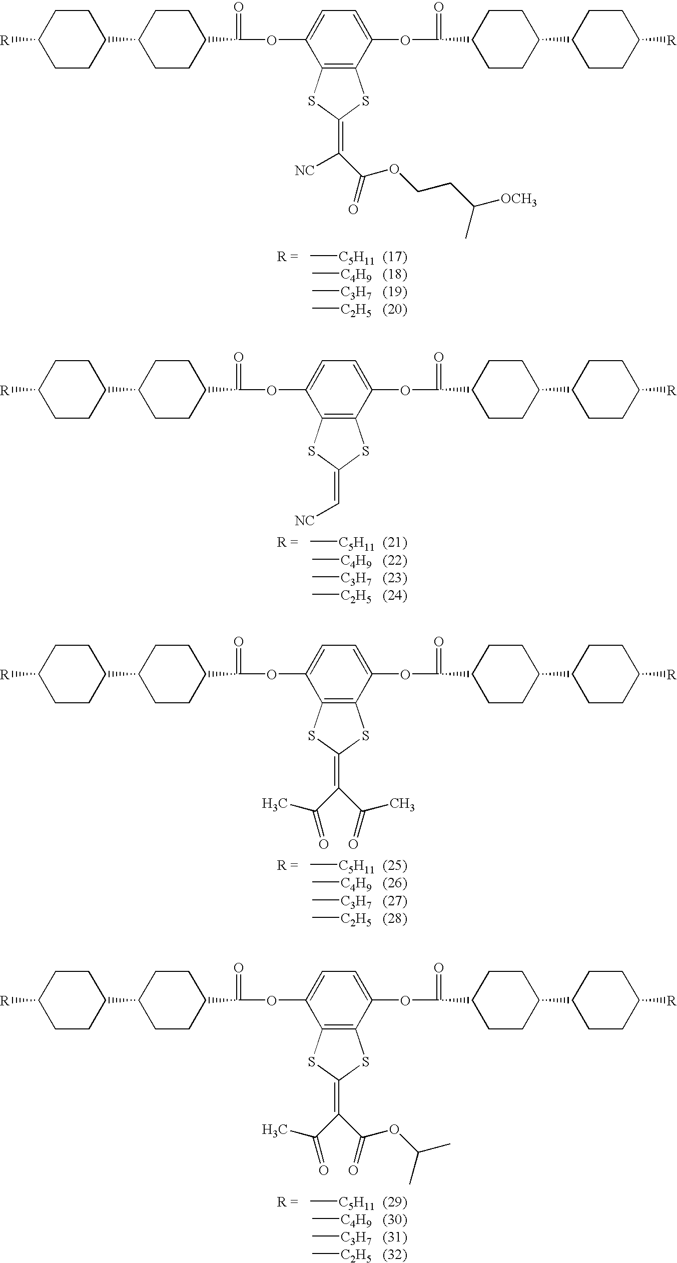

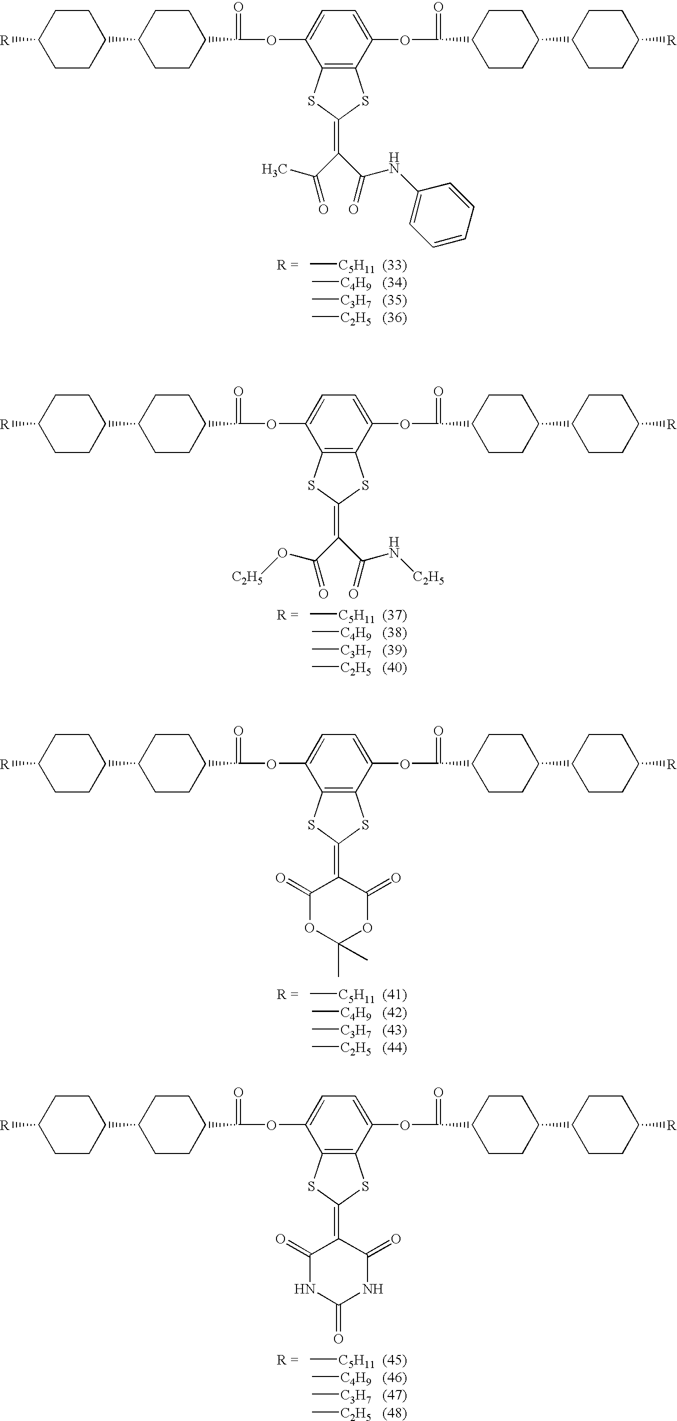

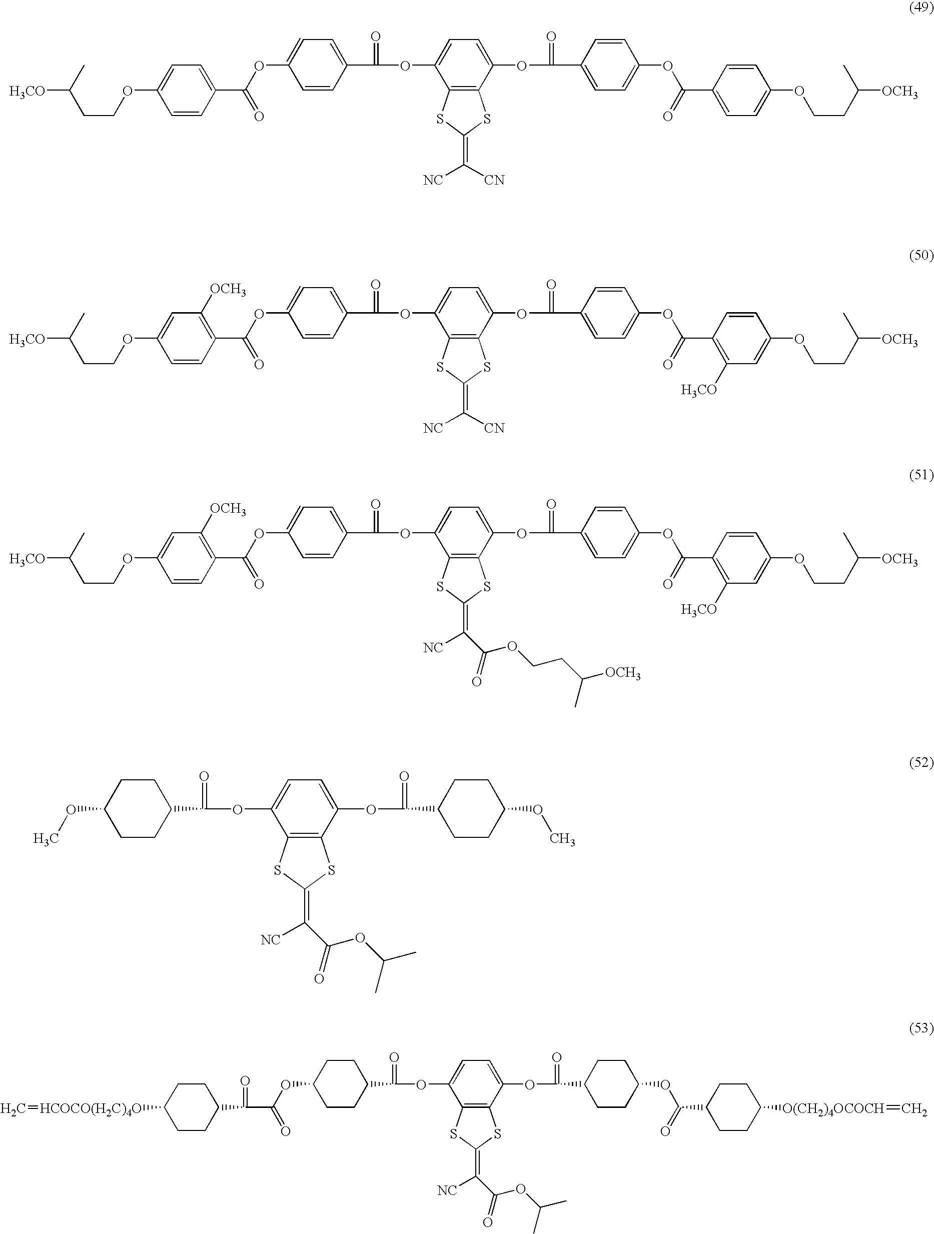

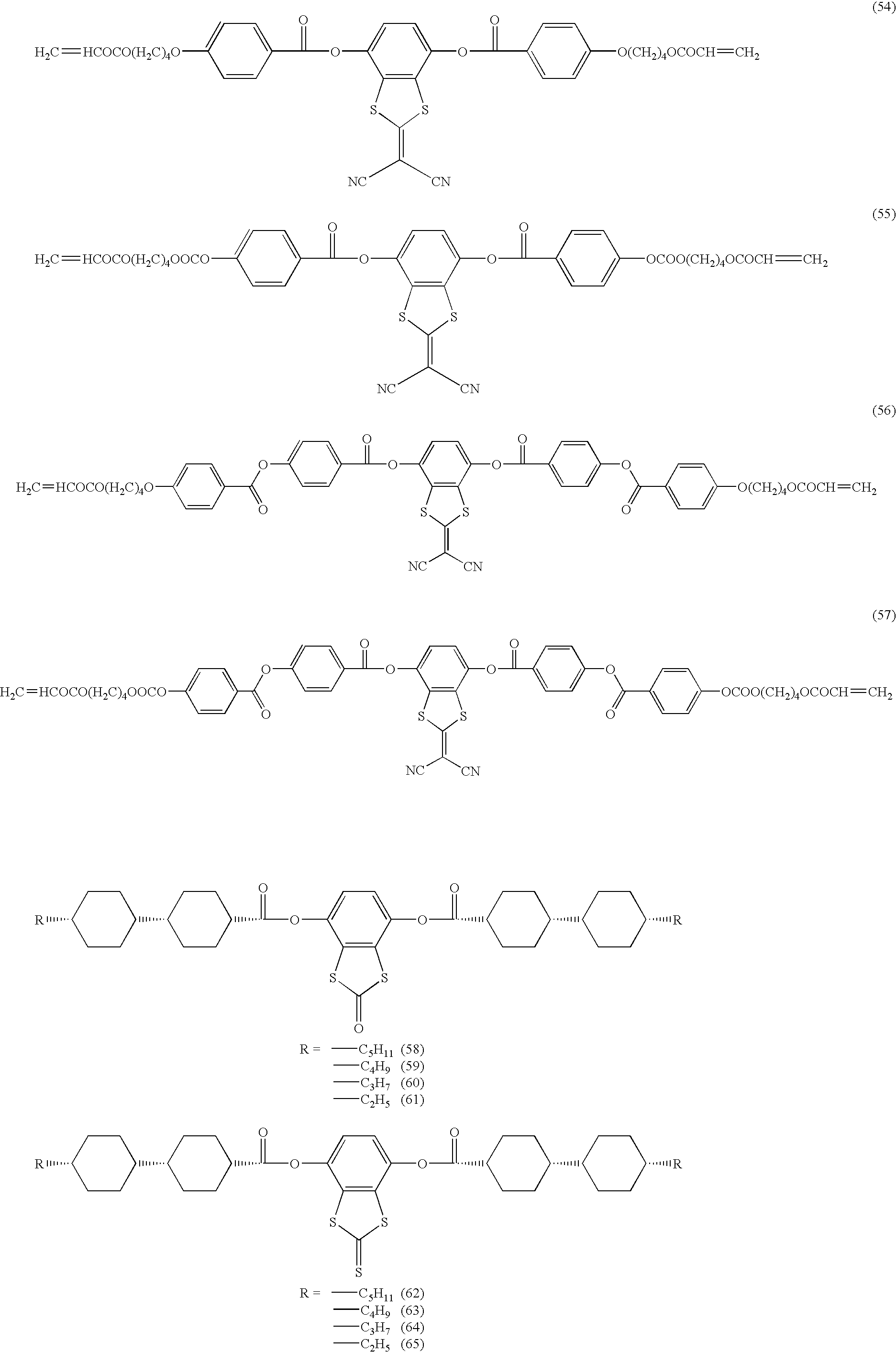

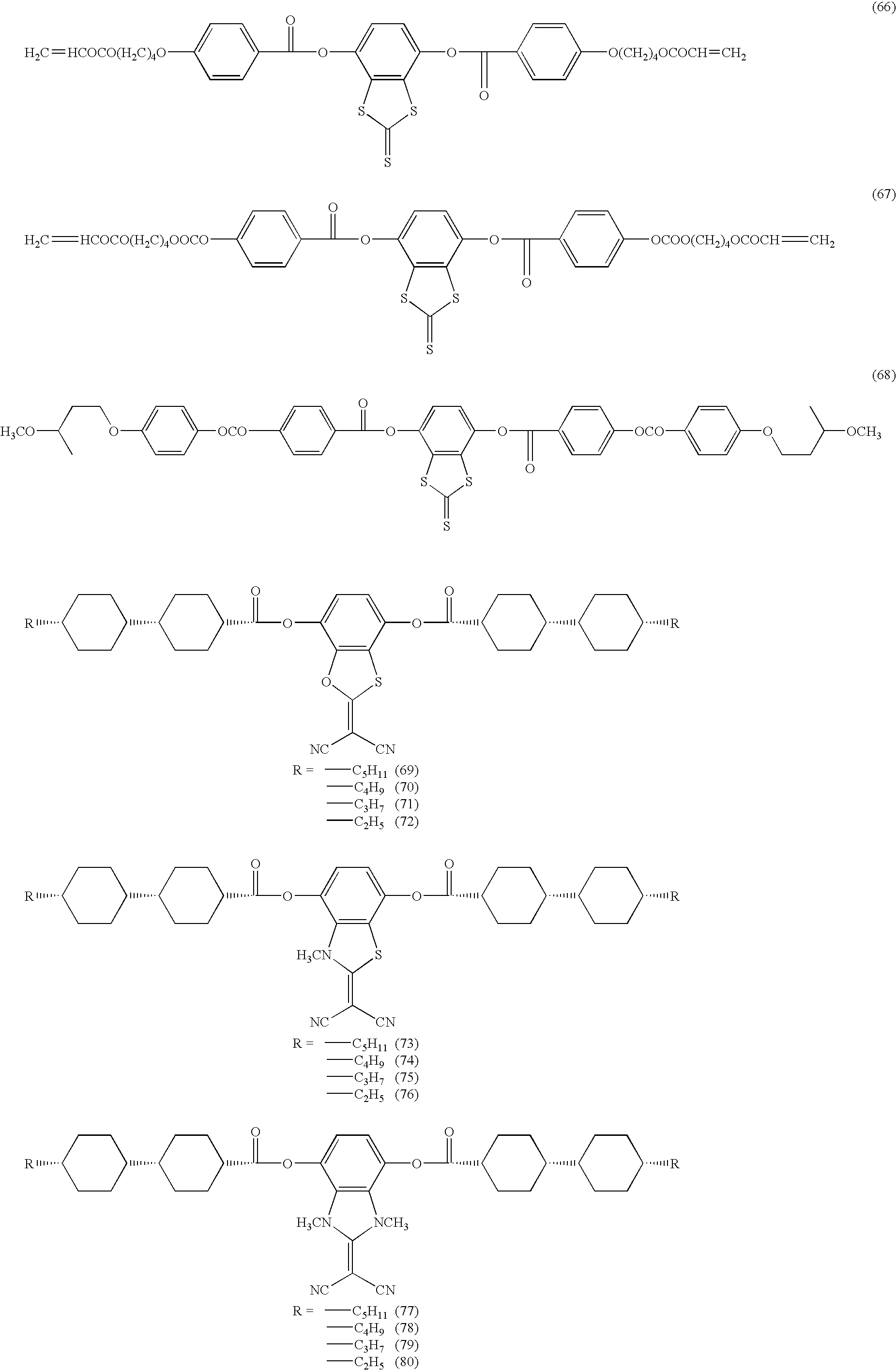

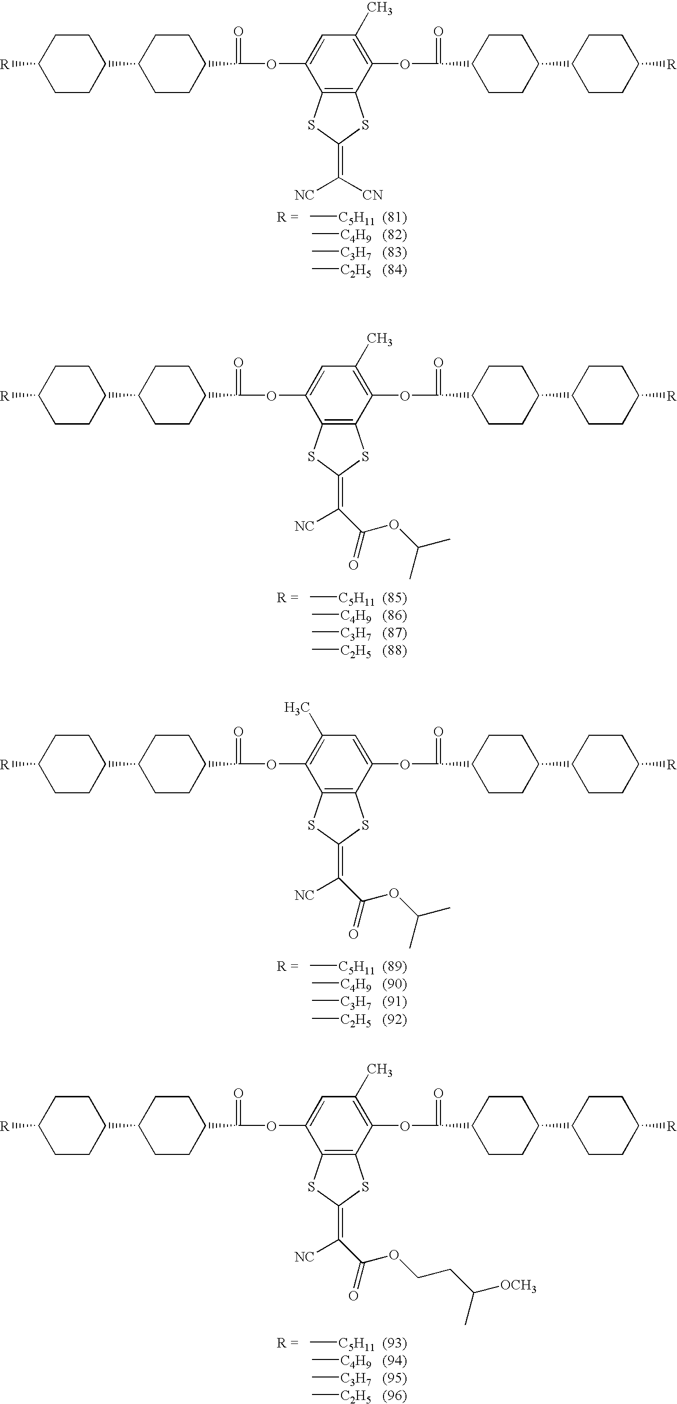

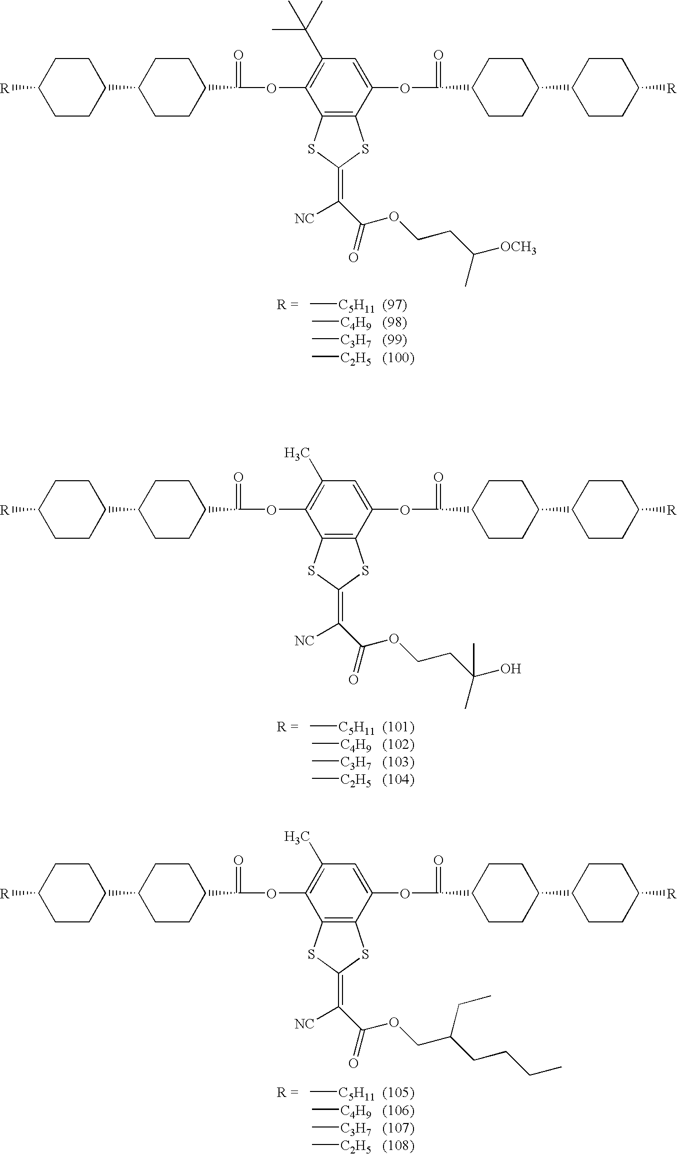

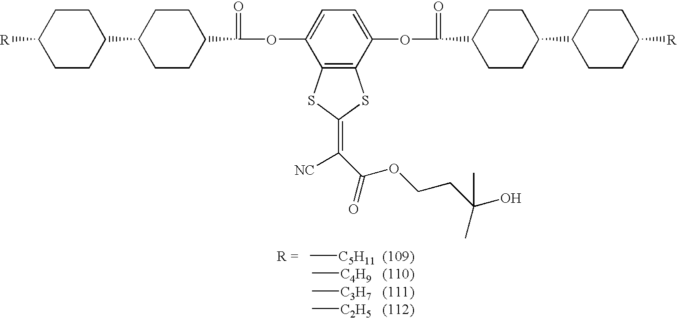

The compound represented by the formula (I) or (II) may be synthesized referring to known methods. For example, Example Compound (1) may be synthesized according to the following scheme.

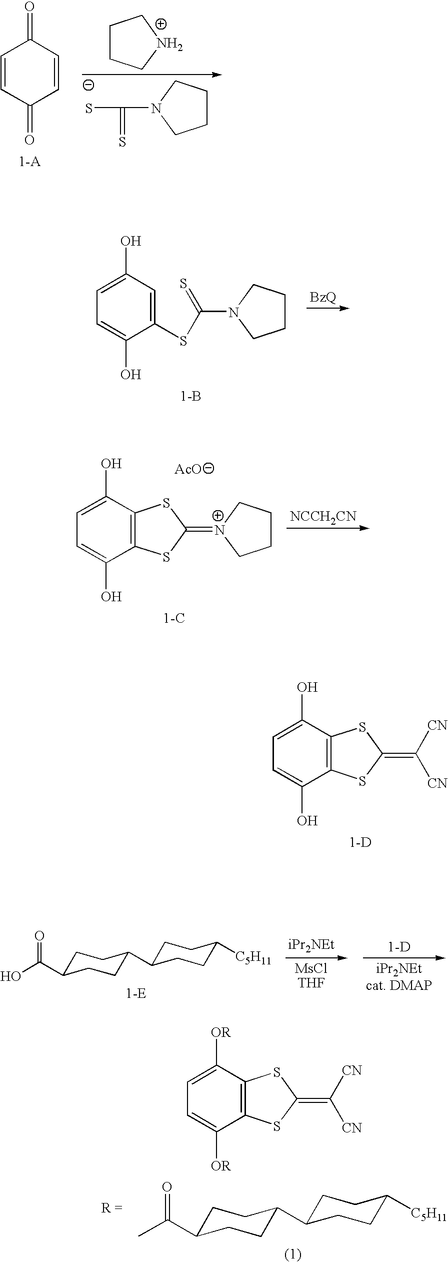

In the above scheme, the steps for producing Compound (1-d) from Compound (1-A) may be carried out referring to the description in “Journal of Chemical Crystallography” (1997); 27(9); p. 515-526.

As shown in the above scheme, Example Compound (1) may be produced as follows. A tetrahydrofuran solution of Compound (1-E) is added with methanesulfonic acid chloride, added dropewise with N,N-di-iso-propylethylamine and then stirred. After that, the reaction solution is added with N,N-di-iso-propylethylamine, added dropewise with a tetrahydrofuran of Compound (1-D), and then added dropewise with a tetrahydrofuran solution of N,N-dimethylamino pyridine (DMAP).

The rod-like aromatic compounds described in Japanese Laid-open Patent publication (occasionally referred to as “JPA”) No. 2004-50516, on pages 11-14, may be employed as the Re enhancer.

One species or two or more species of compounds may be used as the Re enhancer. Employing two or more species as the Re enhancer is preferable since it is possible to widening the adjustable retardation range and to facilitate adjustment of retardation within the preferred range.

The amount of the Re enhancer is preferably from 0.1 to 20 mass % and more preferably from 0.5 to 10 mass % with respect to 100 parts mass of cellulose acylate. When the cellulose acylate film is produced according to a solvent cast method, the Re enhancer may be added to the dope. The addition of the Re enhancer to the dope may be conducted any stage, and for example, a solution of the Re enhance may be prepared by dissolving it in an organic solvent such as alcohol, methylene chloride or dioxolane and then added to the dope; or the Re enhancer may be added to the dope directly.

In one embodiment of the invention, the second optically anisotropic layer is formed according to a coating or transferring method. In the embodiment in which the second optically anisotropic layer is formed according to a coating method, the second optically anisotropic layer may be formed on the other member of a liquid-crystal display device, for example, on the surface of a polymer film to be used as the first optically anisotropic layer or on the surface a protective film for a polarizing element (optionally on the surface of the alignment film formed on those surfaces) by applying a composition for optically anisotropic layer thereon. On the other hand, in the embodiment where the second optically anisotropic layer is formed according to a transferring method, the second optically anisotropic layer may be formed as follows: A composition of an optically anisotropic layer is applied to the surface of a temporary support, polymer film (optionally on the surface of the alignment film formed on that surface), and the resulting layer is transferred onto the other member of a liquid-crystal display device, for example, on the surface of a polymer film to be used as the first optically anisotropic layer or on the surface a protective film for a polarizing element. Accordingly, in any of these embodiments, the second optically anisotropic layer is formed according to a method that includes a coating step.

The material to be used in forming the second optically anisotropic layer is not specifically defined. So far as it may be prepared as a liquid composition for coating application and so far as the layer formed according to a coating process can exhibit optical properties necessary for the second optically anisotropic layer, the material is not specifically defined at all. Layers of the same or different materials may be laminated, and the laminate may form the second optically anisotropic layer, satisfying the optical characteristics necessary for the layer.

### [Liquid-Crystal Composition]

The second optically anisotropic layer may be formed of a liquid-crystal composition. Liquid crystal may have various alignment morphologies, and the optically anisotropic layer in which the alignment of the liquid crystal is controlled and the liquid crystal is fixed in the controlled alignment state may exhibit the desired optical properties, as it is a single layer or a laminate of plural layers. In the invention, the liquid-crystal composition to be used in forming the second optically anisotropic layer is preferably a rod-like liquid-crystal composition containing at least a rod-like liquid-crystal compound of which molecular form is rod-shaped. The liquid crystal to be in the composition may be a low-molecular liquid crystal or a polymer liquid crystal.

Examples of the rod-like liquid crystal compound include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles. Examples of the rod-like liquid crystal compounds further include metal complexes of liquid crystal compounds. Liquid crystal polymers comprising one or more repeating units having a rod-like liquid crystal structure can also be used in the present invention. Namely, the rod-like crystal compounds bonded to a polymer may be use in the present invention.

Among the low-molecular-weight liquid-crystalline compounds, liquid-crystalline compounds represented by a formula (I) are preferred.

Q¹—L¹—A¹—L³—M—L⁴—A²—L²—Q² Formula (I)

In the formula, Q¹ and Q² respectively represent a polymerizable group. L¹, L², L³ and L⁴ respectively represent a single bond or a divalent linking group, and it is preferred that at least one of L³ and L⁴ represents —O—CO—O—. A¹ and A² respectively represent a C₂₋₂₀ spacer group. M represents a mesogen group.

In formula (I), Q¹ and Q²respectively represent a polymerizable group. The polymerization reaction of the polymerizable group is preferably addition polymerization (including ring opening polymerization) or condensation polymerization. In other words, the polymerizable group is preferably a functional group capable of addition polymerization reaction or condensation polymerization reaction. Examples of polymerizable groups are shown below.

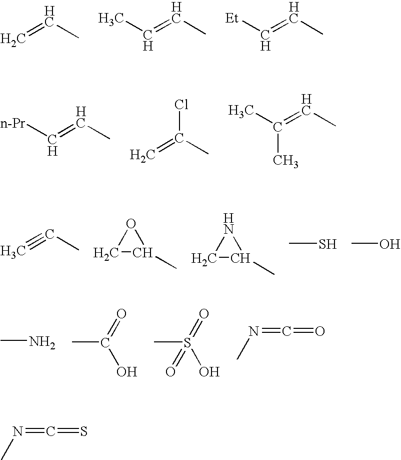

L¹, L², L³ and L⁴ independently represent a divalent linking group, and preferably represent a divalent linking group selected from the group consisting of —O—, —S—, —CO—, -NR²-, —CO—O—, —O—CO—O—, —CO-NR²-, -NR²-CO—, —O—CO—, —O—CO-NR²-, -NR²-CO—O—and -NR²-CO-NR²-. R² represents a C₁₋₇ alkyl group or a hydrogen atom. It is preferred that at least one of L³and L⁴represents —O—or —O—CO—O—(carbonate group). It is preferred that Q¹-L¹and Q²-L²- are respectively CH₂═CH—CO—O—, CH₂═C(CH₃)—CO—O—or CH₂═C(Cl)—CO—O—CO—O—; and it is more preferred they are respectively CH₂═CH—CO—O—.

In the formula, A¹ and A² preferably represent a C₂₋₂₀ spacer group. It is more preferred that they respectively represent C₂₋₁₂ aliphatic group, and much more preferred that they respectively represent a C₂₋₁₂ alkylene group. The spacer group is preferably selected from chain groups and may contain at least one unadjacent oxygen or sulfur atom. And the spacer group may have at least one substituent such as a halogen atom (fluorine, chlorine or bromine atom), cyano, methyl and ethyl.

Examples of the mesogen represented by M include any known mesogen groups. The mesogen groups represented by a formula (II) are preferred.

—(—W¹-L⁵)ₙ—W²— (II)

In the formula, W¹ and W² respectively represent a divalent cyclic aliphatic group, a divalent aromatic group or a divalent hetero-cyclic group; and L⁵ represents a single bond or a linking group. Examples of the linking group representedby L⁵ include those exemplified as examples of L¹ to L⁴ in the formula (I) and —CH₂—O—and —O—CH₂—. In the formula, n is 1, 2 or 3.

Examples of W¹ and W² include 1,4-cyclohexanediyl, 1,4-phenylene, pyrimidine-2,5-diyl, pyridine-2,5-diyl, 1,3,4-thiazole-2,5-diyl, 1,3,4-oxadiazole-2,5-diyl, naphtalene-2,6-diyl, naphtalene-1,5-diyl, thiophen-2,5-diyl, pyridazine-3,6-diyl. 1,4-cyclohexanediyl has two stereoisomers, cis-trans isomers, and the trans isomer is preferred. W¹ and W² may respectively have at least one substituent. Examples the substituent include a halogen atom such as a fluorine, chlorine, bromine or iodine atom; cyano; a C₁₋₁₀ alkyl group such as methyl, ethyl and propyl; a C₁₋₁₀ alkoxy group such as methoxy and ethoxy; a C₁₋₁₀ acyl group such as formyl and acetyl; a C₂₋₁₀ alkoxycarbonyl group such as methoxy carbonyl and ethoxy carbonyl; a C₂₋₁₀ acyloxy group such as acetyloxy and propionyloxy; nitro, trifluoromethyl and difluoromethyl.

Preferred examples of the basic skeleton of the mesogen group represented by the formula (II) include, but are not to be limited to, these described below. And the examples may have at least one substituent selected from the above.

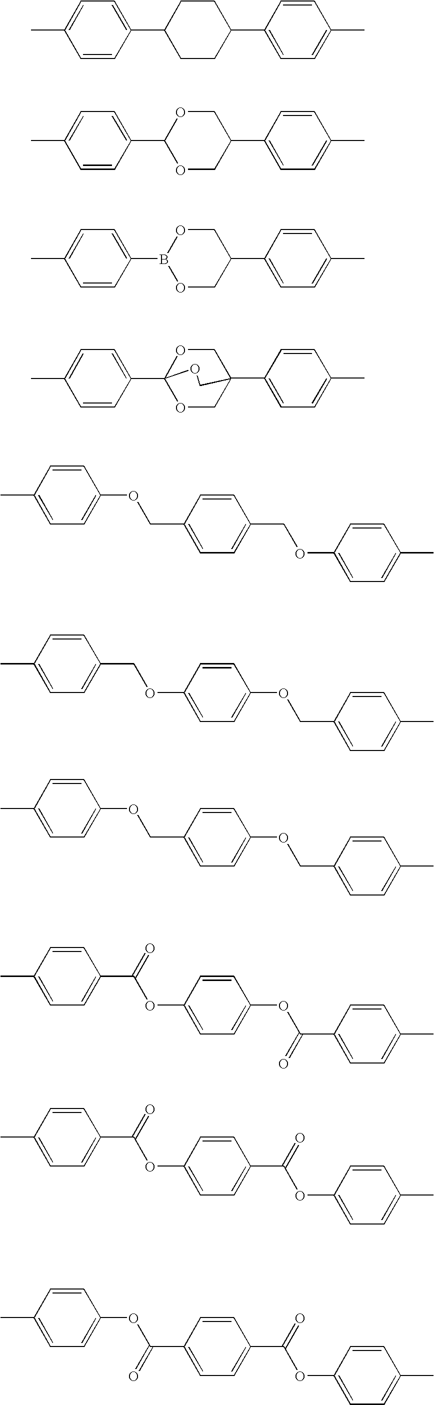

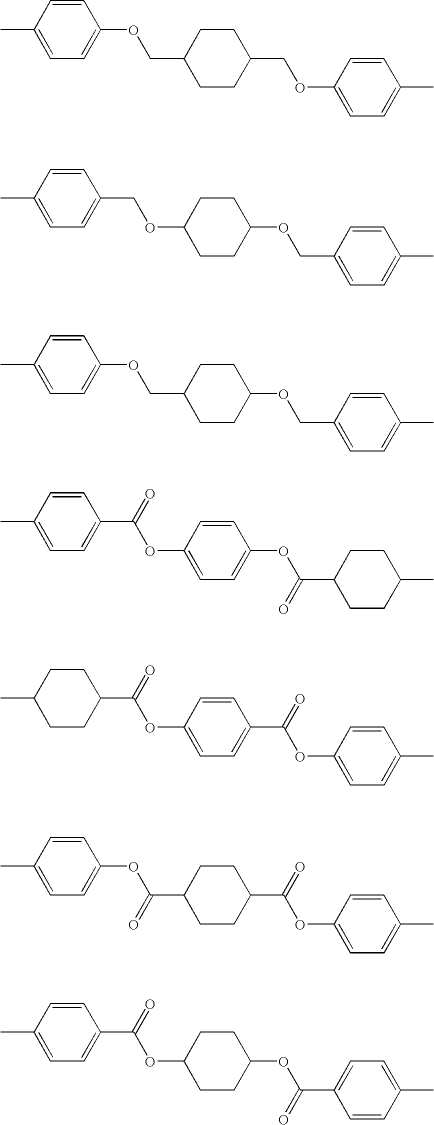

Examples the compound represented by the formula (I) include, but are not to be limited to, these described below. The compounds represented by the formula (I) may be prepared according to a method described in a gazette of Tokkohyo No. hei 11-513019.

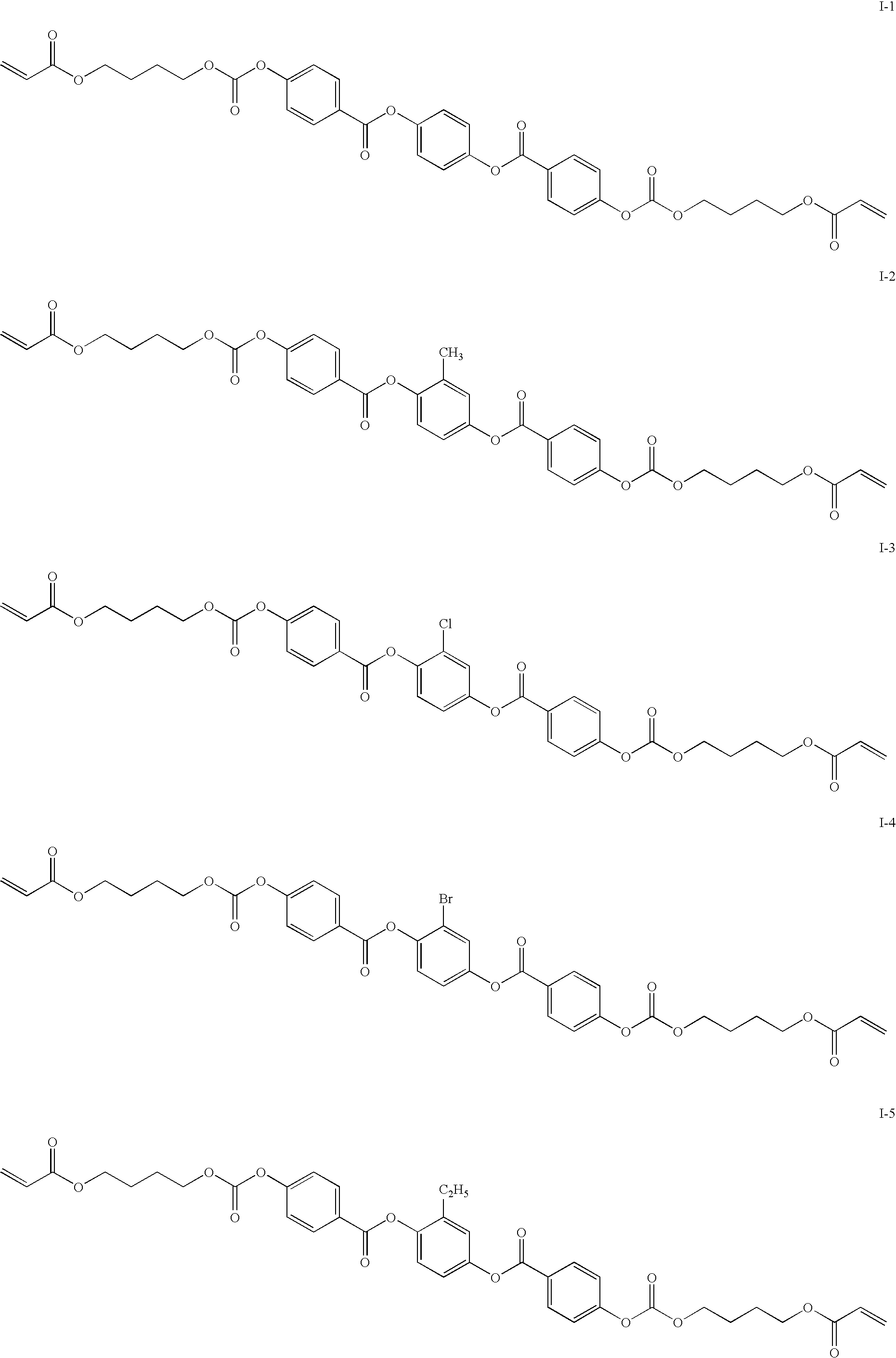

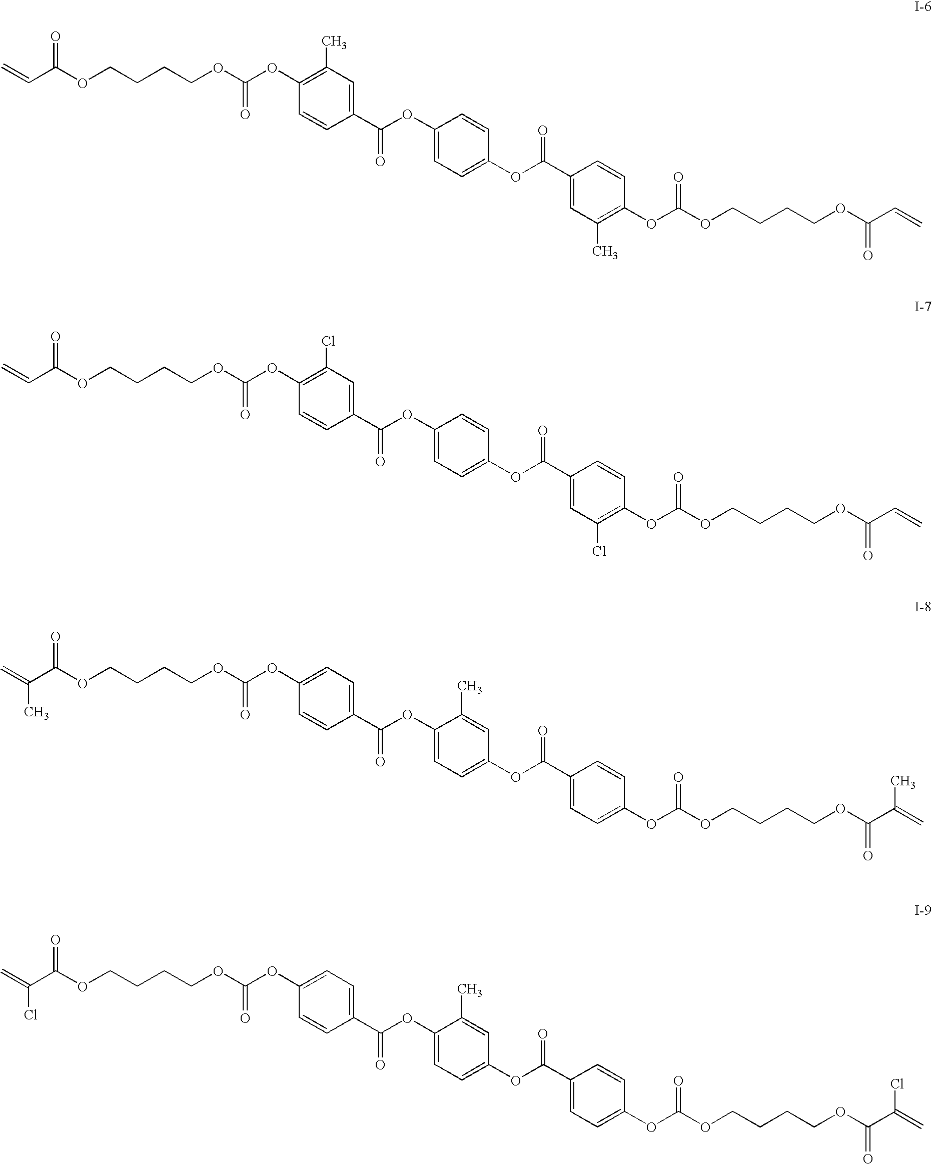

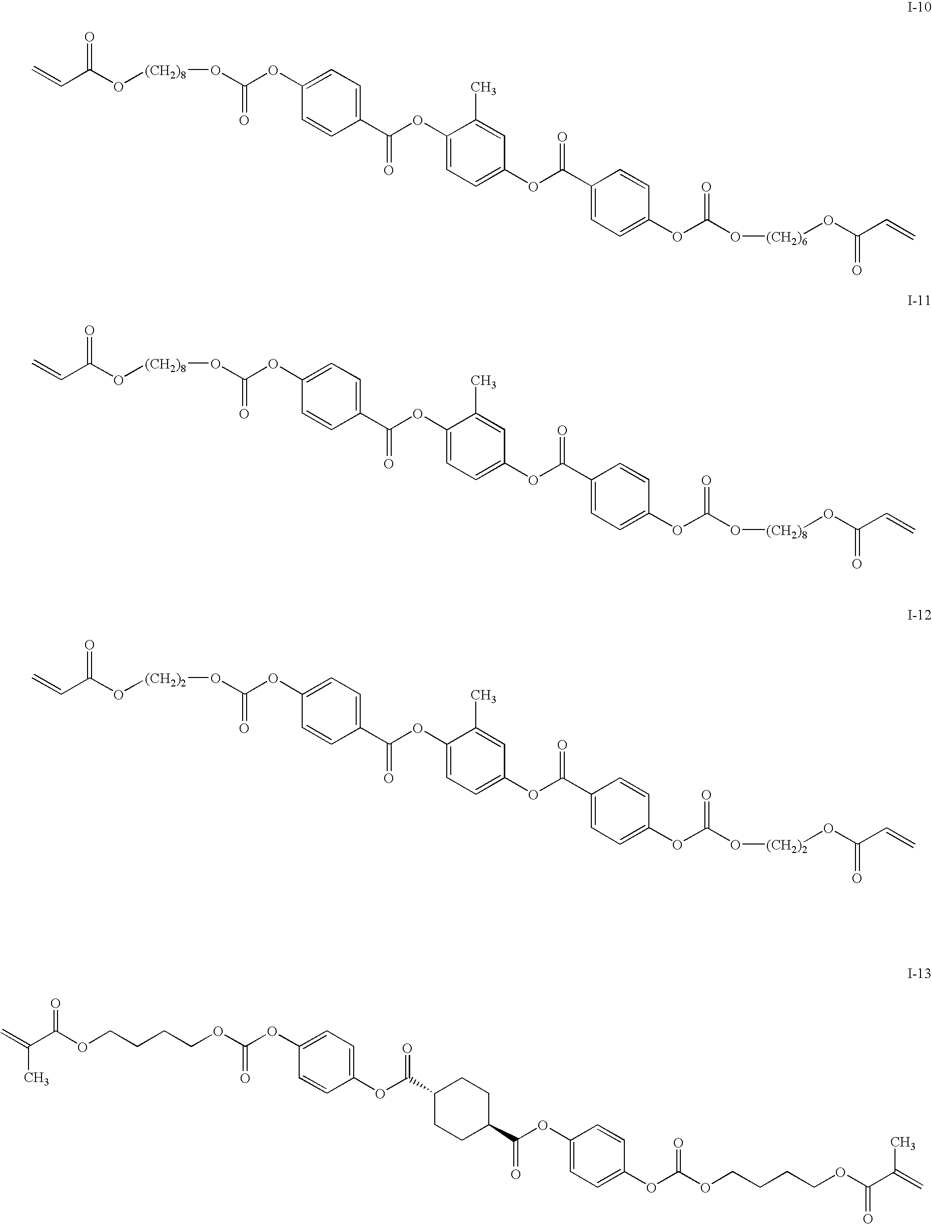

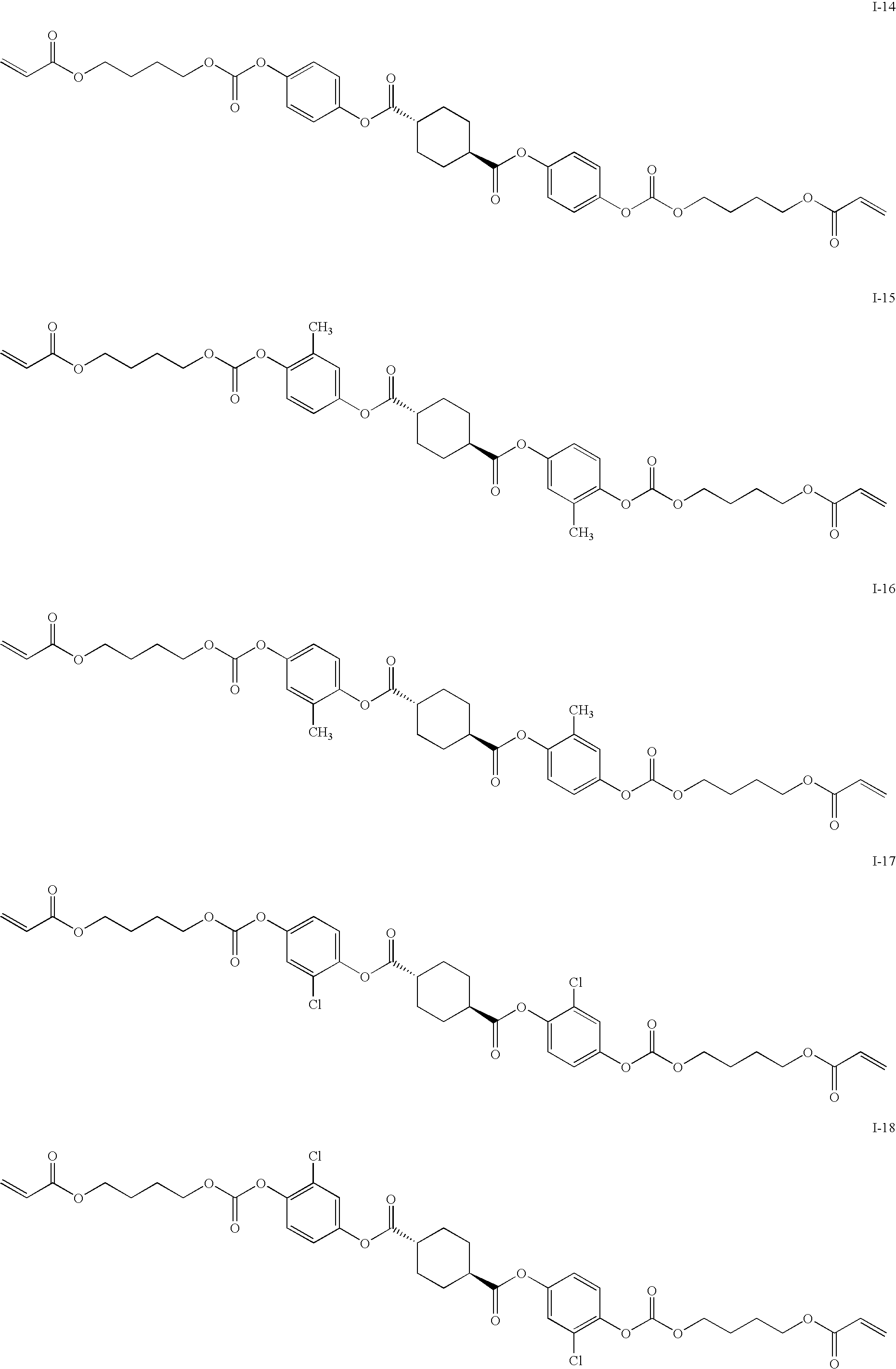

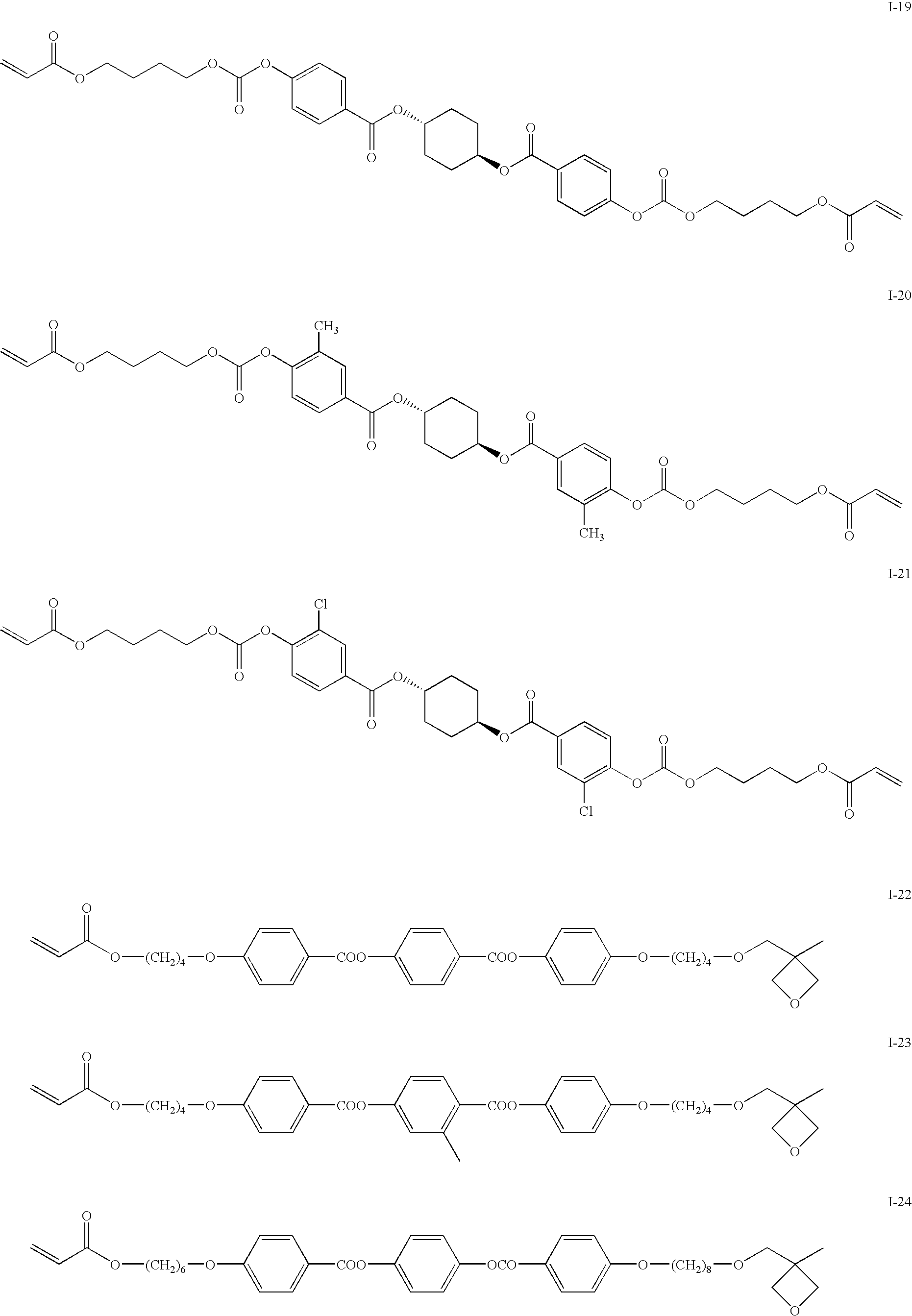

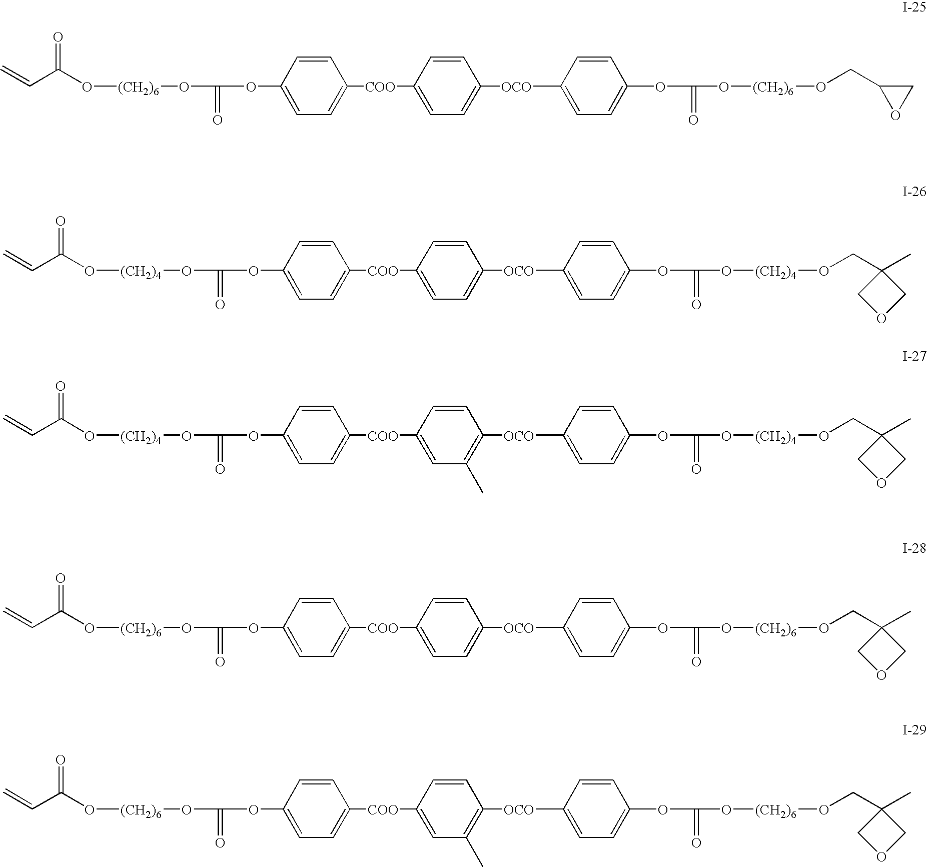

In case where the second optically anisotropic layer is formed of a rod-shaped liquid-crystal composition, it is desirable that the molecules of the rod-shaped liquid crystal are horizontally aligned so that their major axis is parallel to the layer surface, and thereafter the alignment state is fixed as such.

In case where a biaxial second optically anisotropic layer is formed, preferably used is a liquid-crystal composition for biaxial expression that comprises a liquid-crystal composition R capable of expressing a liquid-crystal phase having positive birefringence, and a liquid-crystal composition D capable of expressing a liquid-crystal phase having negative birefringence, as in JPA No. 2005-338744. The liquid-crystal phase having positive birefringence is a liquid-crystal phase satisfying 1≦(nx−nz)/(nx−ny)<1.1; and the liquid-crystal phase having negative birefringence is a liquid-crystal phase satisfying 20<(nx−nz)/(nx−ny)<∞. The liquid-crystal phase having positive birefringence includes, for example, a nematic phase, a smectic A phase and a smectic C phase to be expressed by a rod-shaped or tabular liquid-crystal compound. The liquid-crystal phase of the type satisfies a relation of nx>ny=nz, and therefore, this is a monoaxial liquid-crystal phase having positive birefringence. The details are given in Handbook of Liquid Crystal (issued by Maruzen, 2000), Chap. 2. The phase is especially preferably a nematic phase. On the other hand, the liquid-crystal phase having negative birefringence includes, for example, a discotic nematic phase, a columnar phase and a columnar lamella phase to be expressed by a discotic liquid-crystal compound. Above all, especially preferred is a discotic nematic phase.

Preferred examples of the liquid crystal composition capable of forming a biaxial layer include any liquid crystal compositions comprising both of compounds represented by the formulae (D-1) and (R-2) respectively.

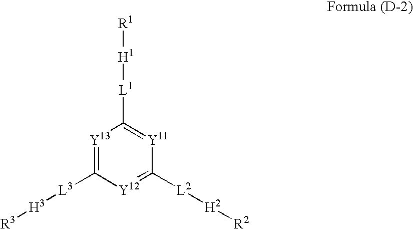

In the formula (D-2), Y¹¹, Y¹² and Y¹³ respectively represent a methine or nitrogen atom; H¹, H² and H³ respectively represent a divalent 5-membered cyclic group; L¹, L² and L³ respectively represent a single bond or a divalent linking group; R¹, R², and R³ respectively represent an alkyl group, alkenyl group, alkynyl group, aryl group, substituted or non-substituted amino group, alkoxy group, aryloxy group, acyl group, alkoxycarbonyl group, aryloxycarbonyl group, alkylsulfonylamino group, arylsulfonylamino group, sulfamoyl group, carbamoyl group, alkylthio group, arylthio group, alkylsulfonyl group, arylsulfonyl group, alkylsulfinyl group, arylsulfinyl group, ureido group, amide phosphate group, hydroxy, mercapto, halogen atom, cyano, sulfo, carboxyl, nitro, hydroxamic acid group, sulfino group, hydrazino group, imino group, heterocyclic group or silyl group.

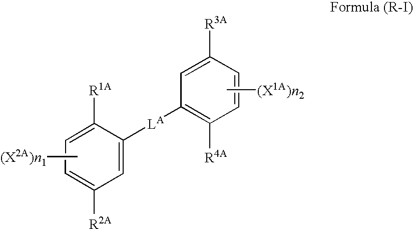

In the formula, L^{A} represents -≡- or -≡-≡-; X^{1A} and X^{2A} respectively represent a halogen atom, carboxyl, hydroxy, cyano, nitro, alkyl group or alkoxy group; n₁ and n₂ respectively represent an integer from 0 to 3; and R^{1A}, R^{2A}, R^{3A} and R^{4A} respectively represent a group represented by the formula (R-IA):

*-(L^{1A}-divalent cyclic group)ₚ-L^{2A}-divalent chain group-Q^{1A} (R-IA)

In the formula (R-IA), “*” represents a site binding to a benzene ring in the formula (R-I); L^{1A} represents a single bond or divalent linking group; L^{2A} represents a single bond or divalent linking group; “divalent cyclic group” represents a linking group having at least one cyclic moiety therein; “divalent chain group” represents an alkylene group, substituted alkylene group, alkenylene group, substituted alkenylene group, alkynylene group or substituted alkynylene group; Q^{1A} represents a polymerizable group; and p is an integer from 0 to 3.

Examples of the liquid crystal compound represented by the formula (D-2) which can be used in the invention include Compounds D-1 to D-134 disclosed in JPA No. 2005-338744, [0145]-[0157]. And examples of the compound represented by the formula (R-I) which can be used in the invention include Compounds TO-1 to TO-12 disclosed in JPA No. 2005-338744, [0073]-[0074].

Examples of the combination of liquid crystal compounds which is capable of exhibiting optical biaxiality are not limited to the above mentioned combinations, and any exemplified compounds disclosed in the patent publications may be used.

And a composition comprising the compound shown below may be used for preparing the second optically anisotropic layer according to a coating or transferring method. The second optically layer formed of the composition comprising the liquid crystal compound shown below may show the reversed wavelength dispersion characteristics of retardation.

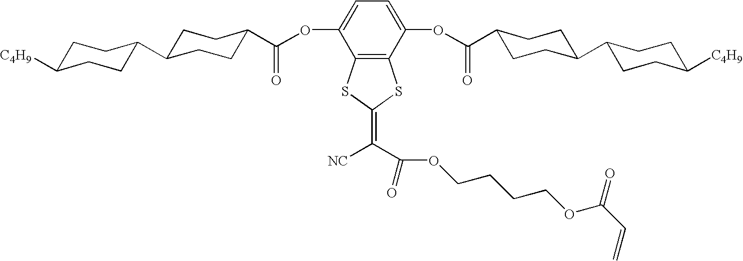

Preferably, the liquid-crystal composition is a curable composition, and it preferably contains a polymerizing component as it forms a cured layer through polymerization. The liquid-crystal compound itself maybe polymerizable, or an additional polymerizing monomer may be added; but preferably, the liquid-crystal compound itself is polymerizable. The curable liquid-crystal composition may optionally contain various additives such as polymerization initiator, alignment controlling agent, surfactant. The second optically anisotropic layer may be formed by preparing a coating liquid of a curable liquid-crystal composition, applying it onto the surface of a support of a polymer film or the like or onto the surface of an alignment film, then aligning themolecules, preferably the discotic molecules of the liquid-crystal compound in a desired alignment state, and thereafter polymerizing it through light irradiation and/or heating thereby fixing the molecules in the alignment state. The polymerization initiators and others usable in the curing reaction and in preparing the curable composition may be the same as those described in JPA No. 2005-338744. In addition, air-interface alignment controlling agent, repelling inhibitor and other additives are also usable herein, and they may be the same as those described in that patent publication.

### [Polymer Composition]

As described in the above, the second optically anisotropic layer may be a layer formed according to a coating method or a transferring method using a polymer composition. The polymer composition contains one or more polymers capable of expressing optical anisotropy according to a coating method. In case where the expression of the optically anisotropic layer is insufficient, then the polymer layer formed according to a coating method may be stretched. For example, a polymer composition is applied onto a support or a polymer film to be a temporary support, thereby forming a polymer layer thereon, and then the obtained laminate film may be stretched so that the stretched layer has the necessary optical characteristics for the second optically anisotropic layer. The polymer for use in forming the second optically anisotropic layer is not specifically defined. Its examples may be the same as those used in forming the first optically anisotropic layer from a polymer composition.

In particular, when a biaxial second optically anisotropic layer is formed, preferred is polyimide. A method of forming a biaxial film from polyimide is described in JPA No. 2005-338425. Examples of the polyimide usable herein may be the same as those described in [0029] to [0053] in that patent publication.

### [Formation Method for Second Optically Anisotropic Layer According to a Coating or Transferring Method]

The formation method for the second optically anisotropic layer according to a coating or transferring method may be the same as that for the first optically anisotropic layer according to a coating or transferring method mentioned in the above.

In case where the biaxial second optically anisotropic layer is formed, using the above-mentioned polyimide, then the organic solvent described in JPA No. 2005-338425 (paragraph 14) may be preferably used.

Preferably, the second optically anisotropic layer is a thin layer, as contributing toward the reduction in the thickness of the body of a liquid-crystal display device. In the invention, the second optically anisotropic layer is formed of a liquid-crystal composition or a polymer composition, and therefore, the layer may be made thin by suitably selecting the material for it. Even though thin, the thus-formed second optically anisotropic layer may have the necessary optical characteristics. In the invention, the thickness of the second optically anisotropic layer is preferably from 0.1 to 20 μm, more preferably from 0.1 to 10 μm, even more preferably from 0.1 to 3 μm. In the invention, Rth (548)/(d×1000) of the second optically anisotropic layer is preferably at least 0.03, more preferably at least 0.05, even more preferably at least 0.07. The above-mentioned range of Rth (548)/(d×1000) is favorable as more reducing the corner unevenness to occur on the display panel surface in long-term use.

The second optically anisotropic layer to be formed according to a coating or transferring method is generally formed on a support of a polymer film or the like. Positively taking advantage of the birefringence of the polymer film to form the support, the laminate may satisfy the necessary optical characteristics for the second optically anisotropic layer in one embodiment; or a film having a retardation of nearly 0 (zero) may be used for the support (for example, the cellulose acylate film as in JPA No. 2005-138375), and the layer of a liquid-crystal composition or a polymer composition alone may satisfy the necessary optical characteristics for the second optically anisotropic layer in the other embodiment. As described in the above, the support for the second optically anisotropic layer may be a polymer film for the first optically anisotropic layer, or may be a polymer film for the protective film for polarizing element; and in these embodiments, the polymer film satisfying the necessary requirements for the individual applications may be selected.

In case where the second optically anisotropic layer is formed of a liquid-crystal composition, an alignment film may be used for making the liquid crystal in a desired alignment state. Any ordinary alignment film may be used, for example, a surface-rubbed polymer film of polyvinyl alcohol film or polyimide film. Examples of the alignment film usable in the invention may be the same as those of the alignment film described in JPA No. 2005-338744.

### [Optical Film]

The invention also relates to an optical film comprising the above-mentioned first optically anisotropic layer (preferably the first optically anisotropic layer satisfying the above formulae (a1) to (a3) ) and the above-mentioned second optically anisotropic layer (preferably the second optically anisotropic layer satisfying the above formulae (b1) to (b6)), in which one of the first and second optically anisotropic layers is formed according to a coating or transferring method.

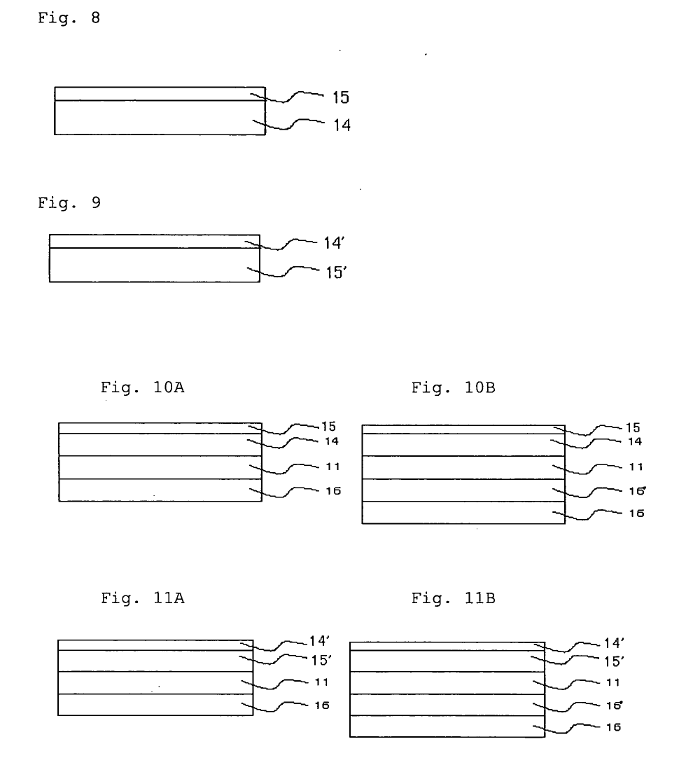

FIG. 8 is a schematic cross-sectional view of one example of an optical film of the invention. The optical film of FIG. 8 comprises a cellulose acylate film 14 that satisfies the characteristics of the first optically anisotropic layer, and, as formed thereon according to a coating method directly or via a transfer material, a layer 15 of a liquid-crystal composition or a polymer composition that satisfies the characteristics of the second optically anisotropic layer.

FIG. 9 is a schematic cross-sectional view of another example of an optical film of the invention. The optical film of FIG. 9 comprises a cellulose acylate film 15′ that satisfies the characteristics of the second optically anisotropic layer, and, as formed thereon according to a coating method directly or via a transfer material, a layer 14′ of a liquid-crystal layer or a polymer layer that satisfies the characteristics of the first optically anisotropic layer. Preferred embodiments of the optically anisotropic layers and examples of the materials for use in forming the layers are as described in the above. The optical film of the invention is favorably used as an optically-compensatory film in a liquid-crystal display device, and more favorably as an optically-compensatory film in a VA-mode liquid-crystal display device.

The invention also relates to an optical film comprising at least a first optically anisotropic layer satisfying the following formula (a6) and a second optically anisotropic layer (preferably satisfying all of the formulae (b1)-(b6)),

wherein the first optically anisotropic layer is a layer formed according to a coating or transferring method, of which thickness-direction retardation Rth decreases with longer wavelength within a visible light range; and

the second optically is a layer formed according to a coating or transferring method, of which in-plane retardation Re and thickness-direction retardation Rth do not change depending on the wavelength within a visible light range, or increase with longer wavelength within a visible light range

0.5<Rth(548)/Re(548). (a6)

This embodiment of the optical film of the invention is also preferably employed as an optical compensation film of a Liquid crystal display device, preferably a VA-mode liquid crystal display device, and may contribute to reducing color shift occurred in oblique directions.

According to this embodiment, both of first and second optically anisotropic layers are formed according to a coating or transferring method, and this embodiment may further comprise a support such as a polymer film supporting both of the first and second optically anisotropic layers. The polymer film is preferably selected from optically isotropic polymer films having Re and Rth nearly equal to 0 nm.

In general, in a large-panel display device, the contrast reduction and the color shift in the oblique direction are remarkable, and therefore the optical film of the invention is especially suitable for use in large-panel liquid-crystal display devices. In case where the optical film is used in large-panel liquid-crystal display devices, for example, it is preferably shaped to have a film width of at least 1470 mm. As the case may be, the optical film may be produced as a long film in continuous production and wound up into a roll, and it may be cut into sheets having a size capable of being directly built in a liquid-crystal display device as it is; and the optical film of the invention may have a form of such cut sheets. The film roll is stored and transported as it is, and when it is actually built in a liquid-crystal display device or when it is stuck to a polarizing element, then it is cut into a desired size. If desired, the long film may be stuck to a polarizing element of a polyvinyl alcohol produced as a long film like it, and then, when it is actually built in a liquid-crystal display device, it may be cut into a desired size. In one embodiment of a roll of the optical film of the invention, the film having a length of at least 2500 m is wound up into a roll film.

### [Polarizing Plate]

The invention also relates to a polarizing plate that comprises a polarizing element and an optical film of the invention on one surface of the polarizing element. Like the optical film of the invention, the polarizing plate may be produced as a long film in a mode of continuous production, and may be wound up as a roll (for example, as a roll having a length of at least 2500 mm, or a roll having a length of at least 3900 m), and it may be cut into sheets having a size capable of being built in a liquid-crystal display device as it is. The polarizing plate of the invention may have a form of such cut sheets. For application to large-panel liquid-crystal display devices, the polarizing plate preferably has a width of at least 1470 mm, as so mentioned hereinabove.

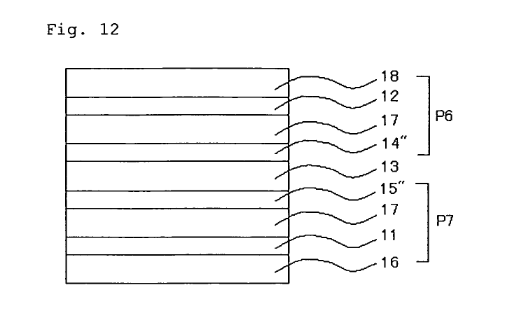

FIG. 10A and FIG. 10B show schematic cross-sectional views of embodiments of the polarizing plate of the invention. The polarizing plate of FIG. 10A comprises a polarizing element 11 of a polyvinyl alcohol film dyed with iodine or dichroic dye; an optical film of the invention, or that is, a laminate of a first optically anisotropic layer 14 and a second optically anisotropic layer 15 disposed on one surface of the polarizing element 11; and a protective film 16 on the other surface thereof. Preferably, the polarizing plate is so built in a liquid-crystal display device that the optical film of the invention may serve as a protective film on the side of the liquid-crystal cell therein and that the second optically anisotropic layer 15 is on the side of the liquid-crystal cell.

FIG. 11A and FIG. 11B show schematic cross-sectional views of other embodiments of the polarizing plate of the invention. The polarizing plate of FIG. 11A comprises a polarizing element 11 of a polyvinyl alcohol film dyed with iodine or dichroic dye; an optical film of the invention, or that is, a laminate of a second optically anisotropic layer 15′ and a first optically anisotropic layer 14′ disposed on one surface of the polarizing element 11; and a protective film 16 on the other surface thereof. Preferably, the polarizing plate is so built in a liquid-crystal display device that the optical film of the invention may serve as a protective film on the side of the liquid-crystal cell therein and that the first optically anisotropic layer 14′ is on the side of the liquid-crystal cell.

The protective film 16 is disposed on the outer side, for which, therefore, a material of low moisture permeation is preferred from in terms of the durability of the polarizing plate. Concretely, preferred is a film having a degree of moisture permeation of at most 200 g/(m²·day), more preferably at most 50 g/(m²·day), even more preferably at most 20 g/(m²·day). Not specifically defined, the lowermost limit of the degree of moisture permeation of the film may be generally 10 g/(m²·day) or so. The moisture permeation of the film is measured at 40° C. and 90% RH. Its details are described in JIS-0208. For the protective film having the characteristics, preferred is a norbornene polymer film, and a commercial product, ZEONOR film may be used. Also preferred for use herein is a low-permeation material prepared by forming a low-permeation coating layer on a film substrate. One example of the coating layer is a polymer that contains a repetitive unit derived from a chlorine-containing vinyl monomer (hereinafter this may be referred to as a chlorine-containing polymer). The chlorine-containing vinyl monomer generally includes vinyl chloride, vinylidene chloride. The chlorine-containing polymer may be obtained through copolymerization of such a vinyl chloride or vinylidene chloride monomer with a monomer copolymerizable with it. The chlorine-containing vinyl monomer may be copolymerized with any other monomer. The monomer copolymerizable with the chlorine-containing vinyl monomer may be selected from olefins, styrenes, acrylates, methacrylates, acrylamides, methacrylamides, itaconic diesters, maleates, fumaric diesters, N-alkylmaleimides, maleic anhydride, acrylonitrile, vinyl ethers, vinyl esters, vinyl ketones, vinyl heterocyclic compounds, glycidyl esters, unsaturated nitrites, unsaturated carboxylic acids.

Because of the reason that a film having a low degree of moisture permeation is disposed on the outer side of a liquid-crystal display device so as to prevent moisture penetration into the device and because of the reason that a film having a low degree of moisture permeation is poorly adhesive to a polarizing element, a protective film 16′ for the polarizing element 11 may be additionally provided between the polarizing element 11 and the film 16 of low moisture permeation, as in FIG. 10B and FIG. 11B. For the protective film 16′, preferred is a cellulose acylate film. In this case, as an example of the invention, preferably used is a low-permeation film comprising a film 16′ of a cellulose acylate film and a film 16 of the above-mentioned chlorine-containing polymer.

Between the polarizing element 11 and the first optically-compensatory film 14 or the second optically anisotropic layer 15′, an additional protective film may also be disposed, having a function of protecting the polarizing element; however, it is desirable that a film having a retardation of nearly 0, for example, the cellulose acylate film described in JPA No. 2005-138375 is used for the protective film of the type in order that the additional protective film would not lower the optical compensatory potency

### EXAMPLES

The invention is described more concretely with reference to the following Examples, in which the material and the reagent used, their amount and the ratio, the details of the treatment and the treatment process may be suitably modified or changed not overstepping the sprit and the scope of the invention. Accordingly, the invention should not be limited by the Examples mentioned below.

### Example 1-1

A VA-mode liquid-crystal display device having the same constitution as that of the liquid-crystal display device of FIG. 1 was produced. Production methods for various members are described below.

### (Production of Cellulose Acylate Film 001 for First Optically Anisotropic Layer)

### Preparation of Cellulose Acylate Solution:

The components were mixed in the ratio indicated in Table 1-1, thereby preparing a cellulose acylate solution. The cellulose acylate solution was cast on a metal support, the resulting web was peeled from the support, and dried to produce a long cellulose acylate film 001 having the thickness indicated in Table 1-1.

TABLE 1-1

| Film Sample No. 001 | |
|---|---|
| Cellulose acylate | 100 parts by mass |
| acetyl substitution degree: | |
| 2.92 | |
| Compound A shown below | 12 parts by mass |
| Rth enhancer I-(2) | 7 parts by mass |
| Thickness | 80 Mm |

Rth Enhancer I-(2)

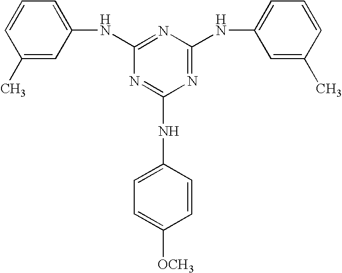

Compound A

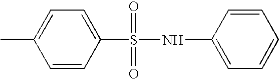

Thus produced, the cellulose acylate film 001 was analyzed for the three-dimensional birefringence thereof at a wavelength of 446 nm, 548 nm and 628 nm, using an automatic birefringence meter KOBRA-21ADH (by Oji Scientific Instruments) according to the method mentioned in the above, thereby obtaining the in-plane retardation Re and the thickness-direction retardation Rth calculated based on the data of Re at different tilt angles. Table 1-2 shows Rth(548)/Re(548) and Rth(446)/Rth(548). As in Table 1-2 below, it is understandable that the cellulose acylate film 001 satisfies the above formulae (a1) to (a3) and can be used as a first optically anisotropic layer.

In the following Examples 1-2, 1-3 and 1-6, the thus-produced long cellulose acylate film 001 was cut into sheets having a suitable length and used as a first optically anisotropic layer.

TABLE 1-2
(Optical Characteristics of Cellulose Acylate Film 001)

| | | Film Sample No. |
|---|---|---|
| | | 001 |
| Re(nm) | Wavelength 446 nm | 2.2 |
| | Wavelength 548 nm | 1.4 |
| | Wavelength 626 nm | 1.1 |
| Rth(nm) | Wavelength 446 nm | 112 |
| | Wavelength 548 nm | 101 |
| | Wavelength 626 nm | 99 |

| | |
|---|---|
| (a1) Rth(548)/Re(548) | 72 |
| (a3) Rth(446)/Rth(548) | 1.11 |

(Production of Optical Film 101 with Second Optically Anisotropic Layer 002 Formed Thereon)

The surface of the cellulose acylate film 001 produced in the above was saponified with an alkaline solution, then a coating layer for alignment film having the formulation mentioned below was applied onto it in an amount of 20 ml/m², using a wire bar coater. This was dried with hot air at 60° C. for 60 seconds and then with hot air at 100° C. for 120 seconds, thereby forming a film. Next, the thus-formed film was rubbed in the direction perpendicular to the machine direction of the cellulose acylate film 001, thereby forming an alignment film.

Formulation of Coating Liquid for Alignment Film

| | |
|---|---|
| Modified Polyvinyl Alcohol mentioned below | 2 mas. pts. |
| Water | 74 mas. pts. |
| Methanol | 24 mas. pts. |
| Glutaraldehyde | 0.1 mas. pts. |

Modified Polyvinyl Alcohol

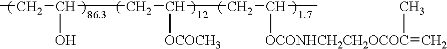

### Preparation of Coating Liquid for Forming Optically Anisotropic Layer 002

A coating liquid for forming optically anisotropic layer 002 having the formulation mentioned below was prepared.

Formulation of Coating Liquid for Optically
anisotropic layer 002

| | |
|---|---|
| Rod-Shaped Liquid-Crystal Compound mentioned | 100 mas. pts. |
| below | |
| Photopolymerization Initiator | 3 mas. pts. |
| (Irgacure 907, by Ciba-Geigy) | 1 mas. pt. |
| Sensitizer (Kayacure DETX, by Nippon Kayaku) | |
| Methyl Ethyl Ketone | 197 mas. pts. |

Rod-Like Liquid-Crystal Compound

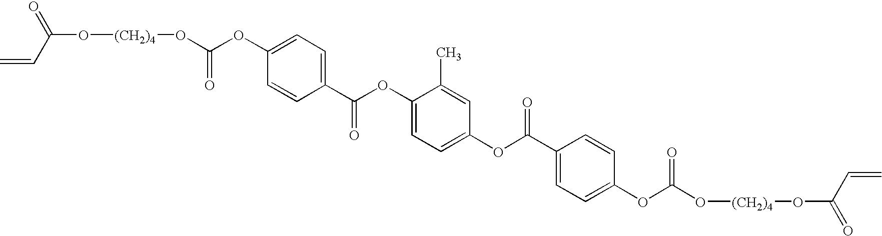

The coating liquid of the above composition was continuously applied onto the formed alignment film, using a bar coater, then dried and heated at 120° C. for 2 minutes (alignment aging), and thereafter using a high-pressure mercury lamp of 120 W/cm, this was irradiated with UV for 30 seconds to form an optically anisotropic layer 002 having a thickness of 1.5 μm, thereby producing an optical film 101 integrated with the cellulose acylate film 001. Its retardation Re at 548 nm was 110 nm, and its Rth was 56 nm. The formed optically anisotropic layer 002 was analyzed for its condition, and the absence of coating unevenness (unevenness resulting from the action of the alignment film to repel the coating liquid) and alignment disorder was confirmed. The optical characteristics of the second optically anisotropic layer 002 are shown in Table 1-3. For analyzing the optical performance of the second optically anisotropic layer 002 alone, an optically anisotropic layer 002 was separately formed on a glass substrate of which Re and Rth are both estimated as 0 (zero), but not on the cellulose acylate film 001, according to the same process as above, and this was analyzed with an automatic birefringence meter KOBRA-21ADH (by Oji Scientific Instruments).

TABLE 1-3
(Optical Performance of Optically anisotropic layer 002)

| | | Optically |
|---|---|---|
| | | anisotropic layer |
| | | No. |
| | | 002 |
| Re | 548 nm | 110 |
| Rth | 548 nm | 56 |

| | |
|---|---|
| Nz(=Rth/Re + 0.5) | 1.01 |
| Thickness (μm) | 1.5 |

### (Production of Protective Film 201 for Polarizing Element)

### Formation of Low Moisture-Permeation Coating Layer

A roll of triacetyl cellulose film having a thickness of 80 μm (TAC-TD80U, by FUJIFILM) was unrolled, and using a coater equipped with a throttle die, a coating liquid for low moisture-permeation coating layer having the formulation mentioned below was directly extruded onto it. The liquid was applied at a traveling speed of 30 m/min, then dried at 60° C. for 5 minutes, and the coated film was rolled up.

Formulation of Coating Liquid for Low Moisture-Permeation
Coating Layer

| | |
|---|---|
| Chlorine-containing Polymer, R204 | 12 g |
| (Asahi Kasei Life & Living's “Saran Resin R204”) | |
| Tetrahydrofuran | 63 g |

### (Formation of Hard Coat Layer)

The 80-μm thick triacetyl cellulose film roll (TAC-TD80U, by FUJIFILM) coated with the low moisture-permeation coating layer was unrolled, and using a coater with a throttle die, the coating liquid for hard coat layer mentioned below was directly extruded onto it. The liquid was applied at a traveling speed of 30 m/min, then dried at 30° C. for 15 minutes, further dried at 90° C. for 20 seconds, and using a 160 W/cm air-cooling metal halide lamp (by Eyegraphics) under nitrogen purging, this was irradiated with UV rays at a dose of 90 mJ/cm² to cure the coating layer, thereby forming an antiglare hard coat layer having a thickness of 6 μm. This was wound up. The above process gave a polarizer protective film 201 coated with a low moisture-permeation barrier layer. The moisture permeation of the thus-produced polarizer protective film 201 was 33 g/(m²·day).

Formulation of Coating Liquid for Hard Coat Layer

| | |
|---|---|
| PET-30 | 40.0 g |
| DPHA | 10.0 g |
| Irgacure 184 | 2.0 g |
| SX-350 (30%) | 2.0 g |
| Crosslinked Acryl-Styrene Particles (30%) | 13.0 g |
| FP-13 | 0.06 g |
| Sol a | 11.0 g |
| Toluene | 38.5 g |

### (Production of Polarizing Plate 1-R)

The back of the optical film 101 produced in the above (the back of the cellulose acylate film 001 on the side not coated with the second optically anisotropic layer 002), and one surface of the polarizer protective film 201 (on the side not coated with the low moisture-permeation layer) were processed for alkali saponification. Concretely, the film was dipped in an aqueous 1.5 N sodium hydroxide solution at 55° C. for 2 minutes, then washed in a water bath at room temperature, and then neutralized with 0.1 N sulfuric acid at 30° C. Again this was washed in a water bath at room temperature, and then dried with hot air at 100° C. Next, a polyvinyl alcohol film roll having a thickness of 80 μm was continuously stretched in an aqueous iodine solution by 5 times, and dried to prepare a polarizing film having a thickness of 20 μm. Using an aqueous 3% polyvinyl alcohol (Kuraray's PVA-117H) solution, the above alkali-saponified optical film 101 and the above alkali-saponified polarizer protective film 201 were stuck together with the polarizing film in such a manner that their saponified surfaces were on the side of the polarizing film, thereby obtaining a polarizing plate 1-R having the cellulose acylate film 001 (first optically anisotropic layer) and the polarizer protective film 201 as a protective film of the polarizing film. In this, the films were so stuck together that the direction MD of the polymer film was parallel to the absorption axis of the polarizing film.

Thus produced, the polarizing plate 1-R was used as the polarizing plate P1 in FIG. 1, serving as a polarizing plate for LCD as described herein under.

### (Production of Polarizing Plate 1-F)

According to the same process as that for the polarizing plate 1-R, a polarizing plate 1-F was produced, for which, however, a commercial cellulose acylate film (FUJIFILM's Z-TAC with Re=0 nm and Rth=0 nm) was used in place of the optical film 101 for the polarizing plate 1-R and another polarizer protective film 201 was used.

Thus produced, the polarizing plate 1-F was used as the polarizing plate P0 for LCD in FIG. 1 as described herein under. Corresponding to the protective film 17, the above Z-TAC (produced by FUJIFILM) was on the side of the liquid-crystal cell.

### (Production of Liquid-Crystal Display Device LCD-1)

In a commercial 37-inch VA-mode liquid-crystal TV (by Sharp), the polarizing plates and the retardation plates on both the top and the back of the panel were peeled away, and this was used as a liquid-crystal cell. In this, the produced polarizing plate 1-F, as the polarizing plate P0 in the constitution of FIG. 1, and the produced polarizing plate 1-R, as the polarizing plate P1 therein, were stuck to the liquid-crystal cell with an adhesive, thereby producing a liquid-crystal display device LCD-1. This LCD-1 was so designed that 14 in FIG. 1 is the cellulose acylate film 001, 15 in FIG. 1 is the optically anisotropic layer 002, and 17 in FIG. 1 is Z-TAC. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Example 1-2

Using the cellulose acylate film 001 produced in Example 1-1 and an optically anisotropic layer 003 was formed according to the following method in place of the optically anisotropic layer 002, an optical film 102 and a polarizing plate 2-R were produced.

### (Production of Optically Anisotropic Layer 003)

In the same manner as in Example 1-1, an alignment film was provided on the film 001. Next, a coating liquid for formation of optically anisotropic layer 003 having the formulation mentioned below was prepared.

Coating Liquid for Formation of
Optically anisotropic layer 003

| | |
|---|---|
| Liquid-Crystal Compound D-8 | 68.8 mas. pts. |
| Liquid-Crystal Compound TO-3 | 31.2 mas. pts. |
| Air Interface Alignment Controlling Agent V-(1) | 0.2 mas. pts. |
| Irgacure 907 (Nagase Sangyo) | 1.0 mas. pt. |
| Chloroform | 700 mas. pts. |

Liquid-Crystal Compound D-8

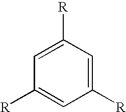

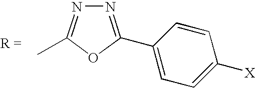

X = —O(CH₂)₃OCOCH═CH₂
Liquid-Crystal Compound TO-3

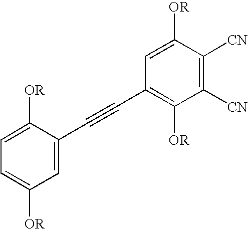

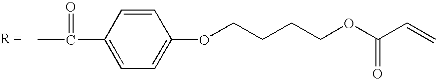

Air Interface Alignment Controlling Agent V-(1)

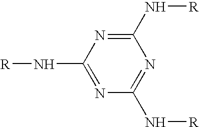

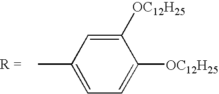

The coating liquid of the above composition was continuously applied onto the formed alignment film, using a bar coater, then dried and heated up to 130° C., then cooled to 95° C., kept heated as such for 2 minutes (alignment aging), and thereafter using a high-pressure mercury lamp of 120 W/cm, this was irradiated with UV for 30 seconds to form an optically anisotropic layer 003 having a thickness of 1.5 μm, thereby fabricating an optical film 102 integrated with the cellulose acylate film 001. The retardation Re at 548 nm of this optically anisotropic layer 003 was 100 nm, and Rth thereof was 130 nm. The formed optically anisotropic layer 003 was analyzed for its condition, and the absence of coating unevenness (unevenness resulting from the action of the alignment film to repel the coating liquid) and alignment disorder was confirmed. The optical characteristics of the second optically anisotropic layer 003 are shown in Table 1-3. For analyzing the optical performance of the second optically anisotropic layer 003 alone, a optically anisotropic layer 003 was separately formed on a glass substrate of which Re and Rth are both estimated as 0 (zero), but not on the cellulose acylate film 001, according to the same process as above, and this was analyzed with an automatic birefringence meter KOBRA-21ADH (by Oji Scientific Instruments).

TABLE 1-4
(Optical Performance of Optically anisotropic layer 003)

| | | Optically |
|---|---|---|
| | | anisotropic layer |
| | | No. |
| | | 003 |
| Re | 548 nm | 100 |
| Rth | 548 nm | 130 |

| | |
|---|---|
| Nz (=Rth/Re + 0.5) | 1.80 |
| thickness (μm) | 1.5 |

### (Production of Polarizing Plate 2-R)

According to the same process as that for the polarizing plate 1-R in Example 1-1, a polarizing plate 2-R was produced, for which, however, the above-produced optical film 102 was used in place of the optical film 101. As described below, the thus-produced polarizing plate 2-R was used as the polarizing plate for LCD, that is, as the polarizing plate P1 in FIG. 1.

### (Production of Liquid-Crystal Display Device LCD-2)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 2-R, as the polarizing plate P1 in the constitution of FIG. 1, and the polarizing plate 1-F produced in Example 1-1, as the polarizing plate P0 therein, were stuck to the liquid-crystal cell with an adhesive, thereby producing a liquid-crystal display device LCD-2. This LCD-2 was so designed that 14 in FIG. 1 is the cellulose acylate film 001, 15 in FIG. 1 is the optically anisotropic layer 003, and 17 in FIG. 1. is Z-TAC. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Example 1-3

### (Production of Polarizing Plate 3-R)

In the same manner as in Example 1-1, an optical film 103 and a polarizing plate 3-R were produced, for which, however, an optically anisotropic layer 004 was formed as the second optically anisotropic layer according to the method mentioned below in place of forming the optically anisotropic layer 002. In forming the optically anisotropic layer 004, the alignment film used in forming the optical film 101 was not used.

### (Formation of Optically Anisotropic Layer 004)

### Preparation of Polyimide Coating Liquid:

Using 2,2′-bis(3,4-dicarboxyphenyl)hexafluoropropanoic acid dianhydride and 2,2′-bis(trifluoromethyl)-4,4′-diaminobiphenyl, a polyimide comprising a repetitive unit of the formula mentioned below was produced (Mw=70,000). The polyimide was dissolved in MIBK to prepare a polyimide solution having a polyimide concentration of 24% by weight and a viscosity of 3 Pa·s. A method for producing the above polyimide is described in detail in Japanese Patent No. 3735361.

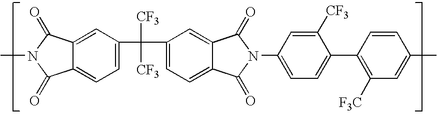

### (Production of Optical Film 103)

Using a bar coater, the above polyimide solution was directly applied onto a cellulose acylate film 001 produced in Example 1-1 with controlling its thickness, and then this was dried at 130° C. for 3 minutes to form a polyimide layer 004 having a thickness of 5 μm, thereby obtaining an optical film 103 integrated with the cellulose acylate film 001. The optically anisotropic layer 004 of the polyimide was analyzed as follows (Table 1-5). Separately, an optically anisotropic layer 004 of the polyimide was formed on a glass substrate, of which Re and Rth are both estimated as 0 (zero), according to the same process as above, and this was analyzed with an automatic birefringence meter KOBRA-21ADH (by Oji Scientific Instruments).

TABLE 1-5
(Optical Performance of Optically anisotropic layer 004)

| | | Optically |
|---|---|---|
| | | anisotropic layer |
| | | No. |
| | | 004 |
| Re | 548 nm | 103 |
| Rth | 548 nm | 130 |

| | |
|---|---|
| Nz (=Rth/Re + 0.5) | 1.76 |
| thickness (μm) | 5.0 |

### (Production of Polarizing Plate 3-R)

According to the same process as that for the polarizing plate 1-R in Example 1-1, a polarizing plate 3-R was produced, for which, however, the above-produced optical film 103 was used in place of the optical film 101.

As described below, the thus-produced polarizing plate 3-R was used as the polarizing plate for LCD, that is, as the polarizing plate P1 in FIG. 1.

### (Production of Liquid-Crystal Display Device LCD-3)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 3-R, as the polarizing plate P1 in the constitution of FIG. 1, and the polarizing plate 1-F produced in Example 1-1, as the polarizing plate P0 therein, were stuck to the liquid-crystal cell with an adhesive, thereby producing a liquid-crystal display device LCD-4. This LCD-3 was so designed that 14 in FIG. 1 is the cellulose acylate film 001, 15 in FIG. 1 is the optically anisotropic layer 004, and 17 in FIG. 1 is Z-TAC. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Example 1-4

### (Production of Cellulose Acylate Film 005)

In the same manner as that for the cellulose acylate film 001 in Example 1-1 but changing the Rth enhancer I-(2) to the following compound B, a cellulose acylate film 005 was produced.

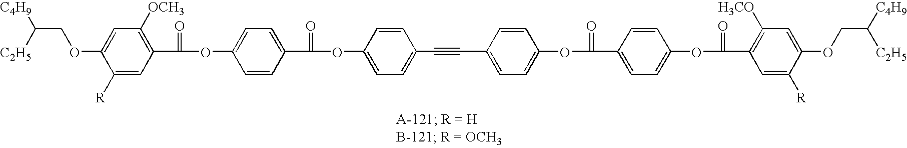

Thus produced, the cellulose acylate film 005 was analyzed for the three-dimensional birefringence thereof at a wavelength of 446 nm, 548 nm and 628 nm, using an automatic birefringence meter KOBRA-21ADH (by Oji Scientific Instruments) according to the method mentioned in the above, thereby obtaining the in-plane retardation Re and the thickness-direction retardation Rth calculated based on the data of Re at different tilt angles. Table 1-6 shows Rth(548)/Re(548) and Rth(446)/Rth(548). As in Table 1-6 below, it is understandable that the cellulose acylate film 005 satisfies the above formulae and can be used as a first optically anisotropic layer.

TABLE 1-6

| | | Film Sample No. |
|---|---|---|
| | | 005 |
| Re (nm) | Wavelength 446 nm | 2.8 |
| | Wavelength 548 nm | 2.1 |
| | Wavelength 626 nm | 1.8 |
| Rth (nm) | Wavelength 446 nm | 123 |
| | Wavelength 548 nm | 100 |
| | Wavelength 626 nm | 95 |

| | |
|---|---|
| (a1) Rth(548)/Re(548) | 48 |
| (a3) Rth(446)/Rth(548) | 1.23 |

### (Production of Liquid-Crystal Display Device LCD-4)

A liquid-crystal display device LCD-4 was produced in the same manner as that for the liquid-crystal display device LCD-1 in Example 1-1, for which, however, the optical film 104 that had been produced with the cellulose acylate film 005 in place of the cellulose acylate film 001 was used. This LCD-4 was so designed that 14 in FIG. 1 is the cellulose acylate film 005, 15 in FIG. 1 is the optically anisotropic layer 002, and 17 in FIG. 1 is Z-TAC.

### Example 1-5

### (Production of Cellulose Acylate Film 006)

In the same manner as that for the cellulose acylate film 001 in Example 1-1 but using 4 parts by mass of the Rth enhancer I-(2) and 3 parts by mass of the compound B in place of using 7 parts by mass of I-(2), a cellulose acylate film 006 was produced.

Thus produced, the cellulose acylate film 006 was analyzed for the three-dimensional birefringence thereof at a wavelength of 446 nm, 548 nm and 628 nm, using an automatic birefringence meter KOBRA-21ADH (by Oji Scientific Instruments) according to the method mentioned in the above, thereby obtaining the in-plane retardation Re and the thickness-direction retardation Rth calculated based on the data of Re at different tilt angles. Table 1-7 shows Rth(548)/Re(548) and Rth(446)/Rth(548). As in Table 1-7 below, it is understandable that the cellulose acylate film 006 satisfies the above formulae and can be used as a first optically anisotropic layer.

TABLE 1-7

| | | Film Sample No. |
|---|---|---|
| | | 006 |
| Re (nm) | Wavelength 446 nm | 2.5 |
| | Wavelength 548 nm | 2 |
| | Wavelength 626 nm | 1.8 |
| Rth (nm) | Wavelength 446 nm | 117 |
| | Wavelength 548 nm | 101 |
| | Wavelength 626 nm | 97 |

| | |
|---|---|
| (a1) Rth(548)/Re(548) | 51 |
| (a3) Rth(446)/Rth(548) | 1.16 |

### (Production of Liquid-Crystal Display Device LCD-5)

A liquid-crystal display device LCD-5 was produced in the same manner as that for the liquid-crystal display device LCD-1 in Example 1-1, for which, however, the optical film 105 that had been produced with the cellulose acylate film 006 in place of the cellulose acylate film 001 was used. This LCD-5 was so designed that 14 in FIG. 1 is the cellulose acylate film 006, 15 in FIG. 1 is the optically anisotropic layer 002, and 17 in FIG. 1 is Z-TAC.

### Example 1-6

A VA-mode liquid-crystal display device having the same constitution as that of the liquid-crystal display device of FIG. 2 was produced. Production methods for various members are described below.

### (Production of Cellulose Acylate Film 006)

An optical film 106 was produced in the same manner as that for the optical film 101 in Example 1-1, for which, however, the cellulose acylate film 001 for the support was changed to FUJIFILM's Z-TAC (thickness, 80 μm), and the optically anisotropic layer 002′ was formed in the same manner as that for the optically anisotropic layer 002 in Example 1-1 thereby giving an optical film 106 integrated with the cellulose acylate film Z-TAC. The optical performance of the optically anisotropic layer 002′ was the same as that of the optically anisotropic layer 002 in Example 1-1.

### (Production of Polarizing Plate 6-R)

A polarizing plate 6-R was produced in the same manner as that for the polarizing plate 1-R in Example 1-1, for which, however, the optical film 106 of this Example 1-6 was used in place of the optical film 101.

Thus produced, the polarizing plate 6-R was used as the polarizing plate P3 in FIG. 2 with its optically anisotropic layer 002′ facing the liquid-crystal cell.

### (Production of Polarizing Plate 6-F)

A polarizing plate 6-F was produced in the same manner as that for the polarizing plate 1-R in Example 1-1, in which, however, the second optically anisotropic layer 002 was not formed.

Thus produced, the polarizing plate 6-F was used as the polarizing plate P2 in FIG. 2.

### (Production of Liquid-Crystal Display Device LCD-6)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 6-F, as the polarizing plate P2 in the constitution of FIG. 2, and the produced polarizing plate 6-R, as the polarizing plate P3 therein, were stuck to the liquid-crystal cell with an adhesive, thereby producing a liquid-crystal display device LCD-6. This LCD-6 was so designed that 14 in FIG. 2 is the cellulose acylate film 001, 15 in FIG. 2 is the optically anisotropic layer 002′, and 17 in FIG. 2 is Z-TAC. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Comparative Example

A monoaxially-stretched polycarbonate film having the optical performance shown in Table 1-8 (Pure Ace, by Teijin Kasei) was formed into an optical film 007; and this was used as a protective film for the lower polarizing plate P1 in FIG. 1 in place of the optical film 101 in Example 1-1 of the invention. A bisphenol A-type polycarbonate (C1400, by Teijin Kasei) was dissolved in methylene chloride to prepare a solution having a solid concentration of 15% by weight, and formed into a film having a thickness of 60 μm according to a solution film formation method. The film was stretched by 1.1 times both in the machine direction and in the transverse direction at 165° C., thereby obtaining an optical film 008 having the performance shown in Table 1-9. The film was used as the upper polarizing plate P0 in FIG. 1 in place of Z-TAC (17) in Example 1-1 of the invention. Having the above constitution, a liquid-crystal display device LCD-7 was produced in the same manner as in Example 1-1.

TABLE 1-8
(Optical Performance of Optical Film 007)

| | | Optical Film No. |
|---|---|---|
| | | 007 |
| Re | 548 nm | 135 |
| Rth | 548 nm | 70 |

| | |
|---|---|
| Nz (=Rth/Re + 0.5) | 1.02 |
| thickness (μm) | 95.0 |

TABLE 1-9
(Optical Performance of Optical Film 008)

| | | Optical Film No. |
|---|---|---|
| | | 008 |
| Re | 548 nm | 0.2 |
| Rth | 548 nm | 155 |

| | |
|---|---|
| Nz (=Rth/Re + 0.5) | 776 |
| thickness (μm) | 55.0 |

### [Evaluation of Liquid-Crystal Display Devices LCD-1 to LCD-7]

### Determination of Viewing Angle-Dependent Contrast

In the normal direction and the oblique direction with an azimuth angle of 45° and a polar angle of 60°, the liquid-crystal display devices LCD-1 to LCD-7 produced in the above and a commercial 37-inch VA-mode liquid-crystal TV (by Sharp) as such, from which the polarizing plates were not peeled, were tested for the white brightness and the black brightness thereof, using ELDIM's Ezcontrast, and the white/black contrast ratio of each sample was calculated from the ratio of the obtained data. It was confirmed that the liquid-crystal display devices of the invention are better than or are equal to the original Sharp's TV in point of the contrast ratio in the normal direction and in the oblique direction, and that the devices of the invention has no or little color shift in the oblique direction.

### Detection of Corner Unevenness (Light Leakage)

The liquid-crystal display devices LCD-1 to LCD-7 produced in the above were turned on at the same time, and in the black state, they were continuously kept ON for 24 hours. The points spaced from the four corners by 1 cm on the panel of each of those liquid-crystal display devices were the check points, and the devices were checked at those points. When uneven light leakage was not observed, the samples were evaluated good (O); when some but little uneven light leakage was observed, the samples were evaluated average (Δ); and when significant uneven light leakage was observed, the samples were evaluated bad (x).

TABLE 1-10

| | | | | Second optically anisotropic | | | | |
|---|---|---|---|---|---|---|---|---|
| | | | | layer (formed according to a | | | | |
| | | | | coating or transferring | | Evaluation | | |
| LCD | | Polarizing | First optically | method) | | photoelastic | Corner | |
| No. | Construction | Plate (PL) | anisotropic layer | material | Re/(d × 1000) | coefficient | Unevenness | Remarks |
| LCD-1 | FIG. 1 | rear side PL | cellulose acylate | No. 002 | 0.073 | 13 | ∘ | Invention |
| | | (P1) | film 001 | (rod-like LC | | | | |
| | | | | composition) | | | | |
| | | front side | Z-TAC | — | — | 11 | | |
| | | PL | | | | | | |
| | | (P0) | | | | | | |
| LCD-2 | FIG. 1 | rear side PL | cellulose acylate | No. 003 | 0.067 | 13 | ∘ | Invention |
| | | (P1) | film 001 | (biaxial LC | | | | |
| | | | | composition) | | | | |
| | | front side | Z-TAC | — | — | 11 | | |
| | | PL | | | | | | |
| | | (P0) | | | | | | |
| LCD-3 | FIG. 1 | rear side PL | cellulose acylate | No. 004 | 0.021 | 13 | Δ | Invention |
| | | (P1) | film 001 | (polyimide | | | | |
| | | | | composition) | | | | |
| | | front side | Z-TAC | — | — | 11 | | |
| | | PL | | | | | | |
| | | (P0) | | | | | | |
| LCD-4 | FIG. 1 | rear side PL | cellulose acylate | No. 002 | 0.073 | 13 | ∘ | Invention |
| | | (P1) | film 005 | (rod-like LC | | | | |
| | | | | composition) | | | | |
| | | front side | Z-TAC | — | — | 11 | | |
| | | PL | | | | | | |
| | | (P0) | | | | | | |
| LCD-5 | FIG. 1 | rear side PL | cellulose acylate | No. 002 | 0.073 | 14 | ∘ | Invention |
| | | (P1) | film 006 | (rod-like LC | | | | |
| | | | | composition) | | | | |
| | | front side | Z-TAC | — | — | 11 | | |
| | | PL | | | | | | |
| | | (P0) | | | | | | |
| LCD-6 | FIG. 2 | rear side PL | Z-TAC | No. 002 | 0.073 | 13 | ∘ | Invention |
| | | (P3) | | (rod-like LC | | | | |
| | | | | composition) | | | | |
| | | front side | cellulose acylate | — | — | 12 | | |
| | | PL | film 001 | | | | | |
| | | (P2) | | | | | | |
| LCD-7 | FIG. 1 | rear side PL | monoaxially | — | — | 38 | x | Comparative |
| | | (P1) | stretched PC film | | | | | Example |
| | | | (Pure Ace, by | | | | | |
| | | | Teijin Kasei) | | | | | |
| | | front side | biaxially | — | — | 35 | | |
| | | PL | stretched PC film | | | | | |
| | | (P0) | | | | | | |

From the results shown in Table 1-10, it is understandable that the liquid-crystal display devices LCD-1 to LCD-6 of the invention have reduced corner unevenness in long-term use and have better characteristics not only in initial stages but also after long-term use compared with the comparative liquid-crystal display device LCD-7. This is because, in the liquid-crystal display devices LCD-1 to LCD-6, the second optically anisotropic layer is formed according to a coating method, and therefore the photoelastic coefficient of the layer is small, but on the other hand, in the liquid-crystal display device LCD-7, a stretched polymer film is used as the second optically anisotropic layer, and therefore, the photoelasticity coefficient of the layer is large, or that is, the superiority of the devices of the invention to the comparative device may be because of the difference in the photoelastic coefficient. Of the liquid-crystal display devices LCD-1 to LCD-6, the devices LCD-1, 2 and 4 to 6 all satisfy the above formulae, and therefore, it is understandable that they have no corner unevenness.

### Example 2-1

A VA-mode liquid-crystal display device having the same constitution as that of the liquid-crystal display device of FIG. 3 was produced. Production methods for various members are described below.

### <<Production of Cellulose Acylate Film 501 for Second Optically Anisotropic Layer>>

### Preparation of Cellulose Acylate Solution:

The components were mixed in the ratio indicated in Table 2-1, thereby preparing a cellulose acylate solution. The cellulose acylate solution was cast on a metal support, the resulting web was peeled from the support, and thereafter stretched under the condition shown in Table 2-1. In Table 2-1, TD means a traveling direction. After stretched, the film was dried, thereby producing a long cellulose acylate film 501 having the thickness shown in Table 2-1.

TABLE 2-1
Film sample No. 501

| | |
|---|---|
| Cellulose acylate | 100 parts by mass |
| Acetyl substitution degree of | |
| 2.86 | |
| Triphenyl phosphate | 7 parts by mass |
| Biphenyl phosphate | 5 parts by mass |
| Re enhancer 1 | 6.5 parts by mass |
| Rth enhancer I-(2) | 2 parts by mass |
| Stretching condition | at 150° C., in a TD, |
| | and stretching degree of 20% |
| Thickness | 85 μm |

Re Enhancer 1

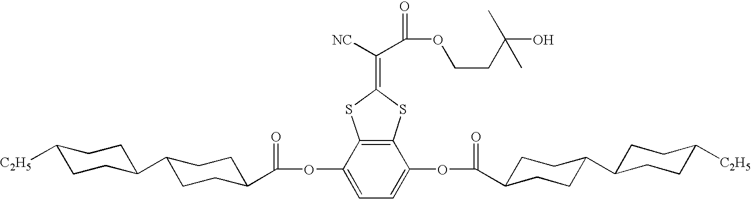

Thus produced, the cellulose acylate film 501 was analyzed for the three-dimensional birefringence thereof at a wavelength of 446 nm, 548 nm and 628 nm, using an automatic birefringence meter KOBRA-21ADH (by Oji Scientific Instruments) according to the method mentioned in the above, thereby obtaining the in-plane retardation Re and the thickness-direction retardation Rth calculated based on the data of Re at different tilt angles. Table 2-2 shows Re at different wavelengths, Nz at 548 nm, Re(446)/Re(548), Re(628)/Re(548), Rth(446)/Rth(548) and Rth(628)/Rth(548). As in Table 2-2 below, it is understandable that the cellulose acylate film 501 satisfies the above formulae (b1) to (b6) and can be used as a second optically anisotropic layer.

In the following Examples 2-2 to 2-4, the thus-produced long cellulose acylate film 501 was cut into sheets having a suitable length and used as a second optically anisotropic layer.

TABLE 2-2

| | | Film Sample No. |
|---|---|---|
| | | 501 |
| Re (nm) | Wavelength 446 nm | 92 |
| | Wavelength 548 nm | 105 |
| | Wavelength 626 nm | 113 |
| Rth (nm) | Wavelength 446 nm | 104 |
| | Wavelength 548 nm | 126 |
| | Wavelength 626 nm | 133 |

| | |
|---|---|
| Nz value | 1.70 |
| (b3) Re (446)/Re (548) | 0.88 |
| (b4) Re (628)/Re (548) | 1.08 |
| (b5) Rth (446)/Rth (548) | 0.83 |
| (b6) Rth (628)/Rth (548) | 1.06 |

<Production of Optical Film 501 with First Optically Anisotropic Layer 502 Formed Thereon)

The surface of the cellulose acylate film 501 produced in the above was saponified with an alkaline solution, then a coating layer for alignment film having the formulation mentioned below was applied onto it in an amount of 20 ml/m², using a wire bar coater. This was dried with hot air at 60° C. for 60 seconds and then with hot air at 100° C. for 120 seconds, thereby forming a film. Next, the thus-formed film was rubbed in the direction perpendicular to the slow axis direction of the cellulose acylate film 501, thereby forming an alignment film.

Composition of Coating Liquid for Alignment Film

| | |
|---|---|
| Modified Polyvinyl Alcohol mentioned below | 10 mas. pts. |
| Water | 371 mas. pts. |
| Methanol | 119 mas. pts. |
| Glutaraldehyde | 0.5 mas. pts. |
| Compound B | 0.2 mas. pts. |

Compound B

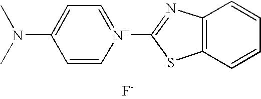

Modified Polyvinyl Alcohol

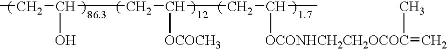

Using a wire bar, a coating liquid for optically anisotropic layer having the formulation mentioned below was applied onto it in such a manner that the thickness-direction retardation Rth at 548 nm of the cured layer was 110 nm.

| | |
|---|---|
| Discotic Liquid-Crystal Compound mentioned below | 1.8 g |
| Ethylene oxide-modified trimethylolpropane | 0.2 g |
| triacrylate (V#360, by Osaka Organic Chemistry) | |
| Photopolymerization Initiator | 0.06 g |
| (Irgacure 907, by Ciba-Geigy) | |
| Sensitizer (Kayacure DETX, by Nippon Kayaku) | 0.02 g |
| Fluorine-Containing Polymer | 0.01 g |
| (compound A mentioned below) | |
| Methyl Ethyl Ketone | 3.9 g |

This was heated in a thermostat at 125° C. for 3 minutes, thereby aligning the discotic liquid-crystal compound therein. Next, using a high-pressure mercury lamp of 120 W/cm, this was exposed to UV for 30 seconds to crosslink the discotic liquid-crystal compound. The temperature in UV curing was 80° C., and an optically anisotropic layer was thus produced. The thickness of the optically anisotropic layer was 1.4 μm. Next, this was left cooled to room temperature. In that manner, an optical film 501 was produced, having a first optically anisotropic layer 502 formed on the cellulose acylate film 501 of a second optically anisotropic layer, according to a coating method. The formed optically anisotropic layer 502 was analyzed for its condition, and the absence of coating unevenness (unevenness resulting from the action of the alignment film to repel the coating liquid) and alignment disorder was confirmed. The optical characteristics of the first optically anisotropic layer 502 are shown in Table 2-3. For analyzing the optical performance of the first optically anisotropic layer 502 alone, an optically anisotropic layer 502 was separately formed on a glass substrate of which Re and Rth are both estimated as 0 (zero), but not on the cellulose acylate film 501, according to the same process as above, and this was analyzed with an automatic birefringence meter KOBRA-21ADH (by Oji Scientific Instruments).

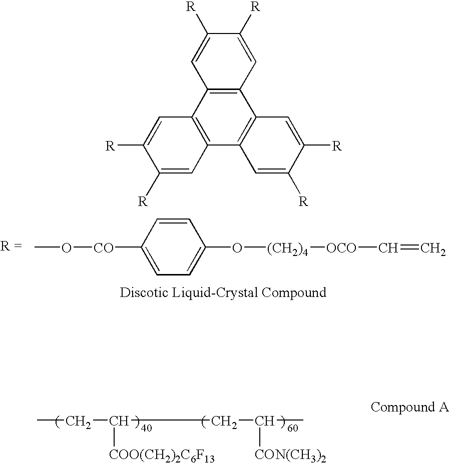

TABLE 2-3
(Optical Performance of Optically anisotropic layer 502)

| | | |
|---|---|---|
| Rth (nm) | 446 nm | 132 |
| | 548 nm | 110 |
| | 626 nm | 102 |

| | |
|---|---|
| (a1) Rth (548)/Re (548) | 137.5 |
| (a3) Rth (446)/Rth (548) | 1.20 |
| thickness (μm) | 1.4 |

<<Production of Protective Film 51-R for Polarizing element>>

### <Formation of Low Moisture-Permeation Coating Layer>

A roll of triacetyl cellulose film having a thickness of 80 μm (TAC-TD80U, by FUJIFILM) was unrolled, and using a coater equipped with a throttle die, a coating liquid for low moisture-permeation coating layer having the formulation mentioned below was directly extruded onto it. The liquid was applied at a traveling speed of 30 m/min, then dried at 60° C. for 5 minutes, and the coated film was rolled up.

[Coating Liquid for Low Moisture-Permeation Coating Layer]

| | |
|---|---|
| Chlorine-containing Polymer, R204 | 12 g |
| (Asahi Kasei Life & Living's “Saran Resin R204”) | |
| Tetrahydrofuran | 63 g |

### <Formation of Hard Coat Layer>

The 80-μm thick triacetyl cellulose film roll (TAC-TD80U, by FUJIFILM) coated with the low moisture-permeation coating layer was unrolled, and using a coater with a throttle die, the coating liquid for hard coat layer mentioned below was directly extruded onto it. The liquid was applied at a traveling speed of 30 m/min, then dried at 30° C. for 15 minutes, further dried at 90° C. for 20 seconds, and using a 160 W/cm air-cooling metal halide lamp (by Eyegraphics) under nitrogen purging, this was irradiated with UV rays at a dose of 90 mJ/cm² to cure the coating layer, thereby forming an antiglare hard coat layer having a thickness of 6 μm. This was wound up. The above process gave a polarizer protective film 503 coated with a low moisture-permeation barrier layer. The moisture permeation of the thus-produced polarizer protective film 201 was 33 g/(m²·day).

[Composition of Coating Liquid for Hard Coat Layer]

| | |
|---|---|
| PET-30 | 40.0 g |
| DPHA | 10.0 g |
| Irgacure 184 | 2.0 g |
| SX-350 (30%) | 2.0 g |
| Crosslinked Acryl-Styrene Particles (30%) | 13.0 g |
| FP-13 | 0.06 g |
| Sol a | 11.0 g |
| Toluene | 38.5 g |

<<Production of Polarizing plate 51-R>>

The back of the optical film 501 produced in the above (the back of the cellulose acylate film 501 on the side not coated with the first optically anisotropic layer 502), and one surface of the polarizer protective film 201 (on the side not coated with the low moisture-permeation layer) were processed for alkali saponification. Concretely, the film was dipped in an aqueous 1.5 N sodium hydroxide solution at 55° C. for 2 minutes, then washed in a water bath at room temperature, and then neutralized with 0.1 N sulfuric acid at 30° C. Again this was washed in a water bath at room temperature, and then dried with hot air at 100° C. Next, a polyvinyl alcohol film roll having a thickness of 80 μm was continuously stretched in an aqueous iodine solution by 5 times, and dried to prepare a polarizing film having a thickness of 20 μm. Using an aqueous 3% polyvinyl alcohol (Kuraray's PVA-117H) solution, the above alkali-saponified optical film 501 and the above alkali-saponified polarizer protective film 201 were stuck together with the polarizing film in such a manner that their saponified surfaces were on the side of the polarizing film, thereby obtaining a polarizing plate 51-R having the cellulose acylate film 501 (second optically anisotropic layer) and the polarizer protective film 201 as a protective film of the polarizing film. In this, the films were so stuck together that the direction MD of the polymer film was parallel to the absorption axis of the polarizing film.

Thus produced, the polarizing plate 51-R was used as the polarizing plate P1′ in FIG. 3.

(Production of Polarizing plate 51-F)

According to the same process as that for the polarizing plate 51-R, a polarizing plate 51-F was produced, for which, however, a commercial cellulose acylate film (FUJIFILM's Z-TAC with Re=0 nm and Rth=0 nm) was used in place of the optical film 501 for the polarizing plate 51-R and another polarizer protective film 201 was used.

Thus produced, the polarizing plate 51-F was used as the polarizing plate P0 in FIG. 3. Corresponding to the protective film 17 in FIG. 3, the above Z-TAC was on the side of the liquid-crystal cell.

### (Production of Liquid-Crystal Display Device LCD-51)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 51-R, as the polarizing plate P1′ in the constitution of FIG. 3, and the produced polarizing plate 51-F, as the polarizing plate P0 therein, were stuck to the liquid-crystal cell with an adhesive, thereby producing a liquid-crystal display device LCD-51. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Example 2-2

A VA-mode liquid-crystal display device having the same constitution as that of the liquid-crystal display device of FIG. 4 was produced. Production methods for various members are described below.

[Production of Polarizing plate 52-R]

A polarizing plate 52-R was produced in the same manner as that for the polarizing plate 51-R in Example 2-1, for which, however, the first optically anisotropic layer 502 was not formed.

Thus produced, the polarizing plate 52-R was used as the polarizing plate P4 in FIG. 4.

### (Production of Optical Film 502)

An optical film 502 was produced in the same manner as that for the optical film 501 in Example 2-1, for which, however, the cellulose acylate film 501 for the support was changed to FUJIFILM's Z-TAC (thickness, 80 μm), and the optically anisotropic layer 502′ was formed in the same manner as that for the optically anisotropic layer 502 in Example 2-1. The optical performance of the optically anisotropic layer 502′ was the same as that of the optically anisotropic layer 502 in Example 2-1. The optical film 502 was analyzed for the three-dimensional birefringence thereof at a wavelength of 446 nm, 548 nm and 628 nm, using an automatic birefringence meter KOBRA-21ADH (by Oji Scientific Instruments) according to the method mentioned in the above, thereby obtaining the in-plane retardation Re and the thickness-direction retardation Rth calculated based on the data of Re at different tilt angles. Table 2-4 shows the results. From Table 2-4, it is understandable that the produced optical film 502 satisfies the above formulae (a1) to (a3).

TABLE 2-4
(Optical Performance of Optical Film 502)

| | | Optical Film No. |
|---|---|---|
| | | 502 |
| Rth | 446 nm | 128 |
| (nm) | 548 nm | 111 |
| | 626 nm | 100 |

| | |
|---|---|
| (a1) Rth (548)/Re (548) | 137.5 |
| (a3) Rth (446)/Rth (548) | 1.15 |
| thickness (μm) | 80 + 1.4 |

### (Production of Polarizing Plate 52-F)

According to the same process as that for the polarizing plate 51-R in Example 2-1, a polarizing plate 52-F was produced, for which, however, the optical film 502 of this Example was used in place of the optical film 501.

Thus produced, the polarizing plate 52-F was used as the polarizing plate P5 for LCD in FIG. 4 in such a manner that the optically anisotropic layer 502′ was on the side of the liquid-crystal cell.

### (Production of Liquid-Crystal Display Device LCD-52)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 52-R, as the polarizing plate P4 in the constitution of FIG. 4, and the produced polarizing plate 52-F, as the polarizing plate P5 therein, were stuck to the liquid-crystal cell with an adhesive, thereby producing a liquid-crystal display device LCD-52. The two polarizing plates were disposed in a cross-Nicol configuration so that the transmission axis of the polarizing plate on the viewers' side was be in the vertical direction, and the transmission axis of the polarizing plate on the backlight side was in the horizontal direction.

### Example 2-3

A VA-mode liquid-crystal display device having the same constitution as that of the liquid-crystal display device of FIG. 3 was produced. Production methods for various members are described below.

(Production of Optical Film 503 and Polarizing Plate 53-R with Optically Anisotropic layer 503)

An optical film 503 and a polarizing plate 53-R were produced in the same manner as that for the polarizing plate 51-R in Example 2-1, for which, however, an optically anisotropic layer 503 was formed as the first optically anisotropic layer according to the method mentioned below in place of forming the optically anisotropic layer 502.

### <<Formation of Optically Anisotropic Layer 503>>

75 parts by weight of a rod-shaped liquid-crystal compound having a polymerizable acrylate group at both ends and having a spacer between the mesogen in the center part and the above acrylate, 1 parts by weight of a photo-polymerization initiator (Chiba Speciality Chemicals' Irgacure Irg 184) and 25 parts by weight of a solvent, methyl ethyl ketone were mixed, and 10 parts by weight of a chiral agent having a polymerizable acrylate group at both ends was added to thereby prepare a coating liquid for optically anisotropic layer.

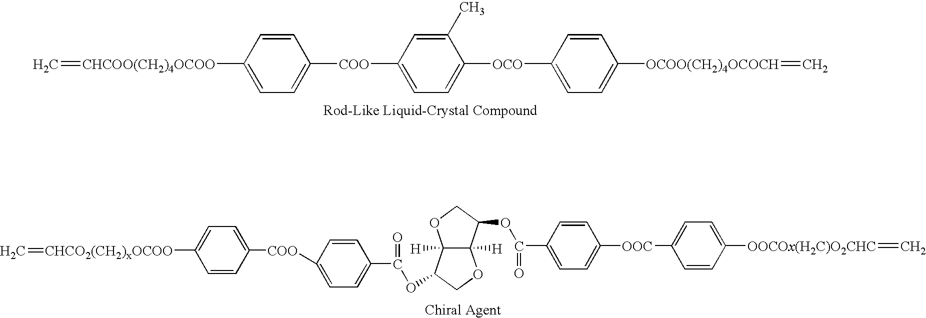

In the formula, x is 4.

The above-prepared coating liquid for optically anisotropic layer 503 was applied to a cellulose acylate film 501, which had been saponified, coated with an alignment film and rubbed, on the side of the rubbed alignment film, like the first retardation film, then dried and UV-cured, thereby forming a chiral nematic (cholesteric) liquid-crystal layer (optically anisotropic layer 503). Thus formed, the thickness of the optically anisotropic layer was 1.8 μm.

In the manner as above, the optically anisotropic layer 503 having a thickness of 1.8 μm was formed, thereby producing an optical film 503. The formed optically anisotropic layer was analyzed for its condition, and the absence of coating unevenness (unevenness resulting from the action of the alignment film to repel the coating liquid) and alignment disorder was confirmed.

The formed optically anisotropic layer 503 was analyzed for its condition, and the absence of coating unevenness (unevenness resulting from the action of the alignment film to repel the coating liquid) and alignment disorder was confirmed. The optical characteristics of the optically anisotropic layer 503 are shown in Table 2-5. For analyzing the optical performance of the optically anisotropic layer 503 alone, an optically anisotropic layer 503 was separately formed on a glass substrate of which Re and Rth are both estimated as 0 (zero), but not on the cellulose acylate film 501, according to the same process as above, and this was analyzed with an automatic birefringence meter KOBRA-21ADH (by Oji Scientific Instruments).

TABLE 2-5

| | | Optically anisotropic |
|---|---|---|
| | | layer No. |
| | | 503 |
| Rth | 446 nm | 116 |
| | 548 nm | 107 |
| | 626 nm | 100 |

| | |
|---|---|
| (a1) Rth (548)/Re (548) | 72.1 |
| (a3) Rth (446)/Rth (548) | 1.08 |
| thickness(μn) | 1.8 |

(Production of Polarizing plate 53-R)

According to the same process as that for the polarizing plate 51-R in Example 2-1, a polarizing plate 53-R was produced, for which, however, the formed optical film 503 was used in place of the optical film 501.

Thus produced, the polarizing plate 53-R was used as the polarizing plate P1′ in FIG. 3.

### (Production of Liquid-Crystal Display Device LCD-53)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 53-R, as the polarizing plate P1′ in the constitution of FIG. 3, and the polarizing plate 51-F produced in Example 2-1, as the polarizing plate P0 therein, were stuck to the liquid-crystal cell with an adhesive, thereby producing a liquid-crystal display device LCD-53. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Example 2-4

A VA-mode liquid-crystal display device having the same constitution as that of the liquid-crystal display device of FIG. 3 was produced. Production methods for various members are described below.

### (Production of Polarizing Plate 54-R)

A polarizing plate 54-R was produced in the same manner as that for the polarizing plate 51-R in Example 2-1, for which, however, an optically anisotropic layer 504 was formed as the first optically anisotropic layer according to the method mentioned below in place of forming the optically anisotropic layer 502. In forming the optically anisotropic layer 504, the alignment film used in producing the optical film 501 was not used.

### <<Formation of Optically Anisotropic Layer 504>>

### (Preparation of Polyimide Coating Liquid)

Using 2,2′-bis(3,4-dicarboxyphenyl)hexafluoropropanoic acid dianhydride (6FDA) and 2,2′-bis(trifluoromethyl)-4,4′-diaminobiphenyl (PFMB), a polyimide comprising a repetitive unit of the formula mentioned below was produced (Mw=150,000). The polyimide was dissolved in MIBK to prepare a polyimide solution having a polyimide concentration of 15% by weight. Methods for producing 6FDA and PFMB are described in detail in Japanese Patent No. 3735361.

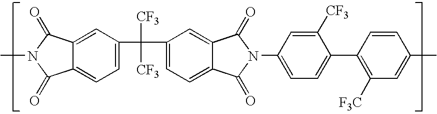

### (Production of Optical Film 504)

Using a bar coater, the above polyimide solution was directly applied onto the cellulose acylate film 501 produced in Example 2-1, with controlling its thickness, and this was dried at 100° C. for 10 minutes and then at 150° C. for 20 minutes to form a polyimide layer 504 having a thickness of 2.7 μm, thereby obtaining an optical film 504 integrated with the cellulose acylate film 501. The optically anisotropic layer 504 of the polyimide was analyzed as follows (Table 2-6). Separately, an optically anisotropic layer 504 of the polyimide was formed on a glass substrate, of which Re and Rth are both estimated as 0 (zero), according to the same process as above, and this was analyzed with an automatic birefringence meter KOBRA-21ADH (by Oji Scientific Instruments).

TABLE 2-6

| | | Optically anisotropic |
|---|---|---|
| | | layer No. |
| | | 504 |
| Rth | 446 nm | 110 |
| (nm) | 548 nm | 108 |
| | 626 nm | 107 |

| | |
|---|---|
| (a1) Rth (548)/Re (548) | 60.0 |
| (a3) Rth (446)/Rth (548) | 1.02 |
| thickness (μm) | 2.7 |

### <<Production of Polarizing Plate 54-R>>

According to the same process as that for the polarizing plate 51-R in Example 2-1, a polarizing plate 54-R was produced, for which, however, the above-produced optical film 504 was used in place of the optical film 501.

The thus-produced polarizing plate 54-R was used as the polarizing plate P1′ in FIG. 3.

### (Production of Liquid-Crystal Display Device LCD-54)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 54-R, as the polarizing plate P1′ in the constitution of FIG. 3, and the polarizing plate 51-F produced in Example 2-1, as the polarizing plate P0 therein, were stuck to the liquid-crystal cell with an adhesive, thereby producing a liquid-crystal display device LCD-54. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### Example 2-5

A VA-mode liquid-crystal display device having the same constitution as that of the liquid-crystal display device of FIG. 12 was produced. Production methods for various members are described below.

### <<Formation of Second Optically Anisotropic Layer 005>>

The surface of “Z-TAC” manufactured by FUJIFILM (thickness of 80 μm) was saponified with an alkaline solution, then a coating layer for alignment film having the formulation mentioned below was applied onto it in an amount of 20 ml/m², using a wire bar coater. This was dried with hot air at 60° C. for 60 seconds and then with hot air at 100° C. for 120 seconds, thereby forming a film. Next, the thus-formed film was rubbed in the direction perpendicular to the MD direction of the Z-TAC film, thereby forming an alignment film.

Composition of Coating Liquid for Alignment Film

| | |
|---|---|
| Modified Polyvinyl Alcohol mentioned below | 10 mas. pts. |
| Water | 371 mas. pts. |
| Methanol | 119 mas. pts. |
| Glutaraldehyde | 0.5 mas. pts. |
| Compound B | 0.2 mas. pts. |

Compound B

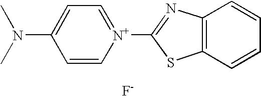

Modified Polyvinyl Alcohol

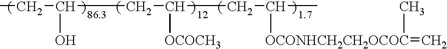

Using a wire bar, a coating liquid for optically anisotropic layer having the formulation mentioned below was applied onto the alignment layer, heated at 140° C. thereby aligning the liquid-crystal compound uniformly, and was exposed to UV of 400 mJ/cm²to polymerize the liquid-crystal compound. Then, an optically anisotropic layer 005 was thus produced. The thickness of the optically anisotropic layer was 3.03 μm. This optical film was used as Optical film 505.

| | |
|---|---|
| Liquid crystal compound shown below | 100 mas. pts. |
| Photopolymerization Initiator | 4 mas. pts. |
| (Irgacure 819, by Ciba-Geigy) | |
| Methl ethyl ketone | 350 mas. pts. |

Liquid crystal compound

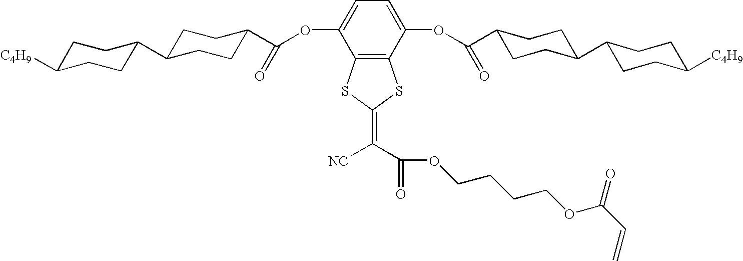

For analyzing the optical performance of the optically anisotropic layer 005 alone, an optically anisotropic layer 005 was separately formed on a glass substrate of which Re and Rth are both estimated as 0 (zero), but not on the Z-TAC film, according to the same process as above, and this was analyzed with an automatic birefringence meter KOBRA-21ADH (by Oji Scientific Instruments).

TABLE 2-7

| Optically anisotropic layer | | |
|---|---|---|
| No. | | 005 |
| Re(nm) | Wavelength 446 nm | 110 |
| | Wavelength 548 nm | 137 |
| | Wavelength 626 nm | 151 |
| Rth(nm) | Wavelength 446 nm | 55 |
| | Wavelength 548 nm | 69 |
| | Wavelength 626 nm | 76 |

| | |
|---|---|
| Nz value | 1.00 |
| (b3) Re(446)/Re(548) | 0.80 |
| (b4) Re(628)/Re(548) | 1.10 |
| (b5) Rth(446)/Rth(548) | 0.80 |
| (b6) Rth(628)/Rth(548) | 1.10 |

### <<Production of Polarizing Plate 55-R>>

According to the same process as that for the polarizing plate 51-R in Example 2-1, a polarizing plate 55-R was produced, for which, however, the above-produced optical film 505 was used in place of the optical film 501.

The thus-produced polarizing plate 55-R was used as the polarizing plate P7 in FIG. 12.

<<Production of Optical film 506>>

An optical film 506 was produced in the same manner as that for the optical film 502 in Example 2-2, except that Optically anisotropic layer 502″ having a thickness of 2.1 μm was formed in place of Optically anisotropic layer 502′.

For analyzing the optical performance of the optically anisotropic layer 502″ alone, an optically anisotropic layer 502″ was separately formed on a glass substrate of which Re and Rth are both estimated as 0 (zero), but not on the Z-TAC film, according to the same process as above, and this was analyzed with an automatic birefringence meter KOBRA-21ADH (by Oji Scientific Instruments).

TABLE 2-8

| Optically anisotropic | | |
|---|---|---|
| layer No. | | 502″ |
| Rth | 446 nm | 197 |
| (nm) | 548 nm | 164 |
| | 626 nm | 152 |

| | |
|---|---|
| (a1) Rth(548)/Re (548) | 137.5 |
| (a3) Rth(446)/Rth(548) | 1.20 |
| thickness (μm) | 2.1 |

<<Production of Polarizing plate 55-F>>

According to the same process as that for the polarizing plate 51-R in Example 2-1, a polarizing plate 55-R was produced, for which, however, the above-produced optical film 506 was used in place of the optical film 501.

This polarizing plate 55-F was disposed so that the optically anisotropic layer 502″ was at the liquid crystal cell side.

The thus-produced polarizing plate 55-F was used as the polarizing plate P6 in FIG. 12.

### (Production of Liquid-Crystal Display Device LCD-55)

In a commercial 37-inch VA-mode liquid-crystal TV (by Sharp), the polarizing plates and the retardation plates on both the top and the back of the panel were peeled away, and this was used as a liquid-crystal cell. The produced polarizing plate 55-R, as the polarizing plate P7 (the second optically anisotropic layer 15″ in FIG. 12 was the optically anisotropic layer 005) in the constitution of FIG. 12, and the polarizing plate 55-F produced in Example 2-1, as the polarizing plate P6 (the first optically anisotropic layer 14″ in FIG. 12 was the optically anisotropic layer 502″) therein, were stuck to the liquid-crystal cell with an adhesive, thereby producing a liquid-crystal display device LCD-55. The two polarizing plates were disposed in a cross-Nicol configuration so that the transmission axis of the polarizing plate on the viewers' side was in the vertical direction, and the transmission axis of the polarizing plate on the backlight side was in the horizontal direction.

### [Evaluation of Liquid-Crystal Display Devices LCD-51 to LCD-55]

### Viewing Angle-Dependent Color Shift

The liquid-crystal display devices LCD-51 to LCD-55 produced in the above and a commercial 37-inch VA-mode liquid-crystal TV (by Sharp) as such, from which the polarizing plates were not peeled, were checked for color shift in a direction with an azimuth angle of 0° and a polar angle of 60° and in a direction with an azimuth angle of 80° and a polar angle of 60° respectively, using ELDIM's Ezcontrast, thereby determining the color shift absolute values Δx and Δy on the xy chromaticity diagram. The results are shown in Table 2-9 below. The commercial VA-mode liquid-crystal TV has the constitution of FIG. 3, having a biaxial film (of which Re and Rth have regular wavelength dispersion characteristics) in place of the first optically anisotropic layer 14′ and the second optically anisotropic layer 15′ respectively and having a cellulose acetate film (of which Re and Rth have reversed wavelength dispersion characteristics with Re=5 nm and Rth=45 nm) as the polarizer protective film 17.

TABLE 2-9

| | | | | | Second | | | |
|---|---|---|---|---|---|---|---|---|
| | Construction | | First optically | | optically | | | |
| | | Polarizing | anisotropic layer | | anisotropic | Evaluation | | Remarks |
| LCD No. | Fig No. | Plate | material | Rth/(d × 1000) | layer | Δx | Δy | Invention |
| LCD-51 | FIG. 3 | P0: 51-F | No. 502 | 0.079 | Cellulose | 0.09 | 0.05 | Invention |
| | | P1′: 51-R | (discotic LC | | acylate film | | | |
| | | | composition) | | 501 | | | |
| LCD-52 | FIG. 4 | P5: 52-F | No. 502′ | 0.079 | Cellulose | 0.08 | 0.06 | Invention |
| | | P4: 52-R | (discotic LC | | acylate film | | | |
| | | | composition) | | 501 | | | |
| LCD-53 | FIG. 3 | P0: 51-F | No. 503 | 0.059 | Cellulose | 0.15 | 0.15 | Invention |
| | | P1′: 53-R | (cholesteric LC | | acylate film | | | |
| | | | composition) | | 501 | | | |
| LCD-54 | FIG. 3 | P0: 51-F | No. 504 | 0.040 | Cellulose | 0.25 | 0.27 | Invention |
| | | P1′: 54-R | (polyimide | | acylate film | | | |
| | | | composition) | | 501 | | | |
| LCD-55 | FIG. 12 | P6: 55-F | No. 502″ | 0.079 | No. 005 | 0.07 | 0.07 | Invention |
| | | P7: 55-R | (discotic LC | | (LC | | | |
| | | | composition) | | composition) | | | |
| Commercially | — | — | — | — | — | 0.55 | 0.46 | Comparative |
| available TV | | | | | | | | Example |

From the results shown in Table 2-9, it is understandable that the liquid-crystal display devices LCD-51 to LCD-55 of the invention are superior to the comparative sample, commercially available VA-mode liquid-crystal display device, in terms of that they are free from the problem of viewing angle-dependent color shift and they have excellent display characteristics.

1. A liquid-crystal display device comprising at least a liquid-crystal cell, a first optically anisotropic layer and a second optically anisotropic layer,
wherein the first optically anisotropic layer satisfies the following formula (a1), the second optically anisotropic layer has at least one optical axis, and at least one of the first and second optically anisotropic layers is formed according to a coating or transferring method.
10<Rth(548)/Re(548) (a1)
[wherein Rth(λ) means the retardation (nm) in the thickness direction at a wavelength λ (nm)].

2. The liquid-crystal display device of claim 2, wherein thickness-direction retardation Rth of the first optically layer is a polymer film decreases with longer wavelength within a visible light range.

3. The liquid-crystal display device of claim 1, wherein in-plane retardation Re and thickness-direction retardation Rth of the second optically anisotropic layer do not change depending on the wavelength within a visible light range, or increase with longer wavelength within a visible light range.

4. The liquid-crystal display device of claim 1, wherein the thickness d (μm) of the first optically anisotropic layer satisfies the following formula (a4), and Rth(548) thereof satisfies the following formula (a5):
0.1≦d≦20 (a4)
Rth(548)/(d×1000)≧0.03. (a5)

5. The liquid-crystal display device of claim 1, wherein the second optically anisotropic layer is a layer formed according to a coating or transferring method, and its thickness d (μm) satisfies the following formula (b7) and its Rth(548) satisfies the following formula (b8):
0.1≦d≦20 (b7)
Re(548)/(d×1000)≧0.03. (b8)

6. The liquid-crystal display device of claim 1, wherein the first optically anisotropic layer satisfies the following formulae (a2) and (a3):
30nm≦Rth(548)≦400nm (a2)
1<Rth(446)/Rth(548). (a3)

7. The liquid-crystal display device of claim 1, wherein the second optically anisotropic layer satisfies the following formulae (b1) and (b2):
Re(548)>20nm (b1)
0.5<Nz<10 (b2)
[wherein Re(λ) and Rth(λ) each indicate the in-plane retardation (nm) and the thickness-direction retardation (nm), respectively, at a wavelength λ (nm); and Nz=Rth(548)/Re(548)+0.5].

8. The liquid-crystal display device of claim 1, wherein the first optically anisotropic layer satisfies the following formulae (a1) to (a3), and the second optically anisotropic layer satisfies the following formulae (b1) to (b6):
10<Rth(548)/Re(548) (a1)
30nm≦Rth(548)≦400nm (a2)
1.0<Rth(446)/Rth(548)<1.5 (a3)
Re(548)>20nm (b1)
0.5<Nz<10 (b2)
0.60≦Re(446)/Re(548)≦1.0 (b3)
1.0≦Re(628)/Re(548)≦1.25 (b4)
0.60≦Rth(446)/Rth(548)23 1.0 (b5)
1.0≦Rth(628)/Rth(548)≦1.25 (b6)
[wherein Re(λ) and Rth(λ) each indicate the in-plane retardation (nm) and the thickness-direction retardation (nm), respectively, at a wavelength λ (nm); and Nz=Rth(548)/Re(548)+0.5].

9. The liquid-crystal display device of claim 1, wherein the first optically anisotropic layer is a cellulose acylate film.

10. The liquid-crystal display device of claim 9, wherein the cellulose acylate film comprises at least one Rth enhancer.

11. The liquid-crystal display device of claim 10, wherein the at least one Rth enhancer is a compound represented by formula (I) or (II): 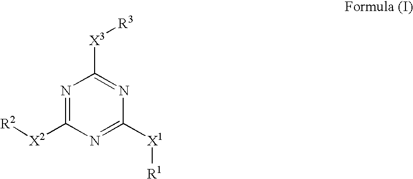
where X¹ represents a single bond, -NR⁴-, —O—or —S—;X² represents a single bond, -NR⁵-, —O—or —S—;X³ represents a single bond, -NR⁶-, —O—or —S—; R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group; 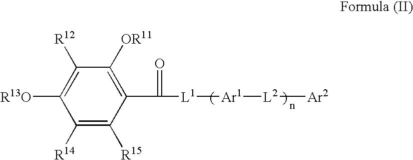
where R¹², R¹⁴ and R¹⁵ independently represent a hydrogen atom or a substituent; R¹¹ and R¹³ independently represent a hydrogen atom or an alkyl group; and L¹ and L² independently represent a single bond or a bivalent linking group. In the formula, Ar¹ represents an arylene group or an aromatic heterocyclic group; Ar² represents an arylene group or an aromatic heterocyclic group; n is an integer equal to or more than 3; “n” types of L² and Ar¹ may be same or different from each other; and R¹¹ and R¹³ are different from each other, provided that the alkyl group represented by R¹³ doesn't include any hetero atoms.

12. The liquid-crystal display device of claim 1, wherein the first optically anisotropic layer is a layer formed of a discotic liquid-crystal composition or a cholesteric liquid-crystal composition according to a coating or transferring method.

13. The liquid-crystal display device of claim 1, wherein the first optically anisotropic layer is a birefringent polymer layer formed according to a coating or transferring method, and the polymer layer comprises at least one polymer material selected from a group consisting of polyamide, polyimide, polyester, polyether ketone, polyamidimide, polyester imide, and polyaryl ether ketone.

14. The liquid-crystal display device of claim 1, wherein the second optically anisotropic layer is a cellulose acylate film.

15. The liquid-crystal display device of claim 14, wherein the cellulose acylate film comprises at least one Re enhancer.

16. The liquid-crystal display device of claim 15, wherein the at least one Re enhancer is a compound represented by formula (I): 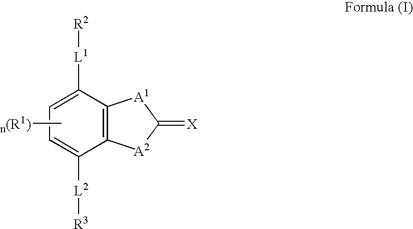
where, L¹ and L² independently represent a single bond or a divalent linking group; A¹ and A² independently represent a group selected from the group consisting of —O—,-NR- where R represents a hydrogen atom or a substituent, —S—and —CO—;R¹, R² and R³ independently represent a substituent; X represents a nonmetal atom selected from the groups 14-16 atoms, provided that X may bind with at least one hydrogen atom or substituent; and n is an integer from 0 to 2.

17. The liquid-crystal display device of claim 1, wherein the second optically anisotropic layer is a layer formed of a liquid-crystal composition according to a coating or transferring method.

18. The liquid-crystal display device of claim 1, wherein the second optically anisotropic layer is a birefringent polymer layer formed according to a coating or transferring method, and the polymer layer comprises at least one polymer material selected from a group consisting of polyamide, polyimide, polyester, polyether ketone, polyamidimide, polyester imide, and polyaryl ether ketone.

19. A liquid-crystal display device comprising at least a liquid-crystal cell, a first optically anisotropic layer satisfying the following formula (a6), and a second optically anisotropic layer,
wherein the first optically anisotropic layer is a layer formed according to a coating or transferring method, of which thickness-direction retardation Rth decreases with longer wavelength within a visible light range; and
the second optically is a layer formed according to a coating or transferring method, of which in-plane retardation Re and thickness-direction retardation Rth do not change depending on the wavelength within a visible light range, or increase with longer wavelength within a visible light range
0.5<Rth(548)/Re(548) (a6)
[wherein Rth(λ) means the retardation (nm) in the thickness direction at a wavelength λ (nm)λ.

20. The liquid-crystal display device of claim 1, wherein the liquid-crystal cell is a vertically aligned mode liquid-crystal cell.

21. An optical film comprising at least a first optically anisotropic layer and a second optically anisotropic layer,
wherein the first optically anisotropic layer satisfies the following formula (a1), the second optically anisotropic layer has at least one optical axis, and at least one of the first and second optically anisotropic layers is formed according to a coating or transferring method.
10<Rth(548)/Re(548) (a1)
[wherein Rth(λ) means the retardation (nm) in the thickness direction at a wavelength λ (nm)].

22. The optical film of claim 21, wherein thickness-direction retardation Rth of the first optically layer decreases with longer wavelength within a visible light range.

23. The optical film of claim 21, wherein in-plane retardation Re and thickness-direction retardation Rth of the second optically anisotropic layer do not change depending on the wavelength within a visible light range, or increase with longer wavelength within a visible light range.

24. An optical film comprising at least a liquid-crystal cell, a first optically anisotropic layer satisfying the following formula (a6) and a second optically anisotropic layer,
wherein the first optically anisotropic layer is a layer formed according to a coating or transferring method, of which thickness-direction retardation Rth decreases with longer wavelength within a visible light range; and
the second optically is a layer formed according to a coating or transferring method, of which in-plane retardation Re and thickness-direction retardation Rth do not change depending on the wavelength within a visible light range, or increase with longer wavelength within a visible light range
0.5<Rth(548)/Re(548) (a6)
[wherein Rth(λ) means the retardation (nm) in the thickness direction at a wavelength λ (nm)].

25. The optical film of claim 21, wherein the thickness d (μm) of the first optically anisotropic layer satisfies the following formula (a4), and Rth(548) thereof satisfies the following formula (a5):
0.1≦d≦20 (a4)
Rth(548)/(d×1000)≧0.03. (a5)

26. The optical film of claim 21, wherein the second optically anisotropic layer is a layer formed according to a coating or transferring method, and its thickness d (μm) satisfies the following formula (b7) and its Rth(548) satisfies the following formula (b8):
0.1≦d≦20 (b7)
Re(548)/(d×1000)≧0.03. (b8)

27. The optical film of claim 21, wherein the first optically anisotropic layer satisfies the following formulae (a2) and (a3):
30nm≦Rth(548)≦400nm (a2)
1<Rth(446)/Rth(548). (a3)

28. The optical film of claim 21, wherein the second optically anisotropic layer satisfies the following formulae (b1) and (b2):
Re(548)>20nm (b1)
0.5<Nz<10 (b2)
[wherein Re(λ) and Rth(λ) each indicate the in-plane retardation (nm) and the thickness-direction retardation (nm), respectively, at a wavelength λ (nm); and Nz=Rth(548)/Re(548)+0.5].

29. The optical film of claim 21, wherein the first optically anisotropic layer satisfies the following formulae (a1) to (a3), and the second optically anisotropic layer satisfies the following formulae (b1) to (b6):
10<Rth(548)/Re(548) (a1)
30nm≦Rth(548)≦400nm (a2)
1.0<Rth(446)/Rth(548)<1.5 (a3)
Re(548)>20nm (b1)
0.5<Nz<10 (b2)
0.60≦Re(446)/Re(548)≦1.0 (b3)
1.0≦Re(628)/Re(548)≦1.25 (b4)
0.60≦Rth(446)/Rth(548)≦1.0 (b5)
1.0≦Rth(628)/Rth(548)≦1.25 (b6)
[wherein Re(λ) and Rth(λ) each indicate the in-plane retardation (nm) and the thickness-direction retardation (nm), respectively, at a wavelength λ (nm); and Nz=Rth(548)/Re(548)+0.5].

30. The optical film of claim 21, wherein the first optically anisotropic layer is a cellulose acylate film.

31. The optical film of claim 30, wherein the cellulose acylate film comprises at least one Rth enhancer.

32. The optical film of claim 31, wherein the at least one Rth enhancer is a compound represented by formula (I) or (II): 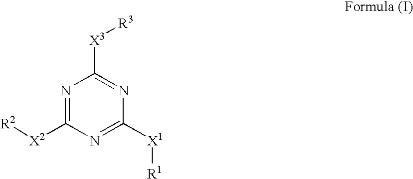
where X¹ represents a single bond, -NR⁴-, —O—or —S—;X² represents a single bond, -NR⁵-, —O—or —S—;X³ represents a single bond, -NR⁶-, —O—or —S—; R¹, R², and R³ independently represent an alkyl group, an alkenyl group, an aromatic ring group or a hetero-ring residue; R⁴, R⁵ and R⁶ independently represent a hydrogen atom, an alkyl group, an alkenyl group, an aryl group or a hetero-ring group; 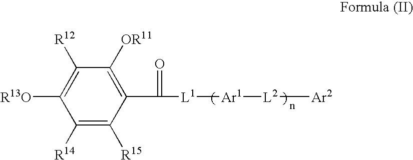
where R¹², R¹⁴ and R¹⁵ independently represent a hydrogen atom or a substituent; R¹¹ and R¹³ independently represent a hydrogen atom or an alkyl group; and L¹ and L² independently represent a single bond or a bivalent linking group. In the formula, Ar¹ represents an arylene group or an aromatic heterocyclic group; Ar² represents an arylene group or an aromatic heterocyclic group; n is an integer equal to or more than 3; “n” types of L² and Ar¹ may be same or different from each other; and R¹¹ and R¹³ are different from each other, provided that the alkyl group represented by R¹³ doesn't include any hetero atoms.

33. The optical film of claim 21, wherein the first optically anisotropic layer is a layer formed of a discotic liquid-crystal composition or a cholesteric liquid-crystal composition according to a coating or transferring method.

34. The optical film of claim 21, wherein the first optically anisotropic layer is a birefringent polymer layer formed according to a coating or transferring method, and the polymer layer comprises at least one polymer material selected from a group consisting of polyamide, polyimide, polyester, polyether ketone, polyamidimide, polyester imide, and polyaryl ether ketone.

35. The optical film of claim 21, wherein the second optically anisotropic layer is a cellulose acylate film.

36. The optical film of claim 35, wherein the cellulose acylate film comprises at least one Re enhancer.

37. The optical film of claim 36, wherein the at least one Re enhancer is a compound represented by formula (I): 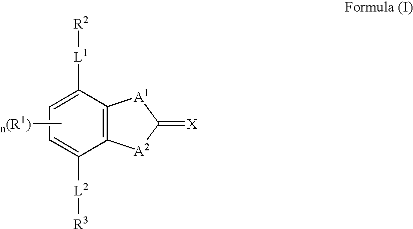
where, L¹ and L² independently represent a single bond or a divalent linking group; A¹ and A² independently represent a group selected from the group consisting of —O—,-NR- where R represents a hydrogen atom or a substituent, —S—and —CO—;R¹, R² and R³ independently represent a substituent; X represents a nonmetal atom selected from the groups 14-16 atoms, provided that X may bind with at least one hydrogen atom or substituent; and n is an integer from 0 to 2.

38. The optical film of claim 21, wherein the second optically anisotropic layer is a layer formed of a liquid-crystal composition according to a coating or transferring method.

39. The optical film of claim 21, wherein the second optically anisotropic layer is a birefringent polymer layer formed according to a coating or transferring method, and the polymer layer comprises at least one polymer material selected from a group consisting of polyamide, polyimide, polyester, polyether ketone, polyamidimide, polyester imide, and polyaryl ether ketone.

40. A polarizing plate comprising a polarizing element and an optical film as set forth in claim 21.

41. The polarizing plate of claim 40, further comprising a protective film protecting the polarizing element, wherein the protective film has a moisture permeation degree equal to or smaller than 200 g/m²·day.

42. A liquid crystal display device comprising an optical film as set forth in claim 21.

43. A polarizing plate comprising a polarizing element and an optical film as set forth in claim 24.

44. A liquid crystal display device comprising a polarizing plate as set forth in claim 40.
